(19) United States
(12) Patent Application Publication
(10) Pub. No.: US 2015/0361213 A1
(43) Pub. Date: Dec. 17, 2015

(54) POLYMER PRODUCT AND PRODUCTION METHOD THEREOF, AND POLYMER PRODUCT PRODUCING APPARATUS

(71) Applicants: Yasuo KAMADA, (US); Taichi NEMOTO, (US); Satoshi IZUMI, (US); Yoko ARAI, (US); Chiaki TANAKA, (US); Yukihiro IMANAGA, (US)

(72) Inventors: Yasuo KAMADA, Shizuoka (JP); Taichi NEMOTO, Shizuoka (JP); Satoshi IZUMI, Shizuoka (JP); Yoko ARAI, Shizuoka (JP); Chiaki TANAKA, Shizuoka (JP); Yukihiro IMANAGA, Shizuoka (JP)

(21) Appl. No.: 14/763,650

(22) PCT Filed: Jan. 20, 2014
(86) PCT No.: PCT/JP2014/051595

§ 371 Date: Jul. 27, 2015

(30) Foreign Application Priority Data
Jan. 28, 2013 (JP) 2013-013766
Jan. 15, 2014 (JP) 2014-005003

(51) Int. Cl. C08G 63/08; B01J 19/24

(52) U.S. Cl. CPC C08G 63/08; B01J 19/24; B01J 2219/24

(57) ABSTRACT

Provided is a polymer product, in which the weight average molecular weight measured by gel permeation chromatography is 250,000 or greater and the content of residual ring-opening-polymerizable monomer is 100 ppm by mass or greater but less than 1,000 ppm by mass, or a polymer product, in which the content of residual ring-opening-polymerizable monomer is from 1,000 ppm by mass to 20,000 ppm by mass and the yellow index (YI) value is 15 or less.

### TECHNICAL FIELD

The present invention relates to a polymer product and a production method of the polymer product, and a polymer product producing apparatus.

### BACKGROUND ART

Conventionally, various polymers have been produced by ring-opening polymerizing ring-opening-polymerizable monomers. For example, polylactic acid is produced by ring-opening polymerizing lactide, which is an example of ring-opening-polymerizable monomers. The produced polylactic acid is used for, for example, fabric for suture threads, sheet for biocompatible materials, particles for cosmetics, and film for plastic bags.

As a method for producing a polymer by ring-opening polymerizing such a ring-opening-polymerizable monomer, there is a method of reacting a ring-opening-polymerizable monomer in its molten state. For example, as a method for producing polylactic acid by ring-opening polymerizing lactide, there is proposed a method of polymerizing lactide by reacting it in its molten state in the presence of tin octylate as a catalyst at a reaction temperature of 195° C. (see PTL 1). However, when polylactic acid is produced by this proposed producing method, lactide will remain in the resulting product in an amount of greater than 2% by mass. This is because a ring-opening-polymerizing reaction system such as lactide has an equilibrium relation between the ring-opening-polymerizable monomer and the polymer, and ring-opening polymerization of the ring-opening-polymerizable monomer at such a high temperature as the aforementioned reaction temperature tends to result in producing the ring-opening-polymerizable monomer through depolymerization reaction. The remained lactide (ring-opening-polymerizable monomer) may function as a hydrolysis catalyst for the obtained product or may degrade the heat resistance of the obtained product. Known for such a case is to reduce the amount of lactide from the polylactic acid at a reduced pressure while the polylactic acid is in its molten state (see PTL 2), which however might result in coloring the polylactic acid from keeping it in its molten state. It is also known to use a hydrolysis inhibitor (see PTL 3). However, addition of the hydrolysis inhibitor might degrade the moldability, and might degrade the physical properties of the molded article to be obtained.

Further, as a method for ring-opening polymerizing a ring-opening-polymerizable monomer at a low reaction temperature, there is proposed a method of ring-opening polymerizing lactide in an organic solvent (see PTL 4). According to this proposed method, D-lactide is polymerized at 25° C. in a dichloromethane solution, which results in obtaining poly-D-lactic acid at a monomer conversion rate of 99.4%. However, when polymerization is performed with the use of an organic solvent as in this proposal, it becomes necessary to dry the organic solvent when using the obtained polymer, and what is more, it is difficult to completely remove the organic solvent from the obtained product by this treatment.

As a method for ring-opening polymerizing a ring-opening-polymerizable monomer without using an organic solvent, there is disclosed a method of ring-opening polymerizing L-lactide with the use of a metal catalyst in the presence of supercritical carbon dioxide (see NPL 1). This disclosed method obtains fine particles of polylactic acid by polymerizing 10 w/v % of L-lactide relative to the supercritical carbon dioxide for 47 hours at a reaction temperature of 80° C. at a pressure of 207 bar with the use of tin octylate as the metal catalyst. However, when polylactic acid is produced by this producing method, there occurs a problem that the metal catalyst tin octylate remains in the obtained product. This is because the catalyst contains metal atoms, which are difficult to remove from the obtained product. The remained tin octylate may degrade the heat resistance and safeness of the obtained product.

As another method for ring-opening polymerizing lactide with the use of supercritical carbon dioxide, there is disclosed a method that uses as a catalyst, an organic catalyst that does not contain metal atoms (see NPL 2). This disclosed method polymerizes lactide by placing lactide and 1,8-diazabicyclo[5.4.0]undeca-7-ene (DBU) or the like as the organic catalyst in an autoclave, stirring them, adding carbon dioxide, and setting the pressure to 250 atm. According to this method, a polymer having a number average molecular weight of about 10,000 is obtained from 16 hours of the reaction.

However, with the method of ring-opening polymerizing a ring-opening-polymerizable monomer with the use of a compressive fluid such as supercritical carbon dioxide, it has been unable to obtain a strong polymer product having a high molecular weight, even by continuing the reaction for a long time, provided that an organic catalyst free from metal atoms is used as a catalyst. There has also been a problem that the durability and the softening temperature of the polymer product may be degraded as influenced by low-molecular-weight components.

Furthermore, this method has also been problematic in that a polymer that contains enantiomers, such as polylactic acid, would be susceptible to racemization as the result of undergoing a long time of reaction.

### CITATION LIST

### Patent Literature

[PTL 1] Japanese Patent Application Laid-Open (JP-A) No. 08-259676
[PTL 2] JP-A No. 2008-63420
[PTL 3] JP-A No. 2005-60474
[PTL 4] JP-A No. 2009-1614

### Non Patent Literature

[NPL 1] Ganapathy, H. S.; Hwang, H. S.; Jeong, Y. T.; LEE, W-T.; Lim, K. T. Eur Polym J. 2007, 43(1), 119-126
[NPL 2] Idriss Blakey, Anguang Yu, Steven M. Howdle, Andrew K. Whittakera, and Kristofer J. Thurechta, Green Chemistry, 2011, Advance Article

### DISCLOSURE OF INVENTION

An object of the present invention is to provide a high-quality polymer product having a high molecular weight and unsusceptible to yellowing.

Another object of the present invention is to provide a high-quality polymer product unsusceptible to yellowing even though containing residual ring-opening-polymerizable monomer in a large amount.

Still another object of the present invention is to provide a polymer product having a high molecular weight, unsusceptible to yellowing, and having a high optical purity and high quality.

Yet another object of the present invention is to provide a polymer product unsusceptible to yellowing even though containing residual ring-opening polymerizable monomer in a large amount and having a high optical purity and high quality.

In a first aspect, a polymer product of the present invention as a means for solving the problems described above has a weight average molecular weight of 250,000 or grater when measured by gel permeation chromatography, and a content of residual ring-opening-polymerizable monomer of 100 ppm by mass or greater but less than 1,000 ppm by mass.

In a second aspect, a polymer product of the present invention has a content of residual ring-opening-polymerizable monomer of from 1,000 ppm by mass to 20,000 ppm by mass, and a yellow index (YI value of 15 or less.

The present invention can provide a high-quality polymer product that can solve the various conventional problems described above, has a high molecular weight, and is unsusceptible to yellowing. Further, the present invention can provide a high-quality polymer product that is unsusceptible to yellowing even though containing residual ring-opening-polymerizable monomer in a large amount.

Still further, the present invention can provide a polymer product having a high molecular weight, unsusceptible to yellowing, and having a high optical purity and high quality.

Yet further, the present invention can provide a polymer product unsusceptible to yellowing even though containing residual ring-opening polymerizable monomer in a large amount and having a high optical purity and high quality.

### BRIEF DESCRIPTION OF DRAWINGS

FIG. 1 is a general phase diagram showing states of a substance with respect to temperature and pressure.

FIG. 2 is a phase diagram for defining the range of a compressive fluid.

FIG. 3 is a system diagram showing an example serial polymerizing step.

FIG. 4 is a system diagram showing another example serial polymerizing step.

FIG. 5A is an exemplary diagram showing a producing system used in a first method.

FIG. 5B is an exemplary diagram showing the producing system used in the first method.

FIG. 6 is an exemplary diagram showing a producing system used in a second method.

FIG. 7 is a system diagram showing an example batch polymerizing step.

FIG. 8 is a system diagram showing another example batch polymerizing step.

### BEST MODE FOR CARRYING OUT THE INVENTION

### (Polymer Product of First Aspect)

A polymer product of the first aspect of the present invention has a weight average molecular weight of 250,000 or greater when measured by gel permeation chromatography, and a content of residual ring-opening-polymerizable monomer of 100 ppm by mass or greater but less than 1,000 ppm by mass.

The weight average molecular weight of the polymer product of the first aspect is 250,000 or greater, preferably 300,000 or greater, more preferably 350,000 or greater, and yet more preferably from 400,000 to 600,000.

When the weight average molecular weight is less than 250,000, the mechanical strength of the polymer product may be insufficient, or the crystallization speed thereof may be slower, so that a long time may be required for molding the polymer product.

Molecular weight distribution (Mw/Mn) of the polymer product of the first aspect, which is obtained by dividing the weight average molecular weight Mw thereof by the number average molecular weight Mn thereof is not particularly limited and may be appropriately selected according to the purpose. However, it is preferably from 1.0 to 2.5, and more preferably from 1.0 to 2.0. When the molecular weight distribution (Mw/Mn) is greater than 2.5, it is probable that the polymerization reaction has progressed non-uniformly, and the physical properties of the polymer product may be difficult to control.

The weight average molecular weight and molecular weight distribution (Mw/Mn) can be measured by gel permeation chromatography (GPC) under the following conditions.

Apparatus: GPC-8020 (manufactured by Tosoh Corporation)
Columns: TSK G2000HXL and G4000HXL (manufactured by Tosoh Corporation)

### Temperature: 40° C.

Solvent: HFIP (hexafluoro isopropanol)
Flow rate: 0.5 mL/min

With the use of a molecular weight calibration curve generated based on a monodisperse polystyrene standard sample, the number average molecular weight (Mn) and the weight average molecular weight (Mw) of the polymer product were calculated from the distribution of molecular weights of the polymer product obtained by injecting a sample having a concentration of 0.5% by mass (1 mL) and measuring it under the above conditions. The molecular weight distribution is a value obtained by dividing Mw by Mn.

The content of residual ring-opening-polymerizable monomer in the polymer product of the first aspect is 100 ppm by mass or greater but less than 1,000 ppm by mass (0.01% by mass or greater but less than 0.1% by mass). When the content is greater than 1,000 ppm by mass (0.1% by mass), the thermal characteristic of the polymer product may be degraded to deteriorate the heat resistant stability, and in addition, the polymer product may be susceptible to decomposition, because a carboxylic acid that is produced when the residual ring-opening-polymerizable monomer is ring-opened has a catalytic function of promoting hydrolysis.

The content of the residual ring-opening-polymerizable monomer can be represented by, for example, mass fraction [the mass of the residual ring-opening-polymerizable monomer/the total amount of the ring-opening-polymerizable monomer (=the mass of the polymer product containing the residual ring-opening-polymerizable monomer)]. The content of the residual ring-opening-polymerizable monomer can be measured based on “Voluntary standards for container packaging of food with synthetic resins such as polyolefin, 3^{rd} revision, supplemented in June, 2004, chapter 3, hygienic test methods”.

A yellow index (YI) value of the polymer product of the first aspect is not particularly limited and may be appropriately selected according to the purpose. However, it is preferably 15 or less, more preferably 10 or less, and still more preferably 5 or less. When the Y1 value is greater than 15, the polymer product may be problematic in terms of appearance, and this problem may be conspicuous when the polymer product is used particularly as a packaging container.

The yellow index (YI) value can be obtained by manufacturing a resin pellet having a thickness of, for example, 2 mm, and measuring it with an SM color computer (manufactured by Suga Test Instruments Co., Ltd.) according to JIS-K7103.

The polymer product of the first aspect, which is high in the molecular weight as having the weight average molecular weight of 250,000 or greater and has a content of residual ring-opening-polymerizable monomer of from 1,000 ppm by mass to 20,000 ppm by mass can be produced by performing polymerization at a polymerization pressure of 35 MPa or greater according to a polymer product producing method of the present invention to be described later.

Polymerization at a polymerization pressure of 35 MPa or greater can suppress racemization of a polymer product that contains enantiomers such as polylactic acid, and can impart an optical purity of 90% or higher even when the weight average molecular weight is high, such as 250,000 or greater.

The optical purity is preferably 90% or higher, more preferably 95% or higher, and yet more preferably 99% or higher. When the optical purity is 90% or higher, it is easy for crystallization to progress, and heat resistance of the polymer product will be improved.

When the optical purity is 90% or lower, heat resistance of the polymer product may be poor. The optical purity is preferably 99.99% or lower. When the optical purity is higher than 99.99%, the polymer product may be brittle.

The optical purity can be obtained as follows.

Optical purity (% ee)=100××|amount of L form−amount of D form |/(amount of L form+amount of D form)

That is, an optical purity is a value obtained by multiplying “a value obtained by dividing ‘a difference (absolute value) between an amount of L form of optically active polymer [% by mass] and an amount of D form of optically active polymer [% by mass]’ by ‘a sum of the amount of L form of optically active polymer [% by mass] and the amount of D form of optically active polymer [% by mass]’” by “100”.

The amount of L form of optically active polymer [% by mass] and the amount of D form of optically active polymer [% by mass] are the values obtained according to the following method using high-performance liquid chromatography (HPLC).

### —Measurement of Amount of L Form and Amount of D Form of Resin (Optically Active Polymer)—

A sample was subjected to frost shattering, and the obtained powder was refluxed in a 1N sodium hydroxide aqueous solution for 3 hours. The resulting solution was neutralized, and after this, filtered and subjected to HPLC.

### —HPLC Measurement Condition—

### Measuring Instrument

HPLC LC-2000 type system manufactured by JASCO Corporation

### Column

SUMICHIRAL OA5000 manufactured by Sumika Chemical Analysis Service, Ltd.

Column temperature

25° C.

Mobile phase

2 mM-CuSO₄ aqueous solution/2-propanol=95/5

Flow rate of mobile phase

1.0 mL/minute

### Detector

Ultraviolet detector (UV 254 nm)

### (Polymer Product of Second Aspect)

The polymer product of the second aspect of the present invention has a content of residual ring-opening-polymerizable monomer of from 1,000 ppm by mass to 20,000 ppm by mass, and a yellow index (YI) value of 15 or less.

The content of residual ring-opening-polymerizable monomer in the polymer product of the second aspect is from 1,000 ppm by mass to 20,000 ppm by mass (from 0.1% by mass to 2% by mass), and preferably from 1,000 ppm by mass to 10,000 ppm by mass (from 0.1% by mass to 1% by mass).

When the content is greater than 20,000 ppm by mass (2% by mass), the thermal characteristic of the polymer product may be degraded to deteriorate the heat resistant stability, and in addition, the polymer product may be susceptible to decomposition, because a carboxylic acid that is produced when the residual ring-opening-polymerizable monomer is ring-opened has a catalytic function of promoting hydrolysis.

The content of residual ring-opening-polymerizable monomer in the polymer product of the second aspect can be measured according to the same method of measuring the content of residual ring-opening-polymerizable monomer in the polymer product of the first aspect.

The yellow index (YI) value of the polymer product of the second aspect is 15 or less, preferably 10 or less, and more preferably 5 or less. When the YI value is greater than 15, the polymer product may be problematic in terms of appearance, and this problem may be conspicuous when the polymer product is used particularly as a packaging container.

The yellow index (YI) value of the polymer product of the second aspect can be measured according to the same method of measuring the YI value of the polymer product of the first aspect.

The weight average molecular weight of the polymer product of the second aspect is not particularly limited and may be appropriately selected according to the purpose. However, it is preferably 10,000 or greater, more preferably 100,000 or greater, and still more preferably from 100,000 or greater but less than 300,000. When the weight average molecular weight is less than 10,000, the mechanical strength of the polymer product may be insufficient.

The weight average molecular weight of the polymer product of the second aspect can be measured according to the same method of measuring the weight average molecular weight of the polymer product of the first aspect.

The polymer product of the second aspect, of which content of residual ring-opening-polymerizable monomer is from 1,000 ppm by mass to 20,000 ppm by mass, and of which yellow index (YI) value is 15 or less, can be produced by performing polymerization at a polymerization pressure of 35 MPa or greater, according to a polymer product producing method of the present invention to be described later.

Polymerization at a polymerization pressure of 35 MPa or greater can suppress racemization of a polymer product that contains enantiomers, such as polylactic acid.

The optical purity of the polymer product of the second aspect is not particularly limited and may be appropriately selected according to the purpose. However, the optical purity is preferably 90% or higher, more preferably 95% or higher, and still more preferably 99% or higher.

When the optical purity is 90% or higher, it is easy for crystallization to progress, and heat resistance of the polymer product will be improved. When the optical purity is lower than 90%, heat resistance of the polymer product may be poor.

The optical purity is preferably 99.99% or lower. When the optical purity is higher than 99.99%, the polymer product may be brittle.

The optical purity of the polymer product of the second aspect can be measured according to the same method as the method for measuring the optical purity of the polymer product of the first aspect.

As described above, the polymer product of the first aspect is a high-quality product that has a small content of residual ring-opening-polymerizable monomer, a high molecular weight, and a high strength, and is unsusceptible to yellowing. It is also a high-quality product that has a high optical purity and a high heat resistance.

As described above, the polymer product of the second aspect is a high-quality product unsusceptible to yellowing even though having a large content of residual ring-opening-polymerizable monomer. It is also a high-quality product that has a high optical purity and a high heat resistance.

The polymer products of the first and second aspects are obtained by polymerizing a ring-opening-polymerizable monomer while bringing the ring-opening-polymerizable monomer and a compressive fluid into contact with each other, as will be explained in a polymer product, producing method to be described later, are not particularly limited, and may be appropriately selected according to the purpose. However, they are preferably a polyester that is obtained by using lactide or the like as the ring-opening-polymerizable monomer.

The polymer products of the first and second aspects are preferably a copolymer including 2 or more kinds of polymer segments.

The polymer products are preferably a stereo complex.

Here, to explain by taking a stereo complex polylactic acid for example, a “stereo complex” means a polylactic acid composition that contains a poly D-lactic acid component and a poly L-lactic acid component, that contains a stereo complex crystal, and that has a stereo complex crystallinity of 90% or greater, where the stereo complex crystallinity is expressed by the following formula (i).

Stereo complex crystallinity (S) can be calculated from the following formula (i) based on heat of melting (ΔHmh) of a polylactic acid homocrystal that is observed at lower than 190° C. in differential scanning calorimetry (DSC), and heat of melting (ΔHmsc) of a polylactic acid stereo complex that is observed at 190° C. or higher in differential scanning calorimetry.

(S)=[ΔHmsc/(ΔHmh+ΔHmsc)]×100

The polymer products of the first and second aspects of the present invention have a high molecular weight and a high strength, and do not cause yellowing. Therefore, these polymer products may be shaped or molded to, for example, particles, film, sheet, moldings, fiber, and foam, to be used for wide applications such as daily necessities, industrial materials, agricultural tools, hygienic materials, medical products, cosmetics, electrophotographic toners, packaging materials, electric equipment materials, home appliances casings, and automobile materials.

The polymer products of the first and second aspects of the present invention are produced according to a polymer product producing method and by a polymer product producing apparatus to be explained below.

### (Polymer Product Producing Method and Polymer Product Producing Apparatus)

The polymer product producing method of the present invention includes at least a polymerizing step, and includes other steps according to necessity.

The polymer product producing apparatus of the present invention includes at least a polymerizing unit and an extruding unit, and further includes other units according to necessity.

The polymer product producing method and polymer product producing apparatus of the present invention will be explained in detail below.

### <Polymerizing Step and Polymerizing Unit>

The polymerizing step is a step of bringing a ring-opening-polymerizable monomer, a compressive fluid, and according to necessity, other components into contact with one another to thereby ring-opening polymerize the ring-opening-polymerizable monomer, and is performed by the polymerizing unit.

In the polymerizing step, it is necessary to bring the ring-opening-polymerizable monomer and the compressive fluid into contact with each other at a pressure of 35 MPa or higher. The pressure is preferably from 35 MPa to 65 MPa. When the pressure is lower than 35 MPa, the polymer to be obtained may not have a high molecular weight, and may have a large content of residual ring-opening-polymerizable monomer. On the other hand, when the pressure is higher than 65 MPa, it may be difficult to control the pressure.

When the pressure becomes 35 MPa or higher, the polymer will undergo a rapid increase of plasticization to become more soluble, which is more convenient for obtaining a polymer product having a higher molecular weight with a less content of residual ring-opening-polymerizable monomer.

The pressure is controlled based on, for example, flow rate, pipe diameter, pipe length, and pipe shape of a pump.

When the pressure becomes 35 MPa or higher, the polymer will undergo a rapid increase of plasticization to become more soluble, which makes it harder for racemization to occur.

The polymerization reaction temperature in the polymerizing step is not particularly limited and may be appropriately selected according to the purpose. However, it is preferably 200° C. or lower, and more preferably from 40° C. to 180° C.

When the polymerization reaction temperature exceeds 200° C., it becomes likely that depolymerization reaction, which is a reverse reaction of the ring-opening polymerization, will occur in equilibrium, which makes it harder for the polymerization reaction to progress quantitatively. Moreover, racemization of the polymer product may progress.

On the other hand, when the polymerization reaction temperature is lower than 40° C., some kinds of ring-opening-polymerizable monomers might take a longer time to be melted by the compressive fluid or might result in being insufficiently melted, or the activity of the catalyst might be weakened. This tends to slow down the reaction speed of the polymerization, and may make it impossible to progress the polymerization reaction quantitatively.

The polymerization reaction temperature is controlled, for example, by a heater provided in the polymerization reaction apparatus, by heating from outside, or the like.

The polymerizing step may be performed serially or batch wise.

In the polymerizing step, a polymerization reaction at a low temperature can be realized with the use of the compressive fluid. Therefore, as compared with conventional melt polymerization, depolymerization can be greatly suppressed. This can realize a polymer conversion rate of 96 mol % or greater, preferably 98 mol % or greater. When the polymer conversion rate is less than 96 mol %, a polymer-containing product to be obtained will have an insufficient thermal characteristic, which may make it necessary to perform an additional operation for removing the ring-opening-polymerizable monomer. Polymer conversion rate here means a rate of ring-opening-polymerizable monomer contributed to polymer production to ring-opening-polymerizable monomer as the raw material. The amount of ring-opening-polymerizable monomer contributed to polymer production can be obtained by subtracting the amount of unreacted ring-opening-polymerizable monomer (the amount of residual ring-opening-polymerizable monomer) from the amount of produced polymer.

### <<Ring-Opening-Polymerizable Monomer>>

The ring-opening-polymerizable monomer is not particularly limited and may be appropriately selected according to the purpose. However, a ring-opening-polymerizable monomer containing a carbonyl group in the ring is preferable. The carbonyl group is constituted by a π-bond between highly electronegative oxygen and carbon. In the carbonyl group, oxygen attracts n-bond electrons to thereby have itself polarize negatively and have carbon polarize positively. Therefore, the carbonyl group is highly reactive. When the compressive fluid is carbon dioxide, it is estimated that the level of affinity between carbon dioxide and the polymer product to be obtained will be high, because the carbonyl group is similar to the structure of carbon dioxide. Assisted by these effects, an effect of plasticization by the compressive fluid to the polymer to be obtained will be high. A ring-opening-polymerizable monomer containing an ester bond is more preferable as the ring-opening-polymerizable monomer containing a carbonyl group in the ring.

Examples of the ring-opening-polymerizable monomer include cyclic ester and cyclic carbonate.

### —Cyclic Ester—

The cyclic ester is not particularly limited and may be appropriately selected according to the purpose. However, preferable are cyclic dimers obtained by dehydration-condensing an L-form, a D-form, or both thereof of a compound represented by General Formula (1) below.

R—C*—H(—OH)(—COOH) General Formula (1)

In General Formula (1), R represents an alkyl group containing 1 to 10 carbon atoms, and C* represents asymmetric carbon.

Examples of the compound represented by General Formula (1) above include enantiomers of lactic acid, enantiomers of 2-hydroxybutanoic acid, enantiomers of 2-hydroxypentanoic acid, enantiomers of 2-hydroxyhexanoic acid, enantiomers of 2-hydroxyheptanoic acid, enantiomers of 2-hydroxyoctanoic acid, enantiomers of 2-hydroxynonanoic acid, enantiomers of 2-hydroxydecanoic acid, enantiomers of 2-hydroxyundecanoic acid, and enantiomers of 2-hydroxydodecanoic acid. Among these, enantiomers of lactic acid are particularly preferable since they are highly reactive and readily available.

Examples of the cyclic ester include aliphatic lactone. Examples of the aliphatic lactone include β-propiolactone, β-butyrolactone, γ-butyrolactone, γ-hexanolactone, γ-octanolactone, δ-valerolactone, δ-hexanolactone, δ-octanolactone, ε-caprolactone, δ-dodecanolactone, α-methyl-γ-butyrolactone, β-methyl-δ-valerolactone, glycolide and lactide. Among these, ε-caprolactone is preferable since it is highly reactive and readily available.

### —Cyclic Carbonate—

The cyclic carbonate is not particularly limited and may be appropriately selected according to the purpose. Examples thereof include ethylene carbonate and propylene carbonate.

One of these ring-opening-polymerizable monomers may be used alone, or two or more of these may be used in combination.

### <<Compressive Fluid>>

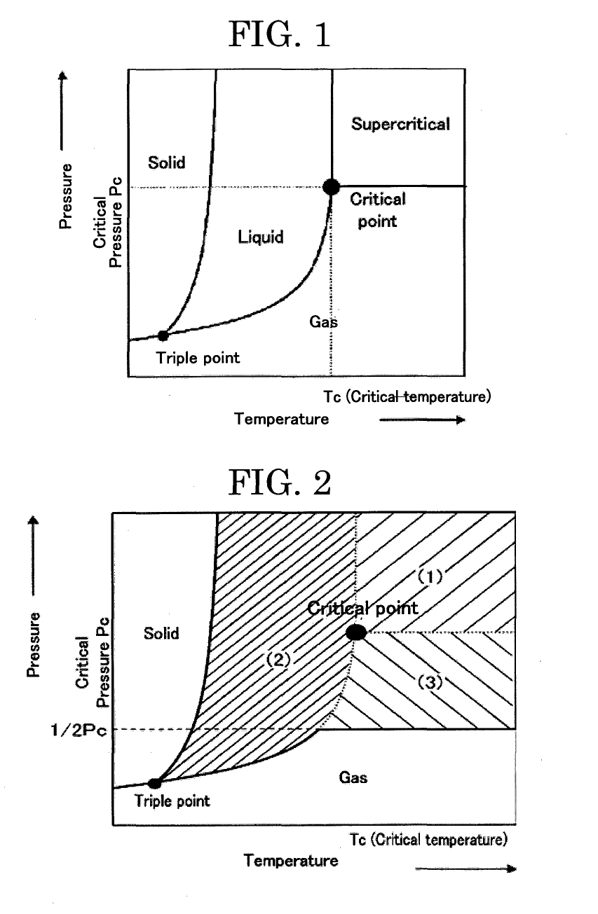

The compressive fluid will be explained with reference to FIG. 1 and FIG. 2. FIG. 1 is a phase diagram showing states of a substance relative to temperature and pressure. FIG. 2 is a phase diagram for defining the range of the compressive fluid.

A “compressive fluid” means a state of a substance when it is present in any of (1), (2), and (3) shown in FIG. 2 in the phase diagram shown in FIG. 1.

A “compressive fluid” means a substance, of which state is present in any of (1), (2), and (3) shown in FIG. 2 in the phase diagram shown in FIG. 1.

In these regions, a substance is known to have a very high density and show different behaviors from when it is at normal temperature and normal pressures. When a substance is in the region (1), it is a supercritical fluid. A supercritical fluid is a fluid that exists as a non-condensable high-density fluid in a temperature/pressure region above a limit (critical point) until which a gas and a liquid can coexist, and does not condense when compressed. When a substance is in the region (2), it is a liquid. However, in the present invention, a substance in the region (2) means a liquefied gas obtained by compressing a substance that has a gaseous state at normal temperature (25° C.) and normal pressures (1 atm). When a substance is in the region (3), it has a gaseous state. However, in the present invention, a substance in the region (3) means a high-pressure gas, of which pressure is equal to or higher than ½ of the critical pressure (Pc), i.e., ½Pc or higher.

Examples of the substance to constitute the compressive fluid include carbon monoxide, carbon dioxide, dinitrogen monoxide, nitrogen, methane, ethane, propane, 2,3-dimethylbutane, and ethylene. Among these, carbon dioxide is preferable, because a supercritical state thereof is easy to produce since the critical pressure thereof is about 7.4 MPa and the critical temperature thereof is about 31° C., and because it is incombustible and easy to handle. One of these compressive fluids may be used alone, or two or more of these may be used in combination.

Carbon dioxide is reactive with a substance having basicity and nucleophilicity. Therefore, conventionally, carbon dioxide has been considered unable to use as a solvent for performing living anion polymerization (see “Latest Applied Technique for Using Supercritical Fluid”, page 173, Mar. 15, 2004, published by NTS Incorporation). However, the present inventors have overthrown the conventional findings. That is, the present inventors have found out that even under supercritical carbon dioxide, a catalyst having basicity and nucleophilicity stably coordinates to a ring-opening-polymerizable monomer to ring-open the ring-opening-polymerizable monomer, to thereby allow the polymerization reaction to progress quantitatively in a short time, to consequently allow the polymerization reaction to progress in a living fashion. The living fashion here means that a reaction progresses quantitatively without side reactions such as migration reaction and termination reaction, to thereby result in a polymer product, of which molecular weight distribution is relatively narrow and monodisperse.

### <<Other Components>>

The other components are not particularly limited and may be appropriately selected according to the purpose. Examples include an initiator, a catalyst, and an additive.

### —Initiator—

The initiator is used for controlling the molecular weight of the polymer product to be obtained by ring-opening polymerization.

The initiator is not particularly limited and may be appropriately selected according to the purpose. For example, when the initiator is an alcohol, it may be either of aliphatic monoalcohol and aliphatic polyhydric alcohol, and it may be either of saturated alcohol and unsaturated alcohol.

Examples of the initiator include monoalcohol, polyhydric alcohol, and lactic acid ester. Examples of the monoalcohol include methanol, ethanol, propanol, butanol, pentanol, hexanol, heptanol, nonanol, decanol, lauryl alcohol, myristyl alcohol, cetyl alcohol, and stearyl alcohol. Examples of the polyhydric alcohol include: dialcohol such as ethylene glycol, 1,2-propanediol, 1,3-propanediol, 1,3-butanediol, 1,4-butanediol, hexanediol, nonanediol, tetramethylene glycol, and polyethylene glycol; glycerol; sorbitol; xylitol; ribitol; erythritol; and triethanol amine. Examples of the lactic acid ester include methyl lactate, and ethyl lactate. One of these may be used alone, or two or more of these may be used in combination.

A polymer product containing an alcohol residue at the terminal, such as polycaprolactonediol and polytetramethyleneglycol may also be used as the initiator. Use of such an initiator allows for synthesizing a diblock copolymer, a triblock copolymer, or the like.

The amount of use of the initiator in the polymerizing step may be appropriately adjusted according to the target molecular weight. It is preferably from 0.1 mol to 5 mol relative to 100 mol of the ring-opening-polymerizable monomer. In order to prevent the polymerization from being initiated non-uniformly, it is preferable to mix the ring-opening-polymerizable monomer and the initiator well in advance of bringing the ring-opening-polymerizable monomer into contact with the catalyst.

### —Catalyst—

The catalyst is not particularly limited and may be appropriately selected according to the purpose. Examples thereof include an organic catalyst and a metal catalyst.

### ——Organic Catalyst——

The organic catalyst is not particularly limited and may be appropriately selected according to the purpose. A preferable organic catalyst is a catalyst that does not contain metal atoms, contributes to the ring-opening polymerization reaction of the ring-opening-polymerizable monomer, and can be desorbed through reaction with an alcohol and reclaimed after it forms an active intermediate with the ring-opening-polymerizable monomer.

For example, for polymerization of a ring-opening-polymerizable monomer containing an ester bond, the organic catalyst is preferably a (nucleophilic) compound that functions as a nucleophile having basicity, more preferably a compound containing a nitrogen atom, and particularly preferably a cyclic compound containing a nitrogen atom. Such a compound is not particularly limited and may be appropriately selected according to the purpose. Examples thereof include cyclic monoamine, cyclic diamine (e.g., a cyclic diamine compound having an amidine skeleton), a cyclic triamine compound having a guanidine skeleton, a heterocyclic aromatic organic compound containing a nitrogen atom, and N-heterocyclic carbene. A cationic organic catalyst may be used for ring-opening polymerization. However, in this case, the catalyst may withdraw hydrogen from the main chain of the polymer (back-biting) to broaden the molecular weight distribution, which makes it difficult to obtain a product having a high molecular weight.

Examples of the cyclic monoamine include quinuclidine.

Examples of the cyclic diamine include 1,4-diazabicyclo-[2.2.2]octane (DABCO) and 1,5-diazabicyclo(4,3,0)-5-nonene.

Examples of the cyclic diamine compound having an amidine skeleton include 1,8-diazabicyclo[5.4.0]undec-7-ene (DBU) and diazabicyclononene.

Examples of the cyclic triamine compound having a guanidine skeleton include 1,5,7-triazabicyclo[4.4.0]dec-5-ene (TBD) and diphenylguanidine (DPG).

Examples of the heterocyclic aromatic organic compound containing a nitrogen atom include N,N-dimethyl-4-aminopyridine (DMAP), 4-pyrrolidinopyridine (PPY), pyrrocolin, imidazole, pyrimidine and purine.

Examples of the N-heterocyclic carbene include 1,3-di-tert-butylimidazol-2-ylidene (ITBU).

Among these, DABCO, DBU, DPG, TBD, DMAP, PPY, and ITBU are preferable, as they have high nucleophilicity without being greatly affected by steric hindrance, or they have such boiling points that they can be removed at a reduced pressure.

Among these organic catalysts, for example, DBU has a liquid state at room temperature and has a boiling point. When such an organic catalyst is selected, it is possible to substantially quantitatively remove the organic catalyst from the obtained polymer product by treating the polymer product at a reduced pressure. The kind of the organic catalyst and whether or not to perform the treatment for removing it are determined according to for what application the product is used.

### ——Metal Catalyst——

The metal catalyst is not particularly limited and may be appropriately selected according to the purpose. Examples thereof include a tin-based compound, an aluminum-based compound, a titanium-based compound, a zirconium-based compound, and an antimony-based compound.

Examples of the tin-based compound include tin octylate, tin dibutylate, and tin di(2-ethylhexanoate).

Examples of the aluminum-based compound include aluminum acetyl acetonate and aluminum acetate.

Examples of the titanium-based compound include tetraisopropyl titanate and tetrabutyl titanate.

Examples of the zirconium-based compound include zirconium isopropoxide.

Examples of the antimony-based compound include antimony trioxide.

The kind and amount of use of the catalyst cannot be flatly specified because they depend on the combination of the compressive fluid and the ring-opening-polymerizable monomer. However, the amount of use thereof is preferably from 0.01 mol to 15 mol, more preferably from 0.1 mol to 1 mol, and particularly preferably from 0.3 mol to 0.5 mol relative to 100 mol of the ring-opening-polymerizable monomer. When the amount of use thereof is less than 0.1 mol, the catalyst will get deactivated before the polymerization reaction is completed, which may make it impossible to obtain a polymer product having the target molecular weight. On the other hand, when the amount of use thereof is greater than 15 mol, it may be difficult to control the polymerization reaction.

As the catalyst to be used in the polymerizing step, the organic catalyst (an organic catalyst free from metal atoms) is preferably used for the applications in which safeness and stability are required of the product.

### —Additive—

In the polymerizing step, an additive may be added according to necessity. Examples of the additive include a surfactant and an antioxidant.

As the surfactant, one that melts in the compressive fluid and has affinity with both of the compressive fluid and the ring-opening-polymerizable monomer is preferably used. Use of such a surfactant allows the polymerization reaction to progress uniformly, making it possible to obtain a product having a narrow molecular weight distribution, and making it easier to obtain a polymer product in a particle state. When the surfactant is used, it may be added to the compressive fluid or it may be added to the ring-opening-polymerizable monomer. For example, when carbon dioxide is used as the compressive fluid, a surfactant containing a carbon dioxide-philic group and a monomer-philic group in the molecule is used. Examples of such a surfactant include a fluorine-based surfactant and a silicone-based surfactant.

### <Extruding Unit>

The polymer product of the present invention has a high molecular weight. Therefore, with the use of the extruding unit, it is possible to take out the polymer product smoothly.

The extruding unit is a unit configured to extrude a polymerization product obtained by the polymerizing unit to the outside. Examples thereof include a gear pump, a uniaxial extruder, and a multiaxial extruder.

### <Other Steps and Other Units>

The other steps are not particularly limited and may be appropriately selected according to the purpose. Examples thereof include a cooling step, a drying step, and an extruding step.

The other units are not particularly limited and may be appropriately selected according to the purpose. Examples thereof include a cooling unit and a drying unit.

Here, a producing apparatus for producing the polymer product of the present invention will be explained with reference to the drawings.

### First Embodiment

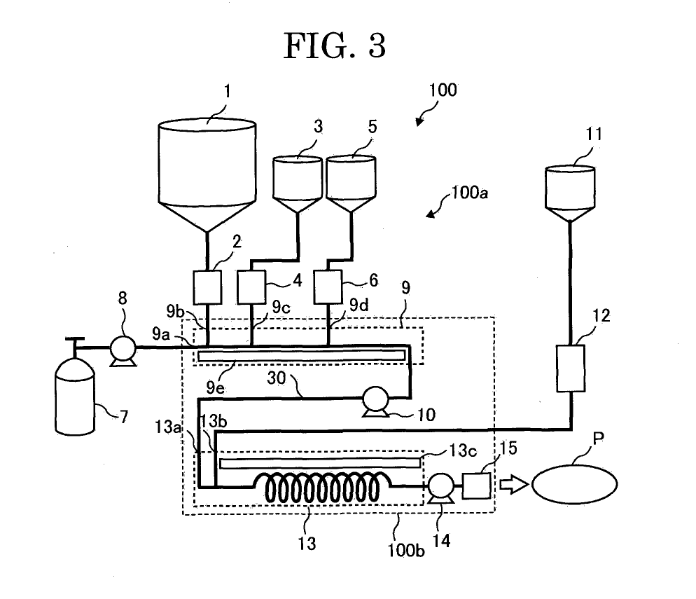

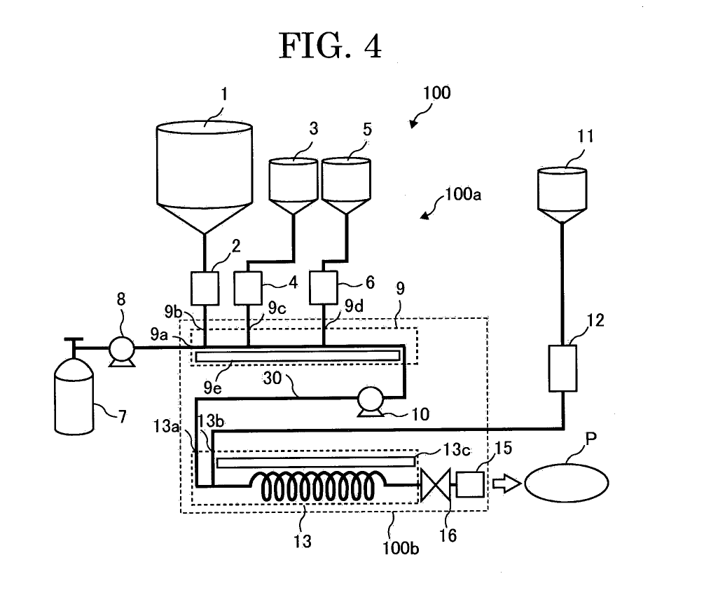

FIG. 3 and FIG. 4 are system diagrams showing an example polymerizing steps. In the system diagram of FIG. 3, a polymerization reaction apparatus 100 includes a supply unit 100a configured to supply a ring-opening-polymerizable monomer and a compressive fluid, and a polymerization reaction apparatus body 100b as an example polymer product producing apparatus configured to polymerize the ring-opening-polymerizable monomer supplied by the supply unit 100a. The supply unit 100a includes tanks (1, 3, 5, 7, 11), gauge feeders (2, 4), and gauge pumps (6, 8, 12). The polymerization reaction apparatus body 100b includes a contact region 9 provided at one end portion of the polymerization reaction apparatus body 100b, a liquid conveying pump 10, a reacting region 13, a gauge pump 14, and an extruding cap 15 provided at the other end portion of the polymerization reaction apparatus body 100b.

The tank 1 of the supply unit 100a stores a ring-opening-polymerizable monomer. The ring-opening-polymerizable monomer to be stored may be powder or a liquid state. The tank 3 stores a solid (powder or granular) one of the initiator and the additive. The tank 5 stores a liquid one of the initiator and the additive. The tank 7 stores a compressive fluid. The tank 7 may store a gaseous matter (a gas) or a solid that turns to a compressive fluid through the process of being supplied to the contact region 9, or that turns to a compressive fluid by being heated or pressurized in the contact region 9. In this case, the gaseous matter or the solid stored in the tank 7 will become the state of (1), (2), or (3) of the phase diagram of FIG. 2 in the contact region 9 by being heated or pressurized.

The gauge feeder 2 weighs the ring-opening-polymerizable monomer stored in the tank 1 and supplies it to the contact region 9 serially. The gauge feeder 4 weighs the solid stored in the tank 3 and supplies it to the contact region 9 serially. The gauge pump 6 weighs the liquid stored in the tank 5 and supplies it to the contact region 9 serially. The gauge pump 8 supplies the compressive fluid stored in the tank 7 to the contact region 9 serially at a constant pressure at a constant flow rate. In the present embodiment, to supply serially is a notion opposed to supplying batch wise, and means to supply the ring-opening-polymerizable monomer such that the polymer product to be obtained by ring-opening polymerizing the ring-opening-polymerizable monomer can be obtained serially. That is, as long as the polymer product to be obtained by ring-opening polymerizing the ring-opening-polymerizable monomer can be obtained serially, the respective materials may be supplied intermissively or intermittently. When both of the initiator and the additive are solid, the polymerization reaction apparatus 100 needs not include the tank 5 and the gauge pump 6. Likewise, when both of the initiator and the additive are liquid, the polymerization reaction apparatus 100 needs not include the tank 3 and the gauge feeder 4.

In the present embodiment, the polymerization reaction apparatus body 100b is a tubular apparatus that includes at one end portion thereof, a monomer inlet through which the ring-opening-polymerizable monomer is introduced, and at the other end portion thereof, an outlet through which the polymer product obtained by polymerizing the ring-opening-polymerizable monomer is discharged. The polymerization reaction apparatus body 100b also includes at the one end portion thereof, a compressive fluid inlet through which the compressive fluid is introduced, and at a portion between the one end portion and the other end portion, a catalyst inlet through which a catalyst is introduced. The respective devices of the polymerization reaction apparatus body 100b are connected as shown in FIG. 3 via a pressure-tight tube 30 through which the raw materials, the compressive fluid, or the produced polymer product is conveyed. The respective devices of the contact region 9, the liquid conveying pump 10, and the reacting region 13 of the polymerization reaction apparatus include a tubular member through which the raw materials, etc. are passed.

The contact region 9 of the polymerization reaction apparatus body 100b is constituted by a pressure-tight apparatus or tube in which to bring the raw materials such as the ring-opening-polymerizable monomer, the initiator, and additive supplied from the tanks (1, 3, 5) into contact with the compressive fluid supplied from the tank 7 serially to mix the raw materials (for example, to melt or dissolve the ring-opening-polymerizable monomer and the initiator). In the present embodiment, to be melted means that the raw materials or the produced polymer product are/is swollen upon contact with the compressive fluid to be thereby plasticized or liquefied. To be dissolved means that the raw materials flux in the compressive fluid. A fluid phase is formed when the ring-opening-polymerizable monomer is dissolved, and a melt phase is formed when it is melted. In order for the reaction to progress uniformly, it is preferable that either a melt phase or a fluid phase be formed. Further, in order for the reaction to progress with the ratio of the raw materials being higher than the ratio of the compressive fluid, it is preferable to melt the ring-opening-polymerizable monomer. In the present embodiment, by supplying the raw materials and the compressive fluid serially, it is possible to bring the raw materials such as the ring-opening-polymerizable monomer and the compressive fluid into contact with each other serially in the contact region 9 at a constant concentration ratio. This allows the raw materials to be mixed efficiently (for example, allows the ring-opening-polymerizable monomer and the initiator to be melted or dissolved efficiently).

The contact region 9 may be constituted by either a tank-shaped apparatus or a tubular apparatus. However, it is preferably constituted by a tubular apparatus, from one end of which the raw materials are supplied, and from the other end of which a mixture such as a melt phase or a fluid phase is taken out. Further, the contact region 9 may include a stirrer configured to stir the raw materials, the compressive fluid, etc. When the contact region 9 includes a stirrer, preferable examples of the stirrer include a uniaxial screw, biaxial screws meshing with each other, a biaxial mixer including multiple stirring elements meshing or overlapping with each other, a kneader including helical stirring elements meshing with each other, and a static mixer. Particularly, biaxial or multiaxial stirrers meshing with each other are preferable because few deposits of the reaction product will occur in these stirrers and containers, and these stirrers have a self-cleaning functionality. When the contact region 9 does not include a stirrer, it is preferable that the contact region 9 be constituted by part of the pressure-tight tube 30. When the contact region 9 is constituted by the tube 30, it is preferable that the ring-opening-polymerizable monomer to be supplied to the contact region 9 be liquefied in advance, in order to ensure that the raw materials will be mixed in the contact region 9 infallibly.

The contact region 9 is provided with an inlet 9a as an example compressive fluid inlet through which the compressive fluid supplied from the tank 7 by the gauge pump 8 is introduced, an inlet 9b as an example monomer inlet through which the ring-opening-polymerizable monomer supplied from the tank 1 by the gauge feeder 2 is introduced, an inlet 9c through which powder supplied from the tank 3 by the gauge feeder 4 is introduced, and an inlet 9d through which the liquid supplied from the tank 5 by the gauge pump 6 is introduced. In the present embodiment, the inlets (9a, 9b, 9c, 9d) are each constituted by a joint that connects a tubular member such as a cylinder or part of the tube 30 through which the raw materials, etc. are supplied in the contact region 9 to a corresponding tube from which each raw material or the compressive fluid is conveyed. The joint is not particularly limited, and examples thereof include publicly-known joints such as a reducer, a coupling, Y, T, and an outlet. The contact region 9 also includes a heater 9e for heating the raw materials and the compressive fluid supplied thereto.

The liquid conveying pump 10 conveys a mixture such as a melt phase or a fluid phase formed in the contact region 9 to the reacting region 13. The tank 11 stores a catalyst. The gauge pump 12 weighs the catalyst stored in the tank 11 and supplies it to the reacting region 13.

The reacting region 13 is constituted by a pressure-tight apparatus or tube in which to mix the raw materials conveyed by the liquid conveying pump 10 with the catalyst supplied by the gauge pump 12 to thereby ring-opening polymerize the ring-opening-polymerizable monomer. The reacting region 13 may be constituted by a tank-shaped apparatus or a tubular apparatus. However, it is preferably constituted by a tubular apparatus because one has little dead space. The reacting region 13 may also include a stirrer configured to stir the raw materials, the compressive fluid, etc. As the stirrer of the reacting region 13, screws meshing with each other, a 2-flight (oval) or 3-flight (triangular) stirring element, and a biaxial or multiaxial stirrer including a stirring blade having a disk shape or a multi-leaf shape (e.g., a clover shape) are preferable in terms of self-cleaning ability. When the raw materials including the catalyst are mixed well in advance, a static mixer configured to divide and combine (converge) flows through multi-stages in a guide device may also be used as the stirrer. Examples of the static mixer include those disclosed in Japanese Patent Application Publications (JP-B) Nos. 47-15526, 47-15527, 47-15528, and 47-15533 (multi-stage mixing type), one disclosed in JP-A No. 47-33166 (Kenics type), and a mixer similar to those listed above including no movable member. When the reacting region 13 does not include a stirrer, the reacting region 13 is constituted by part of the pressure-tight tube 30. In this case, the shape of the tube is not particularly limited, but a preferable shape is a helical shape, in order to reduce the size of the apparatus.

The reacting region 13 is provided with an inlet 13a through which the raw materials mixed in the contact region 9 are introduced, and an inlet 13b as an example catalyst inlet through which the catalyst supplied from the tank 11 by the gauge pump 12 is introduced. In the present embodiment, the inlets (13a, 13b) are each constituted by a joint that connects a tubular member such as a cylinder or part of the tube 30 through which the raw materials, etc. are passed in the reacting region 13 to each tube from which each raw material or the compressive fluid is supplied. The joint is not particularly limited, and examples thereof include publicly-known joints such as a reducer, a coupling, Y, T, and an outlet. The reacting region 13 may also be provided with a gas outlet through which an evaporant is removed. The reacting region 13 also includes a heater 13c for heating the raw materials conveyed therein.

FIG. 3 shows an example in which there is one reacting region 13. However, the polymerization reaction apparatus 100 may include 2 or more reacting regions 13. When there are a plurality of reacting regions 13, the reacting regions 13 may have the same reaction (polymerization) conditions such as temperature, catalyst concentration, pressure, average retention time, and stirring speed. However, it is preferable to select optimum conditions separately in accordance with the respective degrees of progress of the polymerization. It is not advisable to couple too many reacting regions 13 multi-stages, because this would increase the reaction time or complicate the apparatus. The number of stages is preferably from 1 to 4, and particularly preferably from 1 to 3.

Generally, when polymerization is performed with only one reacting region, the degree of polymerization of the polymer product to be obtained from the ring-opening polymerization of the ring-opening-polymerizable monomer and the amount of residual monomer tend to be unstable and fluctuate, which is considered unsuitable for industrial production. This is considered due to instability attributed to mixed presence of the raw materials having a melt viscosity of from several poise to several ten poise and the polymer product resulting from the polymerization having a melt viscosity of several thousand poise. As compared with this, in the present embodiment, the raw materials and the produced polymer product melt (liquefy), which makes it possible to reduce the viscosity difference in the reacting region 13 (also referred to as a polymerization system). Therefore, it is possible to produce a polymer product stably with a less number of stages than in a conventional polymerization reaction apparatus.

The gauge pump 14 discharges the polymer product P resulting from polymerization in the reacting region 13 to the outside of the reacting region 13 through the extruding cap 15. It is also possible to discharge the polymer product P from inside the reacting region 13 without the gauge pump 14, by utilizing the pressure difference between the inside and the outside of the reacting region 13. In this case, in order to adjust the pressure inside the reacting region 13 and the amount of the polymer product P to be discharged, it is also possible to use a pressure adjusting valve 16 as shown in FIG. 4, instead of the gauge pump 14.

### [Polymerizing Step]

Next, a step of polymerizing a ring-opening-polymerizable monomer with the polymerization reaction apparatus 100 will be explained. In the present embodiment, the ring-opening-polymerizable monomer and the compressive fluid are supplied serially and brought into contact with each other, to ring-opening polymerize the ring-opening-polymerizable monomer to obtain a polymer product serially. First, the gauge feeders (2, 4), the gauge pump 6, and the gauge pump 8 are actuated to supply the ring-opening-polymerizable monomer, the initiator, the additive, and the compressive fluid in the tanks (1, 3, 5, 7) serially. Therefore, the raw materials and the compressive fluid are introduced serially into the tube in the contact region 9 through the inlets (9a, 9b, 9c, 9d). Weighing of a solid (powder or granular) raw material might be less precise than weighing of a liquid raw material. In this case, a solid raw material may be melted in advance in order to be stored in the tank 5 and introduced into the tube in the contact region 9 by the gauge pump 6 in its liquid state. The order to actuate the gauge feeders (2, 4), the gauge pump 6, and the gauge pump 8 is not particularly limited. However, if the raw materials in the initial stage are supplied into the reacting region 13 without contacting the compressive fluid, the raw materials might be solidified due to a temperature drop. Therefore, it is preferable to actuate the gauge pump 8 first.

The feeding rates of the raw materials by the gauge feeders (2, 4) and the gauge pump 6 are adjusted to a constant ratio among them, based on a predetermined quantitative ratio among the ring-opening-polymerizable monomer, the initiator, and the additive. The total of the masses of the raw materials supplied per unit time by the gauge feeders (2, 4) and the gauge pump 6 (the total being the raw material feeding rate (g/min)) is adjusted based on desired physical properties of the polymer, the reaction time, etc. Likewise, the mass of the compressive fluid (compressive fluid feeding rate (g/min)) supplied per unit time by the gauge pump 8 is adjusted based on desired physical properties of the polymer, the reaction time, etc. The ratio between the compressive fluid feeding rate and the raw material feeding rate (raw material feeding rate/compressive fluid feeding rate, referred to as feeding ratio) is not particularly limited and may be appropriately selected according to the purpose. However, it is preferably 1 or greater, more preferably 3 or greater, even more preferably 5 or greater, and particularly preferably 10 or greater. The upper limit of the feeding ratio is not particularly limited and may be appropriately selected according to the purpose. However, it is preferably 1,000 or less, more preferably 100 or less, and particularly preferably 50 or less.

With the feeding ratio of 1 or greater, when the raw materials and the compressive fluid are conveyed to the reacting region 13, the reaction will progress in the state where the concentration of the raw materials and the produced polymer product (so-called solid content concentration) is high. The solid content concentration in the polymerization system in this case is greatly different from a solid content concentration in a polymerization system in which polymerization is performed by dissolving a smaller amount of ring-opening-polymerizable monomer in a much greater amount of compressive fluid according to a conventional producing method. The producing method of the present embodiment is characterized in that the polymerization reaction progresses efficiently and stably even in a polymerization system having a high solid content concentration. In the present embodiment, the feeding ratio may be less than 1. Even in this case, the polymer product to be obtained will not have any problem in the quality, but an economical efficiency will be less. When the feeding ratio is greater than 1,000, the capacity of the compressive fluid to dissolve the ring-opening-polymerizable monomer might be insufficient, to make it impossible to progress the intended reaction uniformly.

Since the raw materials and the compressive fluid are introduced into the tube in the contact region 9 serially, they contact each other serially. Therefore, the raw materials such as the ring-opening-polymerizable monomer, the initiator, and the additive mix with one another in the contact region 9. When the contact region 9 includes a stirrer, the raw materials and the compressive fluid may be stirred. In order for the introduced compressive fluid to be prevented from turning to a gas, the temperature and pressure in the tube in the reacting region 13 are controlled to a temperature and pressure that are equal to or greater than at least the triple point of the compressive fluid. This control is performed by adjusting the power of the heater 9e in the contact region 9 or the feeding rate of the compressive fluid. In the present embodiment, the temperature when melting the ring-opening-polymerizable monomer may be a temperature that is equal to or lower than the melting point of the ring-opening-polymerizable monomer at normal pressures. This is considered possible because the contact region 9 internally becomes a high-pressure state in the presence of the compressive fluid to thereby lower the melting point of the ring-opening-polymerizable monomer to below the melting point thereof at normal pressures. Hence, even when the amount of the compressive fluid relative to the ring-opening-polymerizable monomer is small, the ring-opening-polymerizable monomer melts in the contact region 9.

In order for the raw materials to mix efficiently, it is possible to adjust the timing to apply heat or stirring to the raw materials and the compressive fluid in the contact region 9. In this case, heat or stirring may be applied after the raw materials and the compressive fluid are brought into contact with each other, or heat or stirring may be applied while the raw materials and the compressive fluid are brought into contact with each other. In order for them to mix more infallibly, it may be after heat equal to or higher than the melting point of the ring-opening-polymerizable monomer is applied to the ring-opening-polymerizable monomer that the ring-opening-polymerizable monomer and the compressive fluid are brought into contact with each other. When the contact region 9 is, for example, a biaxial mixer, each of these schemes is realized by appropriately setting the arrangement of the screws, the positions of the inlets (9a, 9b, 9c, 9d), and the temperature of the heater 9e.

In the present embodiment, the additive is supplied to the contact region 9 separately from the ring-opening-polymerizable monomer. However, the additive may be supplied together with the ring-opening-polymerizable monomer. The additive may be supplied after the polymerization reaction. In this case, it is possible to take out the obtained polymer product from the reacting region 13, and then add the additive by kneading.

The raw materials mixed in the contact region 9 are conveyed by the liquid conveying pump 10 to be supplied into the reacting region 13 through the inlet 13a. Meanwhile, the catalyst in the tank 11 is weighed by the gauge pump 12 and supplied into the reacting region 13 in a predetermined amount through the inlet 13b. As the catalyst can work at room temperature, in the present embodiment, the catalyst is added after the raw materials are mixed with the compressive fluid. Conventionally, in a method for ring-opening polymerizing a ring-opening-polymerizable monomer using a compressive fluid, no consideration has been given to the timing to add the catalyst. In the present embodiment, because of its high activity, the catalyst is added to the ring-opening polymerization in the polymerization system in the reacting region 13 after the ring-opening-polymerizable monomer, the initiator, etc. have been sufficiently dissolved or melted by the compressive fluid in the system. If the catalyst is added before the ring-opening-polymerizable monomer, the initiator, etc. have been dissolved or melted sufficiently, the reaction might progress non-uniformly.

The raw materials conveyed by the liquid conveying pump 10 and the catalyst supplied by the gauge pump 12 are stirred sufficiently, if necessary by the stirrer in the reacting region 13, or heated to a predetermined temperature by the heater 13c while being conveyed. As a result, the ring-opening-polymerizable monomer is ring-opening polymerized in the reacting region 13 in the presence of the catalyst (polymerizing step).

A conventional polymer product producing method using supercritical carbon dioxide has polymerized a ring-opening-polymerizable monomer by using a large amount of supercritical carbon dioxide, because the lytic potential of supercritical carbon dioxide to the polymer product is low. The polymerization method of the present embodiment can ring-opening polymerize a ring-opening-polymerizable monomer at a high concentration that has not been achieved by conventional polymer product producing methods using a compressive fluid. In this case, the reacting region 13 internally becomes a high-pressure state in the presence of the compressive fluid, to thereby lower the glass transition temperature (Tg) of the produced polymer product. This will lower the viscosity of the produced polymer product to allow the ring-opening polymerization reaction to progress uniformly even in the state where the concentration of the polymer product has become high.

In the present embodiment, the polymerization reaction time (average retention time in the reacting region 13) is set according to the target molecular weight. However, generally, it is preferably 1 hour or shorter, more preferably 45 minutes or shorter, and still more preferably 30 minutes or shorter. According to the producing method of the present embodiment, the polymerization reaction time may be set to 20 minutes or shorter. This is an unprecedented short time for polymerization of a ring-opening-polymerizable monomer in a compressive fluid.

The amount of moisture in the reacting region 13 is preferably 4 mol or less, more preferably 1 mol or less, and particularly preferably 0.5 mol or less relative to 100 mol of the ring-opening-polymerizable monomer. When the amount of moisture is greater than 4 mol, moisture itself starts to contribute as the initiator, which may make it difficult to control the molecular weight. In order to control the amount of moisture in the polymerization system, it is possible to add an operation of removing moisture contained in the ring-opening-polymerizable monomer and the other raw materials as a pre-treatment, if necessary.

The polymer product P having terminated the ring-opening polymerization reaction in the reacting region 13 is discharged to the outside of the reacting region 13 by the gauge pump 14. The rate at which the gauge pump 14 discharges the polymer product P is preferably constant, in order to run the polymerization system filled with the compressive fluid at a constant internal pressure to obtain a uniform polymer product. Hence, the liquid conveying amounts of the liquid conveying mechanism in the reacting region 13 and of the liquid conveying pump 10 are controlled so that the back pressure of the gauge pump 14 may be constant. Likewise, the feeding rates of the liquid conveying mechanism in the contact region 9, of the gauge feeders (2, 4), and of the gauge pumps (6, 8) are controlled so that the back pressure of the liquid conveying pump 10 may be constant. The controlling scheme may be an ON-OFF type, i.e., an intermittent feeding type, but a preferable scheme is often a continuous or stepwise type for gradually increasing or reducing the rotation speed of a pump or the like. In any case, such a control makes it possible to obtain a uniform polymer product stably.

The catalyst remained in the polymer product obtained in the present embodiment is removed according to necessity. The removing method is not particularly limited, but examples thereof include distillation at a reduced pressure when the target is a compound having a boiling point, a method of extracting and removing the catalyst by using as an entrainer a substance that can dissolve the catalyst, and a method of adsorbing and removing the catalyst with a column. In this case, the scheme for removing the catalyst may be a batch type for removing it after the polymer product is taken out from the reacting region 13, or may be a serial type for removing it without taking it out. When distilling the catalyst at a reduced pressure, the pressure reducing condition is set based on the boiling point of the catalyst. For example, the temperature when the pressure is reduced is from 100° C. to 120° C., which means that it is possible to remove the catalyst at a temperature that is lower than the temperature at which the polymer product is depolymerized. When an organic solvent is used for this extraction operation, it may be necessary to perform a step of removing the organic solvent after the catalyst is extracted. Therefore, also in this extraction operation, it is preferable to use the compressive fluid as the solvent. For such an extraction operation, it is possible to use publicly known techniques for extraction of aroma chemicals.

### Second Embodiment

### Applied Example

Next, a second embodiment, as an applied example of the first embodiment will be explained. In the producing method of the first embodiment, there is almost no residual ring-opening-polymerizable monomer and the reaction progresses quantitatively. Based on this, the first method of the second embodiment will synthesize a polymer product by using the polymer product produced by the producing method of the first embodiment, and by appropriately setting the timings to add 1 or more kinds of ring-opening-polymerizable monomers. The second method of the second embodiment will form a complex body by using 2 or more kinds of polymers including the polymer product produced by the producing method of the first embodiment and by serially mixing the 2 or more kinds of polymer products in the presence of the compressive fluid. In the present embodiment, a “complex body” means a copolymer that includes 2 or more kinds of polymer segments obtained by polymerizing a monomer through a plurality of separate system lines, or a mixture of 2 or more kinds of polymer products obtained by polymerizing a monomer through a plurality of separate system lines.

Two patterns for synthesizing a stereo complex, as an example of a complex body, will be explained below.

### <First Method and Apparatus>

The first method of the second embodiment includes the polymerizing step described above (first polymerizing step), and a second polymerizing step of bringing a first polymer product obtained by ring-opening polymerizing a first ring-opening-polymerizing monomer in the first polymerizing step and a second ring-opening-polymerizable monomer into contact with each other serially to thereby polymerize the first polymer product with the second ring-opening-polymerizable monomer, and further includes other steps according to necessity.

A complex body producing apparatus, which is a first apparatus of the second embodiment, includes the polymer product producing apparatus described above and a second reacting region through which the compressive fluid is circulated. The second reacting region includes at an upstream side thereof, a second monomer inlet through which the second ring-opening-polymerizable monomer is introduced and a polymer product inlet through which the first polymer product discharged through the extruding cap 15 of the polymer product producing apparatus is introduced, at a downstream side of the second monomer inlet, a second catalyst inlet through which a second catalyst is introduced, and at a downstream side of the second catalyst inlet, an outlet through which a complex body obtained by polymerizing the first polymer product with the second ring-opening-polymerizable monomer is discharged, and further includes other members according to necessity.

The producing method may be preferably performed by the complex body producing apparatus.

The polymer product complex body producing apparatus is preferably a polymer product complex body serial producing apparatus having a tubular shape, in which: the second reacting region is a tubular reacting region that includes at one end portion thereof (the upstream side), the second monomer inlet through which the second ring-opening-polymerizable monomer is introduced and the inlet through which the first polymer product discharged through the extruding cap 15 of the polymer product producing apparatus described above is introduced, at the other end portion thereof, an outlet through which a complex body obtained by polymerizing the first polymer product with the second ring-opening-polymerizable monomer is discharged, and at a portion between the one end portion and the other end portion, the second catalyst inlet through which the second catalyst is introduced; the polymer product producing apparatus described above is a polymer product serial producing apparatus having a tubular shape; and the inlet (the inlet through which the first polymer product is introduced) is connected with the extruding cap 15 of the polymer product producing apparatus described above.

The first ring-opening-polymerizable monomer and the second ring-opening-polymerizable monomer are not particularly limited and may be selected according to the purpose from those listed as the ring-opening-polymerizable monomer. They may be different kinds of ring-opening-polymerizable monomers from each other, or may be the same kind. For example, it is also possible to obtain a stereo complex body by using monomers that are each other's enantiomers.

The first catalyst and the second catalyst are not particularly limited, may be selected according to the purpose from those listed as the catalyst, and may be the same as or different from each other.

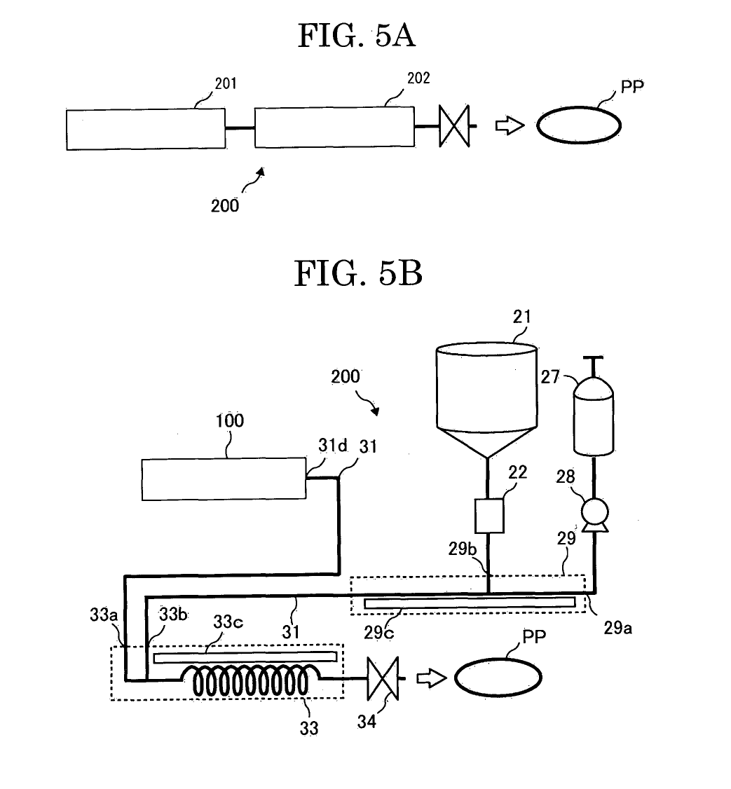

First, the first method will be explained with reference to FIG. 5A and FIG. 5B. FIG. 5A and FIG. 5B are exemplary diagrams showing a complex body producing system used in the first method. The first method includes a mixing step of mixing the polymer product obtained by the producing method of the first embodiment serially in the presence of a compressive fluid. Specifically, a polymer product is produced by the producing method of the first embodiment in a system line 1 (indicated by a reference sign 201 in FIG. 5A) of a producing system 200 of FIG. 5A, and the obtained polymer product P is brought into contact with the second ring-opening-polymerizable monomer newly introduced in a system line 2 (indicated by a reference sign 202 in FIG. 5A) in order to mix them serially in the presence of the compressive fluid, to thereby produce a complex product PP (a final polymer product). It is also possible to obtain a complex product PP including 3 or more kinds of segments by repeating the same system line as the system line 2 of the producing system 200 of FIG. 5A in series.

Next, a specific example of the producing system 200 will be explained with reference to FIG. 5B. The producing system 200 includes the same polymerization reaction apparatus 100 as that used in the first embodiment, tanks (21, 27), a gauge feeder 22, a gauge pump 28, a contact region 29, a reacting region 33, and a pressure adjusting valve 34. In the producing system 200, the reacting region 33 is constituted by a tube or a tubular apparatus that includes at one end portion thereof, an inlet 33a through which a plurality of polymer products are introduced, and at the other end portion thereof, a complex body outlet through which a polymer product complex obtained by mixing the plurality of polymer products is discharged. The inlet 33a of the reacting region 33 is connected to the outlet of the polymerization reaction apparatus 100 through a pressure-tight tube 31. Here, an outlet 31d of the polymerization reaction apparatus 100 means the leading end of the tube 30 or cylinder in the reacting region 13, or the outlet of the gauge pump 14 (FIG. 3) or of the pressure adjusting valve 16 (FIG. 4). In any case, the polymer product P produced by the polymerization reaction apparatus 100 can be supplied to the reacting region 33 without being returned to normal pressures.

The tank 21 stores the second ring-opening-polymerizable monomer. In the first method, the second ring-opening-polymerizable monomer is an enantiomer of the ring-opening-polymerizable monomer stored in the tank 1. The tank 27 stores a compressive fluid. The compressive fluid stored in the tank 27 is not particularly limited, but is preferably the same kind as the compressive fluid stored in the tank 7 in order for the polymerization reaction to progress uniformly. The tank 27 may store a gaseous body (gas) or a solid that turns to a compressive fluid through the process of being supplied to the contact region 29 or that turns to a compressive fluid by being heated or pressurized in the contact region 29. In this case, the gaseous body or the solid stored in the tank 27 becomes the state of (1), (2), or (3) in the phase diagram of FIG. 2 in the contact region 29 by being heated or pressurized.

The gauge feeder 22 weighs the second ring-opening-polymerizable monomer stored in the tank 21 and supplies it to the contact region 29 serially. The gauge pump 28 supplies the compressive fluid stored in the tank 27 to the contact region 29 serially at a constant pressure at a constant flow rate.

The contact region 29 is constituted by a pressure-tight apparatus or tube in which to bring the second ring-opening-polymerizable monomer supplied from the tank 21 and the compressive fluid supplied from the tank 27 into contact with each other serially to dissolve or melt the raw materials. The container of the contact region 29 is provided with an inlet 29a through which the compressive fluid supplied from the tank 27 by the gauge pump 28 is introduced, and an inlet 29b through which the second ring-opening-polymerizable monomer supplied from the tank 21 by the gauge feeder 22 is introduced. The contact region 29 is provided with a heater 29c configured to heat the second ring-opening-polymerizable monomer and the compressive fluid supplied thereto. In the present embodiment, the same as the contact region 9 is used as the contact region 29.

The reacting region 33 is constituted by a pressure-tight apparatus or tube in which to polymerize the polymer product P obtained in the polymerization reaction apparatus 100 as an intermediate body having a state of being dissolved or melted in the compressive fluid, with the second ring-opening-polymerizable monomer dissolved or melted in the compressive fluid in the contact region 29. The reacting region 33 is provided with an inlet 33a through which the polymer product P as the dissolved or melted intermediate body is introduced into the tube, and an inlet 33b through which the dissolved or melted second ring-opening-polymerizable monomer is introduced into the tube. The reacting region 33 is also provided with a heater 33c configured to heat the polymer product P and the second ring-opening-polymerizable monomer conveyed. In the present embodiment, the same as the reacting region 13 is used as the reacting region 33. The pressure adjusting valve 34 as an example of the outlet discharges the complex product PP polymerized in the reacting region 33 to the outside of the reacting region 33 by utilizing the pressure difference between the inside and the outside of the reacting region 33.

In the first method, a ring-opening-polymerizable monomer (e.g., L-lactide) is polymerized in the reacting region 13, and after the reaction is completed quantitatively, an enantiomer ring-opening-polymerizable monomer (e.g., D-lactide) as an example of the second ring-opening-polymerizable monomer is added to the reacting region 33 to further progress the polymerization reaction. As a result, a stereo block copolymer is obtained. This method is very useful because racemization is very unlikely to occur and the product can be obtained through a one-stage reaction, since this method can progress the reaction at a temperature equal to or lower than the melting point of the ring-opening-polymerizable monomers with scarce residual monomers remaining.

### <Second Method and Apparatus>

A polymer product producing method, which is the second method of the second embodiment, includes the polymerizing step described above, and a mixing step of serially mixing 2 or more kinds of polymer products including the polymer product obtained in the polymerizing step in the presence of a compressive fluid, and further includes other steps according to necessity.

It is preferable that the 2 or more kinds of polymer products include a first polymer product obtained by ring-opening polymerizing a first ring-opening-polymerizable monomer, and a second polymer product obtained by ring-opening polymerizing a second ring-opening-polymerizable monomer, and that the first ring-opening-polymerizable monomer and the second ring-opening-polymerizable monomer be each other's enantiomers.

A complex body producing apparatus, which is a second apparatus of the second embodiment, includes 2 or more of the polymer product producing apparatus described above, further includes a mixing vessel in which to mix the 2 or more kinds of polymer products discharged from one outlet and any other outlet(s) of the 2 or more polymer product producing apparatuses, and further includes other members according to necessity.

Of the 2 or more polymer product producing apparatuses, one polymer product producing apparatus produces a polymer product, and any other polymer product producing apparatus produces a polymer product (a polymer product obtained by ring-opening polymerizing the ring-opening-polymerizable monomer in the presence of the compressive fluid).

The polymer product producing method may be preferably performed by the complex body producing apparatus.

The complex body producing apparatus is preferably a complex body serial producing apparatus having a tubular shape, in which: the 2 or more polymer product producing apparatuses are each a polymer product serial producing apparatus having a tubular shape; the mixing vessel is a tubular mixing vessel including at one end portion thereof (the upstream side), 2 or more inlets through which the 2 or more kinds of polymer products are introduced, and at the other end portion thereof, a complex body outlet through which a complex body obtained by mixing the 2 or more kinds of polymer products is discharged; and the 2 or more inlets are connected to 2 or more outlets of the 2 or more polymer product producing apparatuses, respectively.

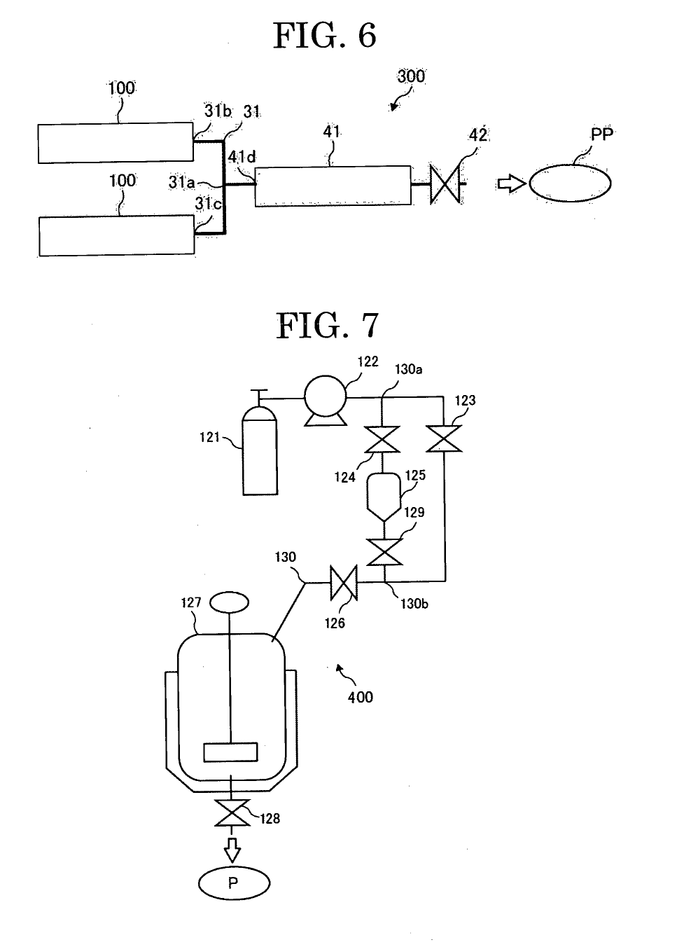

Next, the second method will be explained with reference to FIG. 6. FIG. 6 is an exemplary diagram showing a complex body producing system used in the second method. The second method includes a second polymerizing step of bringing the polymer product obtained by the producing method of the first embodiment into contact with a monomer serially to thereby polymerize the polymer product with the monomer. The second method will form a complex product PP by serially mixing a plurality of polymer products each produced by the producing method of the first embodiment in the presence of a compressive fluid. The plurality of polymer products are, for example, polymerization products obtained by separately polymerizing ring-opening-polymerizable monomers that are each other's enantiomers. A producing system 300 includes a plurality of polymerization reaction apparatuses 100, a mixing apparatus 41, and a pressure adjusting valve 42.

In the complex body producing system 300, a polymer product inlet 41d of the mixing apparatus 41 is connected to the outlets (31b, 31c) of the respective polymerization reaction apparatuses 100 through a pressure-tight tube 31. Here, the outlet of the polymerization reaction apparatus 100 means the leading end of the tube 30 or cylinder in the reacting region 13, or the outlet of the gauge pump 14 (FIG. 3) or of the pressure adjusting valve 16 (FIG. 4). In any case, the polymer product P produced by each polymerization reaction apparatus 100 can be supplied into the reacting region 33 without being returned to normal pressures. As a result, the viscosity of each polymer product P will lower in the presence of the compressive fluid, which makes it possible for the 2 or more kinds of polymer products P to be mixed in the mixing apparatus 41 at a lower temperature. FIG. 6 shows an example in which there are provided two polymerization reaction apparatuses 100 in parallel with the tube 31 including one joint 31a. However, three or more polymerization reaction apparatuses 100 may be provided in parallel with a plurality of joints.

The mixing apparatus 41 is not particularly limited as long as it can mix the plurality of polymer products supplied from the respective polymerization reaction apparatuses 100. Examples thereof include a mixing apparatus including a stirrer. Preferable examples of the stirrer include a uniaxial screw, biaxial screws meshing with each other, a biaxial mixer including multiple stirring elements meshing or overlapping with each other, a kneader including helical stirring elements meshing with each other, and a static mixer. The temperature (mixing temperature) when the mixing apparatus 41 mixes the polymer products may be set the same as the polymerization reaction temperature in the reacting region 13 of each polymerization reaction apparatus 100. The mixing apparatus 41 may include a separate mechanism configured to supply a compressive fluid to the polymer products being mixed. The pressure adjusting valve 42, as an example of a complex body outlet, is a device configured to adjust the flow rate of the complex product PP resulting from mixing the polymer products in the mixing apparatus 41.

In the second method, an L-form monomer and a D-form monomer (e.g., lactides) are polymerized separately in the respective polymerization reaction apparatuses 100 in advance in the compressive fluid. Then, the polymer products obtained by the polymerization are blended in a compressive fluid to thereby obtain a stereo block copolymer (mixing step). Normally, a polymer product such as a polylactic acid may often decompose when heated again to equal to or higher than the melting point, even if it contains very scarce residual monomer. The second method is very useful because it can suppress racemization and thermal degradation like the first method, by blending polylactic acids having a low viscosity and melted in the compressive fluid at equal to or lower than the melting point.

In the first method and the second method, a case has been explained in which a stereo complex is produced by separately polymerizing ring-opening-polymerizable monomers that are each other's enantiomers. However, the ring-opening-polymerizable monomers used in the present embodiment need not be each other's enantiomers. Further, it is also possible to mix block copolymers each forming a stereo complex, by combining the first method and the second method.

### Third Embodiment

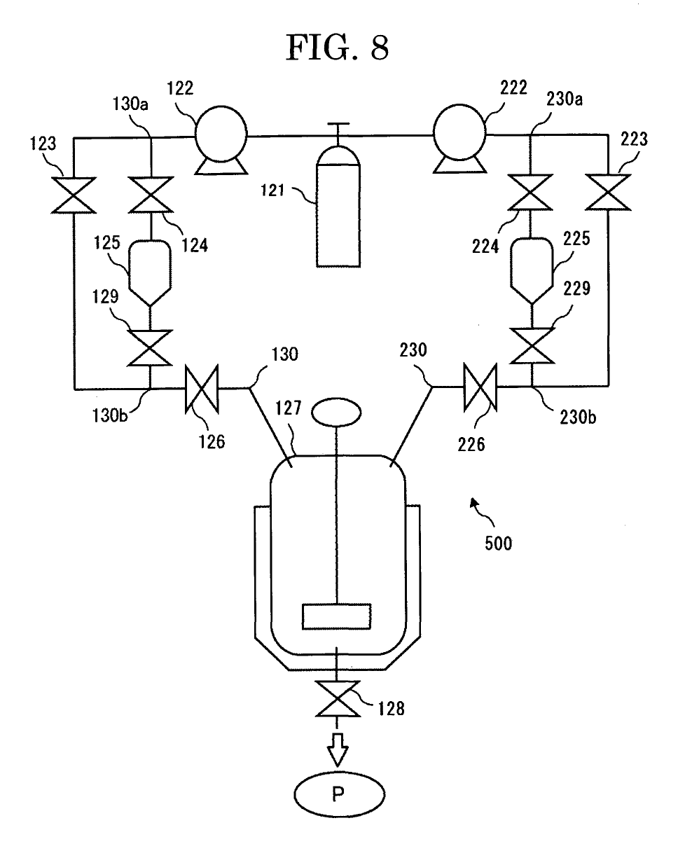

Next, a polymerization reaction apparatus 400 used in a batch-type process will be explained. In the system line diagram shown in FIG. 7, the polymerization reaction apparatus 400 includes a tank 121, a gauge pump 122, an adding pot 125, a reaction vessel 127, and valves (123, 124, 126, 128, 129). These devices are connected as shown in FIG. 7 through a pressure-tight tube 130. The tube 130 is provided with joints (130a, 130b).

The tank 121 stores a compressive fluid. The tank 121 may store a gaseous body (gas) or a solid that turns to a compressive fluid through the route through which it is supplied to the reaction vessel 127 or that turns to a compressive fluid by being heated or pressurized in the reaction vessel 127. In this case, the gaseous body or the solid stored in the tank 121 becomes the state of (1), (2), or (3) of the phase diagram of FIG. 2 in the reaction vessel 127 by being heated or pressurized.

The gauge pump 122 supplies the compressive fluid stored in the tank 121 to the reaction vessel 127 at a constant pressure at a constant flow rate. The adding pot 125 stores a catalyst to be added to the raw materials in the reaction vessel 127. The valves (123, 124, 126, 129) switch between a route of supplying the compressive fluid stored in the tank 121 to the reaction vessel 127 via the adding pot 125 and a route of supplying it to the reaction vessel 127 by bypassing the adding pot 125, by being opened or closed.

The reaction vessel 127 previously stores a ring-opening-polymerizable monomer and an initiator in advance of initiating polymerization. The reaction vessel 127 is a pressure-tight vessel in which to bring the ring-opening-polymerizable monomer and the initiator previously stored therein into contact with the compressive fluid supplied from the tank 121 and the catalyst supplied from the adding pot 125 to thereby ring-opening polymerize the ring-opening-polymerizable monomer. The reaction vessel 127 may be provided with a gas outlet through which an evaporant is removed. The reaction vessel 127 includes a heater configured to heat the raw materials and the compressive fluid. Further, the reaction vessel 127 includes a stirrer configured to stir the raw materials and the compressive fluid. When there occurs a density difference between the raw materials and the produced polymer product, it is possible to suppress sedimentation of the produced polymer product by applying stirring with the stirrer, which makes it possible to progress the polymerization reaction more uniformly and quantitatively. The valve 128 discharges the polymer product P in the reaction vessel 127 by being opened after the polymerization reaction is completed.

### EXAMPLES

The present invention will be explained more specifically below, with Examples and Comparative Examples. The present invention is not limited to these Examples by any means.

### Example 1-1-1

The batch-type polymerization reaction apparatus 400 shown in FIG. 7 was used to ring-opening polymerize a mixture of L-lactide and D-lactide (with a mass ratio of 90/10). The configuration of the polymerization reaction apparatus 400 is described below.
Tank 121: carbonic acid gas cylinder
Adding pot 125: a ¼ inch SUS316 tube was interposed between the valves (124, 129) and used as the adding pot. The pot was previously filled with tin octylate as a catalyst in an amount of 1 mol % relative to the ring-opening-polymerizable monomer.
Reaction vessel 127: a 100 mL SUS316 pressure-tight vessel was previously filled with 108 g of a mixture of a liquid-state lactide (a mixture of L-lactide and D-lactide (with a ratio of 90/10 on a mass basis) (manufactured by Pulac Inc., with a melting point of 100° C.) as the ring-opening-polymerizable monomer and lauryl alcohol as the initiator at a mixing ratio of 99/1 on a molar basis.

The reaction vessel was also filled with toluene as an organic solvent (entrainer) in an amount of 1 mol % relative to the ring-opening-polymerizable monomer.

The gauge pump 122 was actuated to open the valves (123, 126), to thereby supply the carbon dioxide stored in the tank 121 to the reaction vessel 127 by bypassing the adding pot 125. After the space inside the reaction vessel 127 was purged by the carbon dioxide, the temperature was set to 180° C., and the pressure inside the reaction vessel 127 was set to 35 MPa, the valves (124, 129) were opened to supply tin octylate in the adding pot 125 to the reaction vessel 127. After this, the lactide was polymerized in the reaction vessel 127 for 120 minutes. After the reaction was terminated, the valve 128 was opened to return the temperature and the pressure in the reaction vessel 127 gradually to normal temperature and normal pressures. The polymer product (polylactic acid) in the reaction vessel 127 was extruded in a strand form through an extruding cap (unillustrated), and passed through water of 10° C. After this, the strand was cut with a cutter and dried to thereby obtain a pellet.

### <Mixing Ratio [Raw Materials/(Compressive Fluid+Raw Materials)]>

The mixing ratio [raw materials/(compressive fluid+raw materials), abbreviated as R/(C+R)] was calculated according to the following formulae.

Spatial volume of supercritical carbon dioxide: 100 mL−108 g/1.27 (specific gravity of the raw materials)=15 ml

Mass of supercritical carbon dioxide: 15 ml×0.605 (specific gravity of carbon dioxide at 60° C. and 15 MPa)=9.1

Mixing ratio: 108 g/(108 g+9.1 g)=0.92

### <Polymerization Density>

The polymerization density was calculated based on a reference ‘R. Span and W. Wagner “A New Equation of State for Carbon Dioxide covering the Fluid Region from the Triple Point Temperature to 1100 K at Pressures up to 800 MPa” J. Phys. Chem. Ref. Data 25, pp. 1509-1596 (1996)’.

The obtained pellet of Example 1-1-1 was evaluated in terms of residual ring-opening-polymerizable monomer content, weight average molecular weight, molecular weight distribution, impact strength, and YI value as follows. The results are shown in Table 1-1.

### <Residual Ring-Opening-Polymerizable Monomer Content>

The content of the residual ring-opening-polymerizable monomer in the obtained polymer product was obtained according to the method of measuring an amount of lactide described in “Voluntary standards for container packaging of food with synthetic resins such as polyolefin, 3rd revision, supplemented in June, 2004, chapter 3, hygienic test methods, P13”. Specifically, the polymer product such as polylactic acid was uniformly dissolved in dichloromethane, and an acetone/cyclohexane mixture solution was added thereto to re-precipitate the polymer product. The resulting supernatant was subjected to a gas chromatograph (GC) with a hydrogen flame ionization detector (FID) to separate the residual ring-opening-polymerizable monomer (lactide). The content of the residual ring-opening-polymerizable monomer in the polymer product was measured by quantitation based on internal reference method. The GC measurement was performed on the following conditions. In Tables, “ppm” indicates mass fraction.

### <<GC Measurement Conditions>>

Column: a capillary column (manufactured by J&W Inc., DB-17MS, with a length of 30 m×inner diameter of 0.25 mm, and a film thickness of 0.25 μm)

Internal reference: 2,6-dimethyl-γpyrone
Column flow rate: 1.8 mL/min
Column temperature: retained at 50° C. for 1 minute, warmed at a constant rate of 25° C./minute, and retained at 320° C. for 5 minutes.
Detector: a hydrogen flame ionization detection method (FID)

### <Molecular Weight of Polymer Product>

The molecular weight was measured by gel permeation chromatography (GPC) under the following conditions.

Instrument: GPC-8020 (manufactured by Tosoh Corporation)
Columns: TSK G2000HXL and G4000HXL (manufactured by Tosoh Corporation)

### Temperature: 40° C.

Solvent: chloroform
Flow rate: 1.0 mL/minute

A sample having a concentration of 0.5% by mass (1 mL) was injected and measured under the above conditions to obtain a distribution of molecular weights of the polymer product. Based on this, the number average molecular weight (Mn) and the weight average molecular weight (Mw) of the polymer product were calculated, using a molecular weight calibration curve generated based on a monodisperse polystyrene standard sample. A molecular weight distribution was a value obtained by dividing Mw by Mn.

<Yellow Index (YI value)>

A resin pellet having a thickness of 2 mm was manufactured from the obtained polymer product, and measured with an SM color computer (manufactured by Suga Test Instruments Co., Ltd.) according to JIS-K7103 to obtain the YI value.

### <Optical Purity>

The optical purity of the polymer product was calculated according to the following formula.

Optical purity (% ee)=100×|amount of L form−amount of D form|/(amount of L form+amount of D form)

The amount of L form of optically active polymer [% by mass] and the amount of D form of optically active polymer [% by mass] were the values obtained according to the following method using high-performance liquid chromatography (HPLC).

### —Measurement of Amount of L Form and Amount of D Form of Resin (Optically Active Polymer)—

A sample was subjected to frost shattering, and the obtained powder was refluxed in a 1N sodium hydroxide aqueous solution for 3 hours. The resulting solution was neutralized, and after this, filtered and subjected to HPLC.

### —HPLC Measurement Condition—

Measuring instrument

HPLC LC-2000 type system manufactured by JASCO Corporation

### Column

SUMICHIRAL OA5000 manufactured by Sumika Chemical Analysis Service, Ltd.

Column temperature

25° C.

Mobile phase

2 mM-CuSO₄ aqueous solution/2-propanol=95/5

Flow rate of mobile phase

1.0 mL/minute

### Detector

Ultraviolet detector (UV 254 nm)

### <Evaluation of Impact Strength>

Evaluation of impact strength was performed in the following method.

A sheet having a thickness of 0.4 mm was manufactured (the dissolution temperature when manufacturing the sheet was the heating temperature when calculating Tm1). A 200 g weight was dropped down to the sheet to measure the maximum height from which the test piece would not be broken, and the impact strength was evaluated based on the following criteria.

### [Evaluation Criteria]

A: 300 mm or higher

B: 150 mm or higher but lower than 300 mm

C: 50 mm or higher but lower than 150 mm

### Examples 1-1-2 to 1-1-60

The polymer products of Examples 1-1-2 to 1-1-60 were produced in the same manner as example 1-1-1, except that at least any of the kind of the monomer, polymerization pressure, polymerization reaction temperature, density, reaction time, and mixing ratio [raw materials/(compressive fluid+raw materials)] used in Example 1-1-1 was changed as shown in Tables 1-1 to 1-14 below. As for how to add the catalyst, when adding the catalyst beforehand, the ring-opening-polymerizable monomer, the initiator, and the catalyst were put in the reaction vessel 127 from the start and reacted therein. When adding the catalyst afterwards, the ring-opening-polymerizable monomer and the initiator were put in the reaction vessel 127 and mixed therein, and after this, the catalyst was put therein and reacted. The pressure was controlled by changing the flow rate of the pump.

The characteristics of each of the polymer products thus obtained were evaluated in the same manner as Example 1-1-1. The results are shown in Tables 1-1 to 1-14.

<Batch Type, Lactide Homo, Metal Catalyst, with Organic Solvent - - - 1>

TABLE 1-1

| | Ex. 1-1-1 | Ex. 1-1-2 | Ex. 1-1-3 | Ex. 1-1-4 | Ex. 1-1-5 |
|---|---|---|---|---|---|
| Kind of monomer | Lactide | Lactide | Lactide | Lactide | Lactide |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 35 | 40 | 45 | 35 | 40 |
| Temperature (° C.) | 180 | 150 | 80 | 180 | 150 |
| Polymerization density | 484.29 | 607.11 | 851.47 | 484.29 | 607.11 |
| (kg/m³) | | | | | |
| Reaction time (min) | 15 | 15 | 15 | 30 | 30 |
| R/(C + R) | 0.94 | 0.92 | 0.89 | 0.41 | 0.36 |
| Weight average molecular | 15,000 | 130,000 | 270,000 | 16,000 | 160,000 |
| weight Mw | | | | | |
| Molecular weight | 1.4 | 1.6 | 1.6 | 1.3 | 1.6 |
| distribution Mw/Mn | | | | | |
| Residual monomer | 18,000 | 8,200 | 2,100 | 19,000 | 7,400 |
| (ppm by mass) | | | | | |
| YI value | 3 | 4 | 3 | 6 | 5 |
| Impact strength | C | C | C | C | C |
| Optical purity | 90.3 | 91.9 | 92.6 | 92.3 | 93.2 |

<Batch Type, Lactide Homo, Metal Catalyst, with Organic Solvent - - - 2>

TABLE 1-2

| | Ex. 1-1-6 | Ex. 1-1-7 | Ex. 1-1-8 | E. 1-1-9 | Ex. 1-1-10 |
|---|---|---|---|---|---|
| Kind of monomer | Lactide | Lactide | Lactide | Lactide | Lactide |
| Catalyst | Tin octylate | Tine octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 45 | 35 | 40 | 45 | 35 |
| Temperature (° C.) | 80 | 180 | 150 | 80 | 180 |
| Polymerization density | 851.47 | 484.29 | 607.11 | 851.47 | 484.29 |
| (kg/m³) | | | | | |
| Reaction time (min) | 30 | 30 | 30 | 30 | 45 |
| R/(C + R) | 0.28 | 0.94 | 0.92 | 0.89 | 0.94 |
| Weight average molecular | 290,000 | 17,000 | 190,000 | 280,000 | 18,000 |
| weight Mw | | | | | |
| Molecular weight | 1.5 | 1.5 | 1.6 | 1.7 | 1.2 |
| distribution Mw/Mn | | | | | |
| Residual monomer | 1,800 | 8,300 | 3,600 | 800 | 7,600 |
| (ppm by mass) | | | | | |
| YI value | 3 | 7 | 4 | 3 | 8 |
| Impact strength | C | C | C | C | C |
| Optical purity (%) | 92.2 | 91.7 | 93.1 | 94.2 | 90.4 |

<Batch Type, Lactide Homo, Metal Catalyst, with Organic Solvent - - - 3>

TABLE 1-3

| | Ex. 1-1-11 | Ex. 1-1-12 | Ex. 1-1-13 | Ex. 1-1-14 | Ex. 1-1-15 |
|---|---|---|---|---|---|
| Kind of monomer | Lactide | Lactide | Lactide | Lactide | Lactide |
| Catalyst | Tin octylate | Tine octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.2 | 0.2 | 0.2 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 40 | 45 | 50 | 60 | 65 |
| Temperature (° C.) | 150 | 80 | 180 | 150 | 80 |
| Polymerization density | 607.11 | 851.47 | 619.61 | 746.2 | 932.87 |
| (kg/m³) | | | | | |
| Reaction time (mm) | 45 | 45 | 30 | 30 | 30 |
| R/(C + R) | 0.92 | 0.89 | 0.94 | 0.92 | 0.89 |
| Weight average molecular | 210,000 | 285,000 | 330,000 | 390,000 | 540,000 |
| weight Mw | | | | | |
| Molecular weight | 1.7 | 1.7 | 1.4 | 1.6 | 15 |
| distribution Mw/Mn | | | | | |
| Residual monomer | 2,200 | 600 | 18,800 | 7,400 | 1,800 |
| (ppm by mass) | | | | | |
| YI value | 4 | 2 | 9 | 9 | 8 |
| Impact strength | C | C | B | A | A |
| Optical purity (%) | 91.6 | 93.7 | 94.2 | 96.2 | 99.6 |

<Batch Type, Lactide Homo, Metal Catalyst, with Organic Solvent - - - 4>

TABLE 1-4

| | Ex. 1-1-16 | Ex. 1-1-17 | Ex. 1-1-18 | Ex. 1-1-19 | Ex. 1-1-20 |
|---|---|---|---|---|---|
| Kind of monomer | Lactide | Lactide | Lactide | Lactide | Lactide |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.2 | 0.2 | 0.2 | 0.2 | 0.2 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 50 | 60 | 65 | 50 | 60 |
| Temperature (° C.) | 180 | 150 | 80 | 180 | 150 |
| Polymerization density | 619.61 | 746.2 | 932.87 | 619.61 | 746.2 |
| (kg/m³) | | | | | |
| Reaction time (min) | 60 | 60 | 60 | 60 | 60 |
| R/(C + R) | 0.36 | 0.31 | 0.26 | 0.94 | 0.92 |
| Weight average molecular | 350,000 | 420,000 | 570,000 | 380,000 | 470,000 |
| weight Mw | | | | | |
| Molecular weight | 1.2 | 1.7 | 1.5 | 1.4 | 1.8 |
| distribution Mw/Mn | | | | | |
| Residual monomer | 17,000 | 6,300 | 1,100 | 9,500 | 5,400 |
| (ppm by mass) | | | | | |
| YI value | 13 | 10 | 8 | 9 | 11 |
| Impact strength | A | A | A | A | A |
| Optical purity (%) | 93.9 | 98.7 | 99.1 | 95.1 | 96.9 |

<Batch Type, Lactide Homo, Metal Catalyst, with Organic Solvent - - - 5>

TABLE 1-5

| | Ex. 1-1-21 | Ex. 1-1-22 | Ex. 1-1-23 | Ex. 1-1-24 |
|---|---|---|---|---|
| Kind of monomer | Lactide | Lactide | Lactide | Lactide |
| Catalyst | Tin octylate | Tin octylate | Tin octylate | Tin octylate |
| Kind of initiator | Lauryl | Lauryl | Lauryl | Lauryl |
| | alcohol | alcohol | alcohol | alcohol |
| Amount of initiator | 0.2 | 0.2 | 0.2 | 0.2 |
| (mol %) | | | | |
| Organic solvent | Toluene | Toluene | Toluene | Toluene |
| | (1 mol %) | (1 mol %) | (1 mol %) | (1 mol %) |
| Pressure (MPa) | 65 | 50 | 60 | 65 |
| Temperature (° C.) | 80 | 180 | 150 | 80 |
| Polymerization density | 932.87 | 619.61 | 746.2 | 932.87 |
| (kg/m³) | | | | |
| Reaction time (min) | 60 | 90 | 90 | 90 |
| R/(C + R) | 0.89 | 0.94 | 0.92 | 0.89 |
| Weight average molecular | 590,000 | 390,000 | 520,000 | 590,000 |
| weight Mw | | | | |
| Molecular weight | 1.5 | 1.3 | 1.6 | 1.7 |
| distribution Mw/Mn | | | | |
| Residual monomer | 1,100 | 8,700 | 3,200 | 500 |
| (ppm by mass) | | | | |
| YI value | 9 | 10 | 12 | 11 |
| Impact strength | A | A | A | A |
| Optical purity (%) | 99.4 | 94.6 | 97.8 | 99.5 |

<Batch Type, ε-Caprolactone Homo, Metal Catalyst, with Organic Solvent - - - 1>

TABLE 1-6

| | Ex. 1-1-25 | Ex. 1-1-26 | Ex. 1-1-27 | Ex. 1-1-28 | Ex. 1-1-29 |
|---|---|---|---|---|---|
| Kind of monomer | ε- | ε- | ε- | ε- | ε- |
| | caprolactone | caprolactone | caprolactone | caprolactone | caprolactone |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 35 | 65 | 65 | 35 | 65 |
| Temperature (° C.) | 120 | 50 | 50 | 120 | 50 |
| Polymerization density | 645.54 | 1007.59 | 1007.59 | 645.54 | 1007.59 |
| (kg/m³) | | | | | |
| Reaction time (min) | 15 | 15 | 30 | 30 | 30 |
| R/(C + R) | 0.96 | 0.95 | 0.25 | 0.96 | 0.95 |
| Weight average molecular | 22,000 | 180,000 | 260,000 | 200,000 | 280,000 |
| weight Mw | | | | | |
| Molecular weight | 1.4 | 1.6 | 1.5 | 1.5 | 1.6 |
| distribution Mw/Mn | | | | | |
| Residual monomer | 19,800 | 7,500 | 7,400 | 9,800 | 6,800 |
| (ppm by mass) | | | | | |
| YI value | 4 | 1 | 1 | 5 | 2 |
| Impact strength | C | C | C | C | C |
| Addition of catalyst | Before | After | After | Before | After |

<Batch Type, ε-Caprolactone Homo, Metal Catalyst, with Organic Solvent - - - 2>

TABLE 1-7

| | Ex. 1-1-30 | Ex. 1-1-31 | Ex. 1-1-32 | Ex. 1-1-33 | Ex. 1-1-34 |
|---|---|---|---|---|---|
| Kind of monomer | ε- | ε- | ε- | ε- | ε- |
| | caprolactone | caprolactone | caprolactone | caprolactone | caprolactone |
| Catalyst | Tin octylate | Tin octylate | Tin octylate | Tine octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.2 | 0.2 | 0.2 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 35 | 65 | 35 | 65 | 65 |
| Temperature (° C.) | 120 | 50 | 120 | 50 | 50 |
| Polymerization density | 645.54 | 1007.59 | 645.54 | 1007.59 | 1007.59 |
| (kg/m³) | | | | | |
| Reaction time (min) | 45 | 45 | 60 | 60 | 60 |
| R/(C + R) | 0.96 | 0.95 | 0.96 | 0.95 | 0.25 |
| Weight average molecular | 190,000 | 285,000 | 340,000 | 490,000 | 480,000 |
| weight Mw | | | | | |
| Molecular weight | 1.3 | 1.4 | 1.2 | 1.5 | 1.7 |
| distribution Mw/Mn | | | | | |
| Residual monomer | 8,600 | 2,000 | 6,500 | 7,700 | 8,200 |
| (ppm by mass) | | | | | |
| YI value | 4 | 2 | 11 | 10 | 11 |
| Impact strength | C | C | B | A | A |
| Addition of catalyst | Before | After | Before | After | Before |

<Batch Type, ε-Caprolactone Homo, Metal Catalyst, with Organic Solvent - - - 2>

TABLE 1-8

| | Ex. 1-1-35 | Ex. 1-1-36 |
|---|---|---|
| Kind of monomer | ε- | ε- |
| | caprolactone | caprolactone |
| Catalyst | Tin octylate | Tin octylate |
| Kind of initiator | Lauryl | Lauryl |
| | alcohol | alcohol |
| Amount of initiator | 0.2 | 0.2 |
| (mol %) | | |
| Organic solvent | Toluene | Toluene |
| | (1 mol %) | (1 mol %) |
| Pressure (MPa) | 35 | 65 |
| Temperature (° C.) | 120 | 50 |
| Polymerization density | 645.54 | 1007.59 |
| (Kg/m³) | | |
| Reaction time (mim) | 90 | 90 |
| R/(C + R) | 0.96 | 0.95 |
| Weight average molecular | 510,000 | 580,000 |
| weight Mw | | |
| Molecular weight | 1.4 | 1.6 |
| distribution Mw/Mn | | |
| Residual monomer | 5,500 | 1,200 |
| (ppm by mass) | | |
| YI value | 12 | 11 |
| Impact strength | A | A |
| Addition of catalyst | After | Before |

<Batch Type, Ethylene Carbonate Homo, Metal Catalyst, with Organic Solvent - - - 1>

TABLE 1-9

| | Ex. 1-1-37 | Ex. 1-1-38 | Ex. 1-1-39 | Ex. 1-1-40 | Ex. 1-1-41 |
|---|---|---|---|---|---|
| Kind of monomer | Ethylene | Ethylene | Ethylene | Ethylene | Ethylene |
| | carbonate | carbonate | carbonate | carbonate | carbonate |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 35 | 65 | 65 | 35 | 65 |
| Temperature (° C.) | 180 | 50 | 50 | 180 | 50 |
| Polymerization density | 484.29 | 1007.59 | 1007.59 | 484.29 | 1007.59 |
| (kg/m³) | | | | | |
| Reaction time (min) | 15 | 15 | 30 | 30 | 30 |
| R/(C + R) | 0.99 | 0.98 | 0.26 | 0.99 | 0.98 |
| Weight average molecular | 19,000 | 180,000 | 260,000 | 200,000 | 287,000 |
| weight Mw | | | | | |
| Molecular weight | 1.4 | 1.6 | 1.5 | 1.5 | 1.6 |
| distribution Mw/Mn | | | | | |
| Residual monomer | 18,000 | 7,500 | 7,300 | 16,000 | 8,100 |
| (ppm by mass) | | | | | |
| YI value | 6 | 1 | 1 | 5 | 1 |
| Impact strength | C | C | C | C | C |
| Addition of catalyst | Before | After | After | Before | After |

(Batch Type, Ethylene Carbonate Homo, Metal Catalyst, with Organic Solvent - - - 2>

TABLE 1-10

| | Ex. 1-1-42 | Ex. 1-1-43 | Ex. 1-1-44 | Ex. 1-1-45 | Ex. 1-1-46 |
|---|---|---|---|---|---|
| Kind of monomer | Ethylene | Ethylene | Ethylene | Ethylene | Ethylene |
| | carbonate | carbonate | carbonate | carbonate | carbonate |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.2 | 0.2 | 0.2 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 35 | 65 | 35 | 65 | 65 |
| Temperature (° C.) | 180 | 50 | 180 | 50 | 50 |
| Polymerization density | 484.29 | 1007.59 | 484.29 | 1007.59 | 1007.59 |
| (kg/m³) | | | | | |
| Reaction time (min) | 45 | 45 | 60 | 60 | 60 |
| R/(C + R) | 0.99 | 0.98 | 0.99 | 0.98 | 0.26 |
| Weight average molecular | 210,000 | 285,000 | 330,000 | 500,000 | 480,000 |
| weight Mw | | | | | |
| Molecular weight | 1.5 | 1.3 | 1.6 | 1.2 | 1.6 |
| distribution Mw/Mn | | | | | |
| Residual monomer | 7,400 | 7,000 | 5,500 | 7,800 | 8,300 |
| (ppm by mass) | | | | | |
| YI value | 7 | 2 | 9 | 8 | 9 |
| Impact strength | C | C | B | A | A |
| Addition of catalyst | Before | After | Before | After | Before |

<Batch Type, Ethylene Carbonate Homo, Metal Catalyst, with Organic Solvent - - - 3>

TABLE 1-11

| | Ex. 1-1-47 | Ex. 1-1-48 |
|---|---|---|
| Kind of monomer | Ethylene | Ethylene |
| | carbonate | carbonate |
| Catalyst | Tin octylate | Tin octylate |
| Kind of initiator | Lauryl | Lauryl |
| | alcohol | alcohol |
| Amount of initiator | 0.2 | 0.2 |
| (mol %) | | |
| Organic solvent | Toluene | Toluene |
| | (1 mol %) | (1 mol %) |
| Pressure (MPa) | 35 | 65 |
| Temperature (° C.) | 180 | 50 |
| Polymerization density | 484.29 | 1007.59 |
| (kg/m³) | | |
| Reaction time (min) | 90 | 90 |
| R/(C + R) | 0.99 | 0.98 |
| Weight average molecular | 510,000 | 585,000 |
| weight Mw | | |
| Molecular weight | 1.4 | 1.7 |
| distribution Mw/Mn | | |
| Residual monomer | 5,000 | 1,000 |
| (ppm by mass) | | |
| YI value | 11 | 10 |
| Impact strength | A | A |
| Addition of catalyst | After | Before |

<Batch Type, Monomer Kind Homo, Metal Catalyst, with Organic Solvent - - - 1>

TABLE 1-12

| | Ex. 1-1-49 | Ex. 1-1-50 | Ex. 1-1-51 | Ex. 1-1-52 | Ex. 1-1-53 |
|---|---|---|---|---|---|
| Kind of monomer | Glycolide | p- | Propiolactone | σ | Propylene |
| | | dioxanone | | valerolactone | carbonate |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.2 | 0.2 | 0.2 | 0.2 | 0.2 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 65 | 65 | 65 | 65 | 65 |
| Temperature (° C.) | 50 | 120 | 120 | 80 | 50 |
| Polymerization density | 1007.59 | 837.31 | 837.31 | 932.87 | 1007.59 |
| (kg/m³) | | | | | |
| Reaction time (min) | 90 | 90 | 90 | 90 | 90 |
| R/(C + R) | 0.79 | 0.95 | 0.95 | 0.95 | 0.98 |
| Weight average molecular | 590,000 | 580,000 | 587,000 | 580,000 | 570,000 |
| weight Mw | | | | | |
| Molecular weight | 1.4 | 1.4 | 1.5 | 1.5 | 1.5 |
| distribution Mw/Mn | | | | | |
| Residual monomer | 1,200 | 1,100 | 1,000 | 1,000 | 1,500 |
| (ppm by mass) | | | | | |
| YI value | 11 | 12 | 10 | 9 | 10 |
| Impact strength | A | A | A | A | A |
| Addition of catalyst | Before | Before | After | After | After |

<Batch Type, Monomer Kind Homo, Metal Catalyst, with Organic Solvent - - - 2>

TABLE 1-13

| | Ex. 1-1-54 | Ex. 1-1-55 | Ex. 1-1-56 | Ex. 1-1-57 | Ex. 1-1-58 |
|---|---|---|---|---|---|
| Kind of monomer | Trimethylene | Glycolide | p-dioxanone | Propiolactone | σ |
| | carbonate | | | | valerolactone |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.2 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 65 | 35 | 65 | 65 | 65 |
| Temperature (° C.) | 50 | 180 | 120 | 120 | 80 |
| Polymerization density | 1007.59 | 484.29 | 837.31 | 837.31 | 932.87 |
| (kg/m³) | | | | | |
| Reaction time (min) | 90 | 30 | 30 | 30 | 30 |
| R/(C + R) | 0.98 | 0.89 | 0.95 | 0.95 | 0.95 |
| Weight average molecular | 590,000 | 14,000 | 220,000 | 210,000 | 280,000 |
| weight Mw | | | | | |
| Molecular weight | 1.5 | 1.6 | 1.8 | 1.6 | 1.3 |
| distribution Mw/Mn | | | | | |
| Residual monomer | 2,000 | 3,200 | 5,800 | 4,500 | 6,500 |
| (ppm by mass) | | | | | |
| YI value | 11 | 4 | 3 | 3 | 5 |
| Impact strength | A | C | C | C | C |
| Addition of catalyst | Before | Before | After | After | Before |

<Batch Type, Monomer Kind Homo, Metal Catalyst, with Organic Solvent - - - 3>

TABLE 1-14

| | Ex. 1-1-59 | Ex. 1-1-60 |
|---|---|---|
| Kind of monomer | Propylene | Trimethylene |
| | carbonate | carbonate |
| Catalyst | Tin octylate | Tin octylate |
| Kind of initiator | Lauryl | Lauryl |
| | alcohol | alcohol |
| Amount of initiator | 0.5 | 0.5 |
| (mol %) | | |
| Organic solvent | Toluene | Toluene |
| | (1 mol %) | (1 mol %) |
| Pressure (MPa) | 65 | 65 |
| Temperature (° C.) | 50 | 50 |
| Polymerization density | 1007.59 | 1007.59 |
| (kg/m³) | | |
| Reaction time (min) | 30 | 30 |
| R/(C + R) | 0.98 | 0.98 |
| Weight average molecular | 285,000 | 260,000 |
| weight Mw | | |
| Molecular weight | 1.6 | 1.3 |
| distribution Mw/Mn | | |
| Residual monomer | 5,500 | 3,600 |
| (ppm by mass) | | |
| YI value | 4 | 3 |
| Impact strength | C | C |
| Addition of catalyst | After | After |

### Examples 1-2-1 to 1-2-45 and Comparative Example 1-2-1

The polymer products of Examples 1-2-1 to 1-2-45 and Comparative Example 1-2 were produced in the same manner as Example 1-1-1, except that no organic solvent (entrainer; toluene) was used, and at least any of the kind of the monomer, polymerization pressure, polymerization reaction temperature, density, reaction time, and mixing ratio [raw materials/(compressive fluid+raw materials)] used in Example 1-1-1 was changed as shown in Tables 2-1 to 2-11 below. As for how to add the catalyst, when adding the catalyst beforehand, the ring-opening-polymerizable monomer, the initiator, and the catalyst were put in the reaction vessel 127 from the start and reacted therein. When adding the catalyst afterwards, the ring-opening-polymerizable monomer and the initiator were put in the reaction vessel 127 and mixed therein, and after this, the catalyst was put therein and reacted. The pressure was controlled by changing the flow rate of the pump.

The characteristics of each of the polymer products thus obtained were evaluated in the same manner as Example 1-1-1. The results are shown in Tables 2-1 to 2-11.

<Batch Type, Lactide Homo, Metal Catalyst, without Organic Solvent - - - 1>

TABLE 2-1

| | Ex. 1-2-1 | Ex. 1-2-2 | Ex. 1-2-3 | Ex. 1-2-4 | Ex. 1-2-5 |
|---|---|---|---|---|---|
| Kind of monomer | Lactide | Lactide | Lactide | Lactide | Lactide |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Pressure (MPa) | 35 | 40 | 45 | 35 | 40 |
| Temperature (° C.) | 180 | 150 | 80 | 180 | 150 |
| Polymerization density | 484.29 | 607.11 | 851.47 | 484.29 | 607.11 |
| (kg/m³) | | | | | |
| Reaction time (min) | 15 | 15 | 15 | 30 | 30 |
| R/(C + R) | 0.94 | 0.92 | 0.89 | 0.41 | 0.36 |
| Weight average molecular | 15,000 | 130,000 | 270,000 | 16,000 | 160,000 |
| weight Mw | | | | | |
| Molecular weight | 1.3 | 1.2 | 1.5 | 1.4 | 1.6 |
| distribution Mw/Mn | | | | | |
| Residual monomer | 19,000 | 11,000 | 8,000 | 18,500 | 12,000 |
| (ppm by mass) | | | | | |
| YI value | 6 | 4 | 3 | 7 | 4 |
| Impact strength | C | C | C | C | C |
| Optical purity (%) | 90.6 | 92.1 | 94.2 | 91.1 | 93.6 |

<Batch Type, Lactide Homo, Metal Catalyst, without Organic Solvent - - - 2>

TABLE 2-2

| | Ex. 1-2-6 | Ex. 1-2-7 | Ex. 1-2-8 | Ex. 1-2-9 | Ex. 1-2-10 |
|---|---|---|---|---|---|
| Kind of monomer | Lactide | Lactide | Lactide | Lactide | Lactide |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Pressure (MPa) | 45 | 35 | 40 | 45 | 35 |
| Temperature (° C.) | 80 | 180 | 150 | 80 | 180 |
| Polymerization density | 851.47 | 484.29 | 607.11 | 851.47 | 484.29 |
| (kg/m³) | | | | | |
| Reaction time (min) | 30 | 30 | 30 | 30 | 45 |
| R/(C + R) | 0.28 | 0.94 | 0.92 | 0.89 | 0.94 |
| Weight average molecular | 290,000 | 17,000 | 190,000 | 280,000 | 18,000 |
| weight Mw | | | | | |
| Molecular weight | 1.7 | 1.3 | 1.6 | 1.7 | 1.4 |
| distribution Mw/Mn | | | | | |
| Residual monomer | 7,500 | 9,800 | 6,800 | 2,200 | 9,100 |
| (ppm by mass) | | | | | |
| YI value | 2 | 6 | 5 | 2 | 4 |
| Impact strength | C | C | C | C | C |
| Optical purity (%) | 92.4 | 90.2 | 93.3 | 95.1 | 91.6 |

<Batch Type, Lactide Homo, Metal Catalyst, without Organic Solvent - - - 3>

TABLE 2-3

| | Ex. 1-2-11 | Ex. 1-2-12 | Ex. 1-2-13 | Ex. 1-2-14 | Ex. 1-2-15 |
|---|---|---|---|---|---|
| Kind of monomer | Lactide | Lactide | Lactide | Lactide | Lactide |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.2 | 0.2 | 0.2 |
| (mol %) | | | | | |
| Pressure (MPa) | 40 | 45 | 50 | 60 | 65 |
| Temperature (° C.) | 150 | 80 | 180 | 150 | 80 |
| Polymerization density | 607.11 | 851.47 | 619.61 | 746.2 | 932.87 |
| (kg/m³) | | | | | |
| Reaction time (min) | 45 | 45 | 120 | 120 | 120 |
| R/(C + R) | 0.92 | 0.89 | 0.92 | 0.91 | 0.89 |
| Weight average molecular | 210,000 | 285,000 | 320,000 | 440,000 | 590,000 |
| weight Mw | | | | | |
| Molecular weight | 1.6 | 1.5 | 1.4 | 1.7 | 1.5 |
| distribution Mw/Mn | | | | | |
| Residual monomer | 4500 | 900 | 16000 | 8700 | 1200 |
| (ppm by mass) | | | | | |
| YI value | 4 | 3 | 9 | 8 | 7 |
| Impact strength | C | C | B | A | A |
| Optical purity (%) | 92.7 | 93.4 | 95.1 | 97.8 | 98.9 |

<Batch Type, Lactide Homo, Metal Catalyst, without Organic Solvent - - - 4>

TABLE 2-4

| | Ex. 1-2-16 | Ex. 1-2-17 | Ex. 1-2-18 | Ex. 1-2-19 | Ex. 1-2-20 |
|---|---|---|---|---|---|
| Kind of monomer | Lactide | Lactide | Lactide | Lactide | Lactide |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.2 | 0.2 | 0.2 | 0.2 | 0.2 |
| (mol %) | | | | | |
| Pressure (MPa) | 50 | 60 | 65 | 50 | 60 |
| Temperature (° C.) | 180 | 150 | 80 | 180 | 150 |
| Polymerization density | 619.61 | 746.2 | 932.87 | 619.61 | 746.2 |
| (kg/m³) | | | | | |
| Reaction time (min) | 120 | 120 | 120 | 120 | 120 |
| R/(C + R) | 0.36 | 0.31 | 0.26 | 0.92 | 0.91 |
| Weight average molecular | 410,000 | 530,000 | 580,000 | 382,000 | 465,000 |
| weight Mw | | | | | |
| Molecular weight | 1.3 | 1.6 | 1.8 | 1.4 | 1.6 |
| distribution Mw/Mn | | | | | |
| Residual monomer | 19,800 | 2,200 | 700 | 7,700 | 4,200 |
| (ppm by mass) | | | | | |
| YI value | 10 | 10 | 9 | 9 | 12 |
| Impact strength | A | A | A | A | A |
| Optical purity (%) | 95.8 | 97.8 | 98.7 | 96.8 | 97.9 |

<Batch Type, Lactide Homo, Metal Catalyst, without Organic Solvent - - - 5>

TABLE 2-5

| | Ex. 1-2-21 | Comp. Ex. 1-2-1 |
|---|---|---|
| Kind of monomer | Lactide | Lactide |
| Catalyst | Tin octylate | Tin octylate |
| Kind of initiator | Lauryl | Lauryl |
| | alcohol | alcohol |
| Amount of initiator | 0.2 | 0.5 |
| (mol %) | | |
| Pressure (MPa) | 65 | 30 |
| Temperature (° C.) | 80 | 150 |
| Polymerization density | 932.87 | 491.99 |
| (kg/m³) | | |
| Reaction time (min) | 120 | 30 |
| R/(C + R) | 0.89 | 0.94 |
| Weight average molecular | 589,000 | 280,000 |
| weight Mw | | |
| Molecular weight | 1.7 | 1.4 |
| distribution Mw/Mn | | |
| Residual monomer | 760 | 17,500 |
| (ppm by mass) | | |
| YI value | 12 | 18 |
| Impact strength | A | C |
| Optical purity (%) | 99.6 | 79.1 |

<Batch Type, ε-Caprolactone Homo, Metal Catalyst, without Organic Solvent - - - 1>

TABLE 2-6

| | Ex. 1-2-22 | Ex. 1-2-23 | Ex. 1-2-24 | Ex. 1-2-25 | Ex. 1-2-26 |
|---|---|---|---|---|---|
| Kind of monomer | ε- | ε- | ε- | ε- | ε- |
| | caprolactone | caprolactone | caprolactone | caprolactone | caprolactone |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Pressure (MPa) | 35 | 65 | 65 | 35 | 65 |
| Temperature (° C.) | 120 | 50 | 50 | 120 | 50 |
| Polymerization density | 645.54 | 1007.59 | 1007.59 | 645.54 | 1007.59 |
| (kg/m³) | | | | | |
| Reaction time (min) | 15 | 15 | 30 | 30 | 30 |
| R/(C + R) | 0.96 | 0.95 | 0.25 | 0.96 | 0.95 |
| Weight average molecular | 18,000 | 140,000 | 150,000 | 20,000 | 220,000 |
| weight Mw | | | | | |
| Molecular weight | 1.4 | 1.6 | 1.5 | 1.5 | 1.6 |
| distribution Mw/Mn | | | | | |
| Residual monomer | 15,000 | 9,000 | 8,800 | 7,000 | 8,800 |
| (ppm by mass) | | | | | |
| YI value | 4 | 1 | 2 | 5 | 2 |
| Impact strength | C | C | C | C | C |
| Addition of catalyst | Before | After | After | Before | After |

<Batch Type, ε-Caprolactone Homo, Metal Catalyst, without Organic Solvent - - - 2>

TABLE 2-7

| | Ex. 1-2-27 | Ex. 1-2-28 | Ex. 1-2-29 | Ex. 1-2-30 | Ex. 1-2-31 |
|---|---|---|---|---|---|
| Kind of monomer | ε- | ε- | ε- | ε- | ε- |
| | caprolactone | caprolactone | caprolactone | caprolactone | caprolactone |
| Catalyst | Tin octylate | Tris | Tin octylate | Tin octylate | Tin octylate |
| | | (acetylacetonato) | | | |
| | | aluminum | | | |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.2 | 0.2 | 0.2 |
| (mol %) | | | | | |
| Pressure (MPa) | 35 | 65 | 35 | 65 | 65 |
| Temperature (° C.) | 120 | 50 | 120 | 50 | 50 |
| Polymerization density | 645.54 | 1007.59 | 645.54 | 1007.59 | 1007.59 |
| (kg/m³) | | | | | |
| Reaction time (min) | 45 | 45 | 120 | 120 | 120 |
| R/(C + R) | 0.96 | 0.95 | 0.96 | 0.95 | 0.25 |
| Weight average molecular | 230,000 | 250,000 | 310,000 | 500,000 | 575,000 |
| weight Mw | | | | | |
| Molecular weight | 1.5 | 1.3 | 1.6 | 1.7 | 1.6 |
| distribution Mw/Mn | | | | | |
| Residual monomer | 8,900 | 5,500 | 10,000 | 8,000 | 6,000 |
| (ppm by mass) | | | | | |
| YI value | 4 | 3 | 10 | 9 | 9 |
| Impact strength | C | C | B | A | A |
| Addition of catalyst | Before | After | Before | After | Before |

<Batch Type, ε-Caprolactone Homo, Metal Catalyst, without Organic Solvent - - - 3>

TABLE 2-8

| | Ex. 1-2-32 | Ex. 1-2-33 |
|---|---|---|
| Kind of monomer | ε- | ε- |
| | caprolactone | caprolactone |
| Catalyst | Tin octylate | Tin octylate |
| Kind of initiator | Lauryl | Lauryl |
| | alcohol | alcohol |
| Amount of initiator | 0.2 | 0.2 |
| (mol %) | | |
| Pressure (MPa) | 35 | 65 |
| Temperature (° C.) | 120 | 50 |
| Polymerization density | 645.54 | 1007.59 |
| (kg/m³) | | |
| Reaction time (min) | 120 | 120 |
| R/(C + R) | 0.96 | 0.95 |
| Weight average | 560,000 | 580,000 |
| molecular weight Mw | | |
| Molecular weight | 1.4 | 1.5 |
| distribution Mw/Mn | | |
| Residual monomer | 5,000 | 3,000 |
| (ppm by mass) | | |
| YI value | 12 | 10 |
| Impact strength | A | A |
| Addition of catalyst | After | Before |

<Batch Type, Ethylene Carbonate Homo, Metal Catalyst, without Organic Solvent - - - 1>

TABLE 2-9

| | Ex. 1-2-34 | Ex. 1-2-35 | Ex. 1-2-36 | Ex. 1-2-37 | Ex. 1-2-38 |
|---|---|---|---|---|---|
| Kind of monomer | Ethylene | Ethylene | Ethylene | Ethylene | Ethylene |
| | carbonate | carbonate | carbonate | carbonate | carbonate |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Pressure (MPa) | 35 | 65 | 65 | 35 | 65 |
| Temperature (° C.) | 180 | 50 | 50 | 180 | 50 |
| Polymerization density | 484.29 | 1007.59 | 1007.59 | 484.29 | 1007.59 |
| (kg/m³) | | | | | |
| Reaction time (min) | 15 | 15 | 30 | 30 | 30 |
| R/(C + R) | 0.99 | 0.98 | 0.26 | 0.99 | 0.98 |
| Weight average | 16,000 | 170,000 | 250,000 | 17,000 | 260,000 |
| molecular weight Mw | | | | | |
| Molecular weight | 1.4 | 1.6 | 1.5 | 1.5 | 1.6 |
| distribution Mw/Mn | | | | | |
| Residual monomer | 17,000 | 7,900 | 6,000 | 8,500 | 8,800 |
| (ppm by mass) | | | | | |
| YI value | 6 | 2 | 3 | 4 | 3 |
| Impact strength | C | C | C | C | C |
| Addition of catalyst | Before | After | After | Before | After |

<Batch Type, Ethylene Carbonate Homo, Metal Catalyst, without Organic Solvent - - - 2>

TABLE 2-10

| | Ex. 1-2-39 | Ex. 1-2-40 | Ex. 1-2-41 | Ex. 1-2-42 | Ex. 1-2-43 |
|---|---|---|---|---|---|
| Kind of monomer | Ethylene | Ethylene | Ethylene | Ethylene | Ethylene |
| | carbonate | carbonate | carbonate | carbonate | carbonate |
| Catalyst | Tin octylate | Tris | Tin octylate | Tin octylate | Tin octylate |
| | | (acetyl- | | | |
| | | acetonato) | | | |
| | | aluminum | | | |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.2 | 0.2 | 0.2 |
| (mol %) | | | | | |
| Pressure (MPa) | 35 | 65 | 35 | 65 | 65 |
| Temperature (° C.) | 180 | 50 | 180 | 50 | 50 |
| Polymerization density | 484.29 | 1007.59 | 484.29 | 1007.59 | 1007.59 |
| (kg/m³) | | | | | |
| Reaction time (min) | 45 | 45 | 120 | 120 | 120 |
| R/(C + R) | 0.99 | 0.98 | 0.99 | 0.98 | 0.26 |
| Weight average | 250,000 | 280,000 | 335,000 | 557,000 | 570,000 |
| molecular weight Mw | | | | | |
| Molecular weight | 1.7 | 1.4 | 1.6 | 1.8 | 1.6 |
| distribution Mw/Mn | | | | | |
| Residual monomer | 7,600 | 6,600 | 7,500 | 11,000 | 10,000 |
| (ppm by mass) | | | | | |
| YI value | 2 | 3 | 9 | 8 | 9 |
| Impact strength | C | C | B | A | A |
| Addition of catalyst | Before | After | Before | After | Before |

<Batch Type, Ethylene Carbonate Homo, Metal Catalyst, without Organic Solvent - - - 3>

TABLE 2-11

| | Ex. 1-2-44 | Ex. 1-2-45 |
|---|---|---|
| Kind of monomer | Ethylene | Ethylene |
| | carbonate | carbonate |
| Catalyst | Tin octylate | Tin octylate |
| Kind of initiator | Lauryl | Lauryl |
| | alcohol | alcohol |
| Amount of initiator | 0.2 | 0.2 |
| (mol %) | | |
| Pressure (MPa) | 35 | 65 |
| Temperature (° C.) | 180 | 50 |
| Polymerization density | 484.29 | 1007.59 |
| (kg/m³) | | |
| Reaction time (min) | 120 | 120 |
| R/(C + R) | 0.99 | 0.98 |
| Weight average | 550,000 | 585,000 |
| molecular weight Mw | | |
| Molecular weight | 1.8 | 1.8 |
| distribution Mw/Mn | | |
| Residual monomer | 6,000 | 1,500 |
| (ppm by mass) | | |
| YI value | 12 | 10 |
| Impact strength | A | A |
| Addition of catalyst | After | Before |

### Examples 1-3-1 to 1-3-62

The polymer products of Examples 1-3-1 to 1-3-62 were produced in the same manner as Example 1-1-1, except that the metal catalyst was changed to an organic molecule catalyst, and at least any of the kind of the monomer, polymerization pressure, polymerization reaction temperature, density, reaction time, and mixing ratio [raw materials/(compressive fluid+raw materials)] used in Example 1-1-1 was changed as shown in Tables 3-1 to 3-14 below. As for how to add the catalyst, when adding the catalyst beforehand, the ring-opening-polymerizable monomer, the initiator, and the catalyst were put in the reaction vessel 127 from the start and reacted therein. When adding the catalyst afterwards, the ring-opening-polymerizable monomer and the initiator were put in the reaction vessel 127 and mixed therein, and after this, the catalyst was put therein and reacted. The pressure was controlled by changing the flow rate of the pump.

The characteristics of each of the polymer products thus obtained were evaluated in the same manner as Example 1-1-1. The results are shown in Tables 3-1 to 3-14.

<Batch Type, Lactide Homo, Organic Molecule Catalyst, with Organic Solvent - - - 1>

TABLE 3-1

| | Ex. 1-3-1 | Ex. 1-3-2 | Ex. 1-3-3 | Ex. 1-3-4 | Ex. 1-3-5 |
|---|---|---|---|---|---|
| Kind of monomer | Lactide | Lactide | Lactide | Lactide | Lactide |
| Catalyst | DBU | DBU | DBU | DBU | DBU |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 35 | 40 | 45 | 35 | 40 |
| Temperature (° C.) | 80 | 70 | 60 | 80 | 70 |
| Polymerization density | 788.97 | 856.7 | 913.29 | 788.97 | 856.7 |
| (kg/m³) | | | | | |
| Reaction time (min) | 15 | 15 | 15 | 30 | 30 |
| R/(C + R) | 0.94 | 0.92 | 0.89 | 0.41 | 0.36 |
| Weight average | 13,000 | 85,000 | 152,000 | 16,000 | 110,000 |
| molecular weight Mw | | | | | |
| Molecular weight | 1.4 | 1.6 | 1.5 | 1.4 | 1.6 |
| distribution Mw/Mn | | | | | |
| Residual monomer | 19,700 | 9,800 | 6,500 | 18,800 | 7,700 |
| (ppm by mass) | | | | | |
| YI value | 6 | 3 | 3 | 5 | 4 |
| Impact strength | C | C | C | C | C |

<Batch Type, Lactide Homo, Organic Molecule Catalyst, with Organic Solvent - - - 2>

TABLE 3-2

| | Ex. 1-3-6 | Ex. 1-3-7 | Ex. 1-3-8 | Ex. 1-3-9 | Ex. 1-3-10 |
|---|---|---|---|---|---|
| Kind of monomer | Lactide | Lactide | Lactide | Lactide | Lactide |
| Catalyst | DBU | DBU | DBU | DBU | DBU |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 45 | 35 | 40 | 45 | 35 |
| Temperature (° C.) | 60 | 80 | 70 | 60 | 80 |
| Polymerization density | 913.29 | 788.97 | 856.7 | 913.29 | 788.97 |
| (kg/m³) | | | | | |
| Reaction time (min) | 30 | 30 | 30 | 30 | 45 |
| R/(C + R) | 0.28 | 0.94 | 0.92 | 0.89 | 0.94 |
| Weight average | 189,000 | 15,000 | 95,000 | 164,000 | 18,000 |
| molecular weight Mw | | | | | |
| Molecular weight | 1.5 | 1.4 | 1.6 | 1.5 | 1.4 |
| distribution Mw/Mn | | | | | |
| Residual monomer | 4,500 | 9,500 | 4,300 | 1,000 | 7,800 |
| (ppm by mass) | | | | | |
| YI value | 2 | 6 | 6 | 3 | 7 |
| Impact strength | C | C | C | C | C |

<Batch Type, Lactide Homo, Organic Molecule Catalyst, with Organic Solvent - - - 3>

TABLE 3-3

| | Ex. 1-3-11 | Ex. 1-3-12 | Ex. 1-3-13 | Ex. 1-3-14 | Ex. 1-3-15 |
|---|---|---|---|---|---|
| Kind of monomer | Lactide | Lactide | Lactide | Lactide | Lactide |
| Catalyst | DBU | DBU | DBU | DBU | DBU |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 40 | 45 | 50 | 55 | 60 |
| Temperature (° C.) | 70 | 60 | 80 | 70 | 60 |
| Polymerization density | 856.7 | 913.29 | 875.68 | 924.12 | 967.71 |
| (kg/m³) | | | | | |
| Reaction time (min) | 45 | 45 | 30 | 30 | 30 |
| R/(C + R) | 0.92 | 0.89 | 0.92 | 0.91 | 0.89 |
| Weight average | 115,000 | 184,000 | 15,000 | 110,000 | 190,000 |
| molecular weight Mw | | | | | |
| Molecular weight | 1.6 | 1.7 | 1.4 | 1.6 | 1.5 |
| distribution Mw/Mn | | | | | |
| Residual monomer | 3,600 | 2,900 | 19,800 | 8,200 | 2,100 |
| (ppm by mass) | | | | | |
| YI value | 5 | 3 | 4 | 4 | 2 |
| Impact strength | C | C | C | C | C |

<Batch Type, Lactide Homo, Organic Molecule Catalyst, with Organic Solvent - - - 4>

TABLE 3-4

| | Ex. 1-3-16 | Ex. 1-3-17 | Ex. 1-3-18 | Ex. 1-3-19 | Ex. 1-3-20 |
|---|---|---|---|---|---|
| Kind of monomer | Lactide | Lactide | Lactide | Lactide | Lactide |
| Catalyst | DBU | DBU | DBU | DBU | DBU |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 50 | 55 | 60 | 50 | 55 |
| Temperature (° C.) | 80 | 70 | 60 | 80 | 70 |
| Polymerization density | 875.68 | 924.12 | 967.71 | 875.68 | 924.12 |
| (kg/m³) | | | | | |
| Reaction time (min) | 60 | 60 | 60 | 60 | 60 |
| R/(C + R) | 0.36 | 0.31 | 0.26 | 0.92 | 0.91 |
| Weight average | 16,000 | 190,000 | 230,000 | 17,000 | 190,000 |
| molecular weight Mw | | | | | |
| Molecular weight | 1.4 | 1.6 | 1.8 | 1.4 | 1.7 |
| distribution Mw/Mn | | | | | |
| Residual monomer | 16,200 | 7,400 | 1,800 | 8,300 | 3,600 |
| (ppm by mass) | | | | | |
| YI value | 5 | 5 | 1 | 4 | 2 |
| Impact strength | C | C | C | C | C |

<Batch Type, Lactide Homo, Organic Molecule Catalyst, with Organic Solvent - - - 5>

TABLE 3-5

| | Ex. 1-3-21 | Ex. 1-3-22 | Ex. 1-3-23 | Ex. 1-3-24 | Ex. 1-3-25 |
|---|---|---|---|---|---|
| Kind of monomer | Lactide | Lactide | Lactide | Lactide | Lactide |
| Catalyst | DBU | DBU | DBU | DBU | DMAP |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 60 | 50 | 55 | 60 | 35 |
| Temperature (° C.) | 60 | 80 | 70 | 60 | 180 |
| Polymerization density | 967.71 | 875.68 | 924.12 | 967.71 | 484.29 |
| (kg/m³) | | | | | |
| Reaction time (min) | 60 | 90 | 90 | 90 | 15 |
| R/(C + R) | 0.89 | 0.92 | 0.91 | 0.89 | 0.94 |
| Weight average | 250,000 | 180,000 | 210,000 | 285,000 | 14,500 |
| molecular weight Mw | | | | | |
| Molecular weight | 1.5 | 1.4 | 1.3 | 1.5 | 1.4 |
| distribution Mw/Mn | | | | | |
| Residual monomer | 800 | 8,300 | 890 | 800 | 18,000 |
| (ppm by mass) | | | | | |
| YI value | 2 | 4 | 3 | 3 | 6 |
| Impact strength | C | C | C | C | C |

<Batch Type, Lactide Homo, Organic Molecule Catalyst, with Organic Solvent - - - 6>

TABLE 3-6

| | Ex. 1-3-26 | Ex. 1-3-27 | Ex. 1-3-28 | Ex. 1-3-29 | Ex. 1-3-30 |
|---|---|---|---|---|---|
| Kind of monomer | Lactide | Lactide | Lactide | Lactide | Lactide |
| Catalyst | DMAP | DMAP | DMAP | DMAP | DMAP |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 40 | 45 | 35 | 40 | 45 |
| Temperature (° C.) | 150 | 80 | 180 | 150 | 80 |
| Polymerization density | 607.11 | 851.47 | 484.29 | 607.11 | 851.47 |
| (kg/m³) | | | | | |
| Reaction time (min) | 15 | 15 | 30 | 30 | 30 |
| R/(C + R) | 0.92 | 0.89 | 0.41 | 0.36 | 0.28 |
| Weight average | 120,000 | 260,000 | 16,500 | 100,000 | 230,000 |
| molecular weight Mw | | | | | |
| Molecular weight | 1.6 | 1.5 | 1.6 | 1.6 | 1.5 |
| distribution Mw/Mn | | | | | |
| Residual monomer | 9,200 | 2,300 | 16,200 | 8,100 | 1,800 |
| (ppm by mass) | | | | | |
| YI value | 4 | 3 | 6 | 3 | 3 |
| Impact strength | C | C | C | C | C |

<Batch Type, Lactide Homo, Organic Molecule Catalyst, with Organic Solvent - - - 7>

TABLE 3-7

| | Ex. 1-3-31 | Ex. 1-3-32 | Ex. 1-3-33 | Ex. 1-3-34 | Ex. 1-3-35 |
|---|---|---|---|---|---|
| Kind of monomer | Lactide | Lactide | Lactide | Lactide | Lactide |
| Catalyst | DMAP | DMAP | DMAP | DMAP | DMAP |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 35 | 40 | 45 | 35 | 40 |
| Temperature (° C.) | 180 | 150 | 80 | 180 | 150 |
| Polymerization density | 484.29 | 607.11 | 851.47 | 484.29 | 607.11 |
| (kg/m³) | | | | | |
| Reaction time (min) | 30 | 30 | 30 | 45 | 45 |
| R/(C + R) | 0.94 | 0.92 | 0.89 | 0.94 | 0.92 |
| Weight average | 17,000 | 190,000 | 280,000 | 17,000 | 190,000 |
| molecular weight Mw | | | | | |
| Molecular weight | 1.3 | 1.6 | 1.5 | 1.6 | 1.8 |
| distribution Mw/Mn | | | | | |
| Residual monomer | 9,500 | 4,200 | 1,100 | 8,100 | 3,200 |
| (ppm by mass) | | | | | |
| YI value | 7 | 6 | 3 | 7 | 4 |
| Impact strength | C | C | C | C | C |

<Batch Type, Lactide Homo, Organic Molecule Catalyst, with Organic Solvent - - - 8>

TABLE 3-8

| | Ex. 1-3-36 | Ex. 1-3-37 | Ex. 1-3-38 | Ex. 1-3-39 | Ex. 1-3-40 |
|---|---|---|---|---|---|
| Kind of monomer | Lactide | Lactide | Lactide | Lactide | Lactide |
| Catalyst | DMAP | DMAP | DMAP | DMAP | DMAP |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 45 | 50 | 55 | 60 | 50 |
| Temperature (° C.) | 80 | 180 | 150 | 80 | 180 |
| Polymerization density | 851.47 | 619.61 | 746.2 | 932.87 | 619.61 |
| (kg/m³) | | | | | |
| Reaction time (min) | 45 | 30 | 30 | 30 | 60 |
| R/(C + R) | 0.89 | 0.92 | 0.91 | 0.89 | 0.36 |
| Weight average | 280,000 | 17,000 | 160,000 | 280,000 | 19,000 |
| molecular weight Mw | | | | | |
| Molecular weight | 1.5 | 1.4 | 1.6 | 1.3 | 1.4 |
| distribution Mw/Mn | | | | | |
| Residual monomer | 900 | 17,000 | 8,800 | 1,900 | 11,000 |
| (ppm by mass) | | | | | |
| YI value | 3 | 5 | 3 | 2 | 4 |
| Impact strength | C | C | C | C | C |

<Batch Type, Lactide Homo, Organic Molecule Catalyst, with Organic Solvent - - - 9>

TABLE 3-9

| | Ex. 1-3-41 | Ex. 1-3-42 | Ex. 1-3-43 | Ex. 1-3-44 | Ex. 1-3-45 |
|---|---|---|---|---|---|
| Kind of monomer | Lactide | Lactide | Lactide | Lactide | Lactide |
| Catalyst | DMAP | DMAP | DMAP | DMAP | DMAP |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 55 | 60 | 50 | 55 | 60 |
| Temperature (° C.) | 150 | 80 | 180 | 150 | 80 |
| Polymerization density | 746.2 | 932.87 | 619.61 | 746.2 | 932.87 |
| (kg/m³) | | | | | |
| Reaction time (min) | 60 | 60 | 60 | 60 | 60 |
| R/(C + R) | 0.31 | 0.26 | 0.92 | 0.91 | 0.89 |
| Weight average | 160,000 | 280,000 | 18,200 | 210,000 | 287,000 |
| molecular weight Mw | | | | | |
| Molecular weight | 1.6 | 1.2 | 1.4 | 1.6 | 1.7 |
| distribution Mw/Mn | | | | | |
| Residual monomer | 7,400 | 1,700 | 8,300 | 3,600 | 800 |
| (ppm by mass) | | | | | |
| YI value | 4 | 2 | 4 | 5 | 2 |
| Impact strength | C | C | C | C | C |

<Batch Type, Lactide Homo, Organic Molecule Catalyst, with Organic Solvent - - - 9>

TABLE 3-10

| | Ex. 1-3-46 | Ex. 1-3-47 | Ex. 1-3-48 |
|---|---|---|---|
| Kind of monomer | Lactide | Lactide | Lactide |
| Catalyst | DMAP | DMAP | DMAP |
| Kind of initiator | Lauryl | Lauryl | Lauryl |
| | alcohol | alcohol | alcohol |
| Amount of initiator | 0.5 | 0.5 | 0.5 |
| (mol %) | | | |
| Organic solvent | Toluene | Toluene | Toluene |
| | (1 mol %) | (1 mol %) | (1 mol %) |
| Pressure (MPa) | 50 | 55 | 60 |
| Temperature (° C.) | 180 | 150 | 80 |
| Polymerization density | 619.61 | 746.2 | 932.87 |
| (kg/m³) | | | |
| Reaction time (min) | 90 | 90 | 90 |
| R/(C + R) | 0.92 | 0.91 | 0.89 |
| Weight average | 175,000 | 210,000 | 290,000 |
| molecular weight Mw | | | |
| Molecular weight | 1.4 | 1.6 | 1.5 |
| distribution Mw/Mn | | | |
| Residual monomer | 7,000 | 2,900 | 800 |
| (ppm by mass) | | | |
| YI value | 4 | 2 | 2 |
| Impact strength | C | C | C |

<Batch Type, ε-Caprolactone Homo, Organic Molecule Catalyst, with Organic Solvent - - - 1>

TABLE 3-11

| | Ex. 1-3-49 | Ex. 1-3-50 | Ex. 1-3-51 | Ex. 1-3-52 | Ex. 1-3-53 |
|---|---|---|---|---|---|
| Kind of monomer | ε- | ε- | ε- | ε- | ε- |
| | caprolactone | caprolactone | caprolactone | caprolactone | caprolactone |
| Catalyst | TBD | TBD | TBD | TBD | TBD |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 35 | 65 | 65 | 35 | 65 |
| Temperature (° C.) | 120 | 50 | 50 | 120 | 50 |
| Polymerization density | 645.54 | 1007.59 | 1007.59 | 645.54 | 1007.59 |
| (kg/m³) | | | | | |
| Reaction time (min) | 15 | 15 | 30 | 30 | 30 |
| R/(C + R) | 0.96 | 0.95 | 0.25 | 0.96 | 0.95 |
| Weight average | 14,000 | 160,000 | 240,000 | 15,000 | 240,000 |
| molecular weight Mw | | | | | |
| Molecular weight | 1.4 | 1.6 | 1.4 | 1.5 | 1.6 |
| distribution Mw/Mn | | | | | |
| Residual monomer | 15,000 | 8,300 | 7,800 | 8,000 | 3,300 |
| (ppm by mass) | | | | | |
| YI value | 5 | 2 | 1 | 3 | 3 |
| Impact strength | C | C | C | C | C |
| Addition of catalyst | Before | After | After | Before | After |

<Batch Type, ε-Caprolactone Homo, Organic Molecule Catalyst, with Organic Solvent - - - 2>

TABLE 3-12

| | Ex. 1-3-54 | Ex. 1-3-55 |
|---|---|---|
| Kind of monomer | ε- | ε- |
| | caprolactone | caprolactone |
| Catalyst | TBD | TBD |
| Kind of initiator | Lauryl | Lauryl |
| | alcohol | alcohol |
| Amount of initiator | 0.5 | 0.5 |
| (mol %) | | |
| Organic solvent | Toluene | Toluene |
| | (1 mol %) | (1 mol %) |
| Pressure (MPa) | 35 | 65 |
| Temperature (° C.) | 120 | 50 |
| Polymerization density | 645.54 | 1007.59 |
| (kg/m³) | | |
| Reaction time (min) | 45 | 45 |
| R/(C + R) | 0.96 | 0.95 |
| Weight average | 260,000 | 280,000 |
| molecular weight Mw | | |
| Molecular weight | 1.5 | 1.4 |
| distribution Mw/Mn | | |
| Residual monomer | 3,200 | 3,100 |
| (ppm by mass) | | |
| YI value | 4 | 1 |
| Impact strength | C | C |
| Addition of catalyst | Before | After |

<Batch Type, Ethylene Carbonate Homo, Organic Molecule Catalyst, with Organic Solvent - - - 1>

TABLE 3-13

| | Ex. 1-3-56 | Ex. 1-3-57 | Ex. 1-3-58 | Ex. 1-3-59 | Ex. 1-3-60 |
|---|---|---|---|---|---|
| Kind of monomer | Ethylene | Ethylene | Ethylene | Ethylene | Ethylene |
| | carbonate | carbonate | carbonate | carbonate | carbonate |
| Catalyst | DBU | DBU | DBU | DBU | DBU |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Organic solvent | Toluene | Toluene | Toluene | Toluene | Toluene |
| | (1 mol %) | (1 mol %) | (1 mol %) | (1 mol %) | (1 mol %) |
| Pressure (MPa) | 35 | 65 | 65 | 35 | 65 |
| Temperature (° C.) | 80 | 50 | 50 | 80 | 50 |
| Polymerization density | 788.97 | 1007.59 | 1007.59 | 788.97 | 1007.59 |
| (kg/m³) | | | | | |
| Reaction time (min) | 15 | 15 | 30 | 30 | 30 |
| R/(C + R) | 0.99 | 0.98 | 0.26 | 0.99 | 0.98 |
| Weight average | 18,000 | 230,000 | 250,000 | 260,000 | 280,000 |
| molecular weight Mw | | | | | |
| Molecular weight | 1.4 | 1.6 | 1.4 | 1.5 | 1.6 |
| distribution Mw/Mn | | | | | |
| Residual monomer | 18,000 | 10,000 | 8,500 | 6,300 | 6,000 |
| (ppm by mass) | | | | | |
| YI value | 6 | 5 | 3 | 6 | 3 |
| Impact strength | C | C | C | C | C |
| Addition of catalyst | Before | After | After | Before | After |

<Batch Type, Ethylene Carbonate Homo, Organic Molecule Catalyst, with Organic Solvent - - - 2>

TABLE 3-14

| | Ex. 1-3-61 | Ex. 1-3-62 |
|---|---|---|
| Kind of monomer | Ethylene | Ethylene |
| | carbonate | carbonate |
| Catalyst | DBU | DBU |
| Kind of initiator | Lauryl | Lauryl |
| | alcohol | alcohol |
| Amount of initiator | 0.5 | 0.5 |
| (mol %) | | |
| Organic solvent | Toluene | Toluene |
| | (1 mol %) | (1 mol %) |
| Pressure (MPa) | 35 | 65 |
| Temperature (° C.) | 80 | 50 |
| Polymerization density | 788.97 | 1007.59 |
| (kg/m³) | | |
| Reaction time (min) | 45 | 45 |
| R/(C + R) | 0.99 | 0.98 |
| Weight average | 270,000 | 285,000 |
| molecular weight Mw | | |
| Molecular weight | 1.5 | 1.4 |
| distribution Mw/Mn | | |
| Residual monomer | 4,000 | 2,800 |
| (ppm by mass) | | |
| YI value | 4 | 3 |
| Impact strength | C | C |
| Addition of catalyst | Before | After |

### Examples 1-4-1 to 1-4-30 and Comparative Example 1-4-1

The polymer products of Examples 1-4-1 to 1-4-30 and Comparative Example 1-4-1 were produced in the same manner as Example 1-1-1, except that the metal catalyst was changed to an organic molecule catalyst, no organic solvent (entrainer) was used, and at least any of the kind of the monomer, polymerization pressure, polymerization reaction temperature, density, reaction time, and mixing ratio [raw materials/(compressive fluid+raw materials)] used in Example 1-1-1 was changed as shown in Tables 4-1 to 4-7 below. As for how to add the catalyst, when adding the catalyst beforehand, the ring-opening-polymerizable monomer, the initiator, and the catalyst were put in the reaction vessel 127 from the start and reacted therein. When adding the catalyst afterwards, the ring-opening-polymerizable monomer and the initiator were put in the reaction vessel 127 and mixed therein, and after this, the catalyst was put therein and reacted. The pressure was controlled by changing the flow rate of the pump.

The characteristics of each of the polymer products thus obtained were evaluated in the same manner as Example 1-1-1. The results are shown in Tables 4-1 to 4-7.

<Batch Type, Lactide Homo, Organic Molecule Catalyst, without Organic Solvent - - - 1>

TABLE 4-1

| | Ex. 1-4-1 | Ex. 1-4-2 | Ex. 1-4-3 | Ex. 1-4-4 | Ex. 1-4-5 |
|---|---|---|---|---|---|
| Kind of monomer | Lactide | Lactide | Lactide | Lactide | Lactide |
| Catalyst | DBU | DBU | DBU | DBU | DBU |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Pressure (MPa) | 35 | 40 | 45 | 35 | 40 |
| Temperature (° C.) | 80 | 70 | 60 | 80 | 70 |
| Polymerization density | 788.97 | 856.7 | 913.29 | 788.97 | 856.7 |
| (kg/m³) | | | | | |
| Reaction time (min) | 15 | 15 | 15 | 30 | 30 |
| R/(C + R) | 0.94 | 0.92 | 0.89 | 0.41 | 0.36 |
| Weight average | 13,000 | 85,000 | 152,000 | 16,000 | 110,000 |
| molecular weight Mw | | | | | |
| Molecular weight | 1.4 | 1.6 | 1.5 | 1.3 | 1.6 |
| distribution Mw/Mn | | | | | |
| Residual monomer | 16,900 | 9,800 | 6,500 | 12,000 | 7,700 |
| (ppm by mass) | | | | | |
| YI value | 6 | 4 | 3 | 5 | 3 |
| Impact strength | C | C | C | C | C |

<Batch Type, Lactide Homo, Organic Molecule Catalyst, without Organic Solvent - - - 2>

TABLE 4-2

| | Ex. 1-4-6 | Ex. 1-4-7 | Ex. 1-4-8 | Ex. 1-4-9 | Ex. 1-4-10 |
|---|---|---|---|---|---|
| Kind of monomer | Lactide | Lactide | Lactide | Lactide | Lactide |
| Catalyst | DBU | DBU | DBU | DBU | DBU |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Pressure (MPa) | 45 | 50 | 55 | 60 | 50 |
| Temperature (° C.) | 60 | 80 | 70 | 60 | 80 |
| Polymerization density | 913.29 | 875.68 | 924.12 | 967.71 | 875.68 |
| (kg/m³) | | | | | |
| Reaction time (min) | 30 | 30 | 30 | 30 | 60 |
| R/(C + R) | 0.28 | 0.92 | 0.91 | 0.89 | 0.36 |
| Weight average | 189,000 | 15,000 | 110,000 | 190,000 | 16,000 |
| molecular weight Mw | | | | | |
| Molecular weight | 1.4 | 1.4 | 1.6 | 1.6 | 1.4 |
| distribution Mw/Mn | | | | | |
| Residual monomer | 4,500 | 17,600 | 8,200 | 2,100 | 18,200 |
| (ppm by mass) | | | | | |
| YI value | 3 | 4 | 3 | 2 | 5 |
| Impact strength | C | C | C | C | C |

<Batch Type, Lactide Homo, Organic Molecule Catalyst, without Organic Solvent - - - 3>

TABLE 4-3

| | | | Comp. | | |
|---|---|---|---|---|---|
| | Ex. 1-4-11 | Ex. 1-4-12 | Ex. 1-4-1 | Ex. 1-4-13 | Ex. 1-4-14 |
| Kind of monomer | Lactide | Lactide | Lactide | Lactide | Lactide |
| Catalyst | DBU | DBU | DBU | DMAP | DMAP |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Pressure (MPa) | 55 | 60 | 30 | 35 | 40 |
| Temperature (° C.) | 70 | 60 | 80 | 180 | 150 |
| Polymerization density | 924.12 | 967.71 | 829.71 | 484.29 | 607.11 |
| (kg/m³) | | | | | |
| Reaction time (min) | 60 | 60 | 60 | 15 | 15 |
| R/(C + R) | 0.31 | 0.26 | 0.9 | 0.94 | 0.92 |
| Weight average | 190,000 | 230,000 | 180,000 | 13,000 | 110,000 |
| molecular weight Mw | | | | | |
| Molecular weight | 1.6 | 1.4 | 1.3 | 1.2 | 1.6 |
| distribution Mw/Mn | | | | | |
| Residual monomer | 7,400 | 1,800 | 7,000 | 16,000 | 7,200 |
| (ppm by mass) | | | | | |
| YI value | 4 | 4 | 23 | 5 | 4 |
| Impact strength | C | C | C | C | C |

<Batch Type, Lactide Homo, Organic Molecule Catalyst, without Organic Solvent - - - 4>

TABLE 4-4

| | Ex. 1-4-15 | Ex. 1-4-16 | Ex. 1-4-17 | Ex. 1-4-18 | Ex. 1-4-19 |
|---|---|---|---|---|---|
| Kind of monomer | Lactide | Lactide | Lactide | Lactide | Lactide |
| Catalyst | DMAP | DMAP | DMAP | DMAP | DMAP |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Pressure (MPa) | 45 | 35 | 40 | 45 | 50 |
| Temperature (° C.) | 80 | 180 | 150 | 80 | 180 |
| Polymerization density | 851.47 | 484.29 | 607.11 | 851.47 | 619.61 |
| (kg/m³) | | | | | |
| Reaction time (min) | 15 | 30 | 30 | 30 | 30 |
| R/(C + R) | 0.89 | 0.41 | 0.36 | 0.28 | 0.92 |
| Weight average | 240,000 | 13,000 | 160,000 | 290,000 | 17,000 |
| molecular weight Mw | | | | | |
| Molecular weight | 1.7 | 1.4 | 1.6 | 1.6 | 1.4 |
| distribution Mw/Mn | | | | | |
| Residual monomer | 1,800 | 17,000 | 7,400 | 1,800 | 17,600 |
| (ppm by mass) | | | | | |
| YI value | 3 | 7 | 3 | 3 | 6 |
| Impact strength | C | C | C | C | C |

<Batch Type, Lactide Homo, Organic Molecule Catalyst, without Organic Solvent - - - 5>

TABLE 4-5

| | Ex. 1-4-20 | Ex. 1-4-21 | Ex. 1-4-22 | Ex. 1-4-23 | Ex. 1-4-24 |
|---|---|---|---|---|---|
| Kind of monomer | Lactide | Lactide | Lactide | Lactide | Lactide |
| Catalyst | DMAP | DMAP | DMAP | DMAP | DMAP |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Pressure (MPa) | 55 | 60 | 50 | 55 | 60 |
| Temperature (° C.) | 150 | 80 | 180 | 150 | 80 |
| Polymerization density | 746.2 | 932.87 | 619.61 | 746.2 | 932.87 |
| (kg/m³) | | | | | |
| Reaction time (min) | 30 | 30 | 60 | 60 | 60 |
| R/(C + R) | 0.91 | 0.89 | 0.36 | 0.31 | 0.26 |
| Weight average | 160,000 | 280,000 | 16,000 | 160,000 | 290,000 |
| molecular weight Mw | | | | | |
| Molecular weight | 1.4 | 1.5 | 1.4 | 1.6 | 1.7 |
| distribution Mw/Mn | | | | | |
| Residual monomer | 8,200 | 2,200 | 18,200 | 7,400 | 1,800 |
| (ppm by mass) | | | | | |
| YI value | 5 | 2 | 5 | 3 | 2 |
| Impact strength | C | C | C | C | C |

<Batch Type, ε-Caprolactone, Organic Molecule Catalyst, without Organic Solvent - - - 1>

TABLE 4-6

| | Ex. 1-4-25 | Ex. 1-4-26 | Ex. 1-4-27 |
|---|---|---|---|
| Kind of monomer | ε- | ε- | ε- |
| | caprolactone | caprolactone | caprolactone |
| Catalyst | TBD | TBD | TBD |
| Kind of initiator | Lauryl | Lauryl | Lauryl |
| | alcohol | alcohol | alcohol |
| Amount of initiator | 0.5 | 0.5 | 0.5 |
| (mol %) | | | |
| Pressure (MPa) | 35 | 65 | 65 |
| Temperature (° C.) | 120 | 50 | 50 |
| Polymerization density | 645.54 | 1007.59 | 1007.59 |
| (kg/m³) | | | |
| Reaction time (min) | 15 | 15 | 30 |
| R/(C + R) | 0.96 | 0.95 | 0.25 |
| Weight average | 19,000 | 200,000 | 250,000 |
| molecular weight Mw | | | |
| Molecular weight | 1.4 | 1.6 | 1.7 |
| distribution Mw/Mn | | | |
| Residual monomer | 14,000 | 8,700 | 8,600 |
| (ppm by mass) | | | |
| YI value | 4 | 1 | 1 |
| Impact strength | C | C | C |
| Addition of catalyst | Before | After | After |

<Batch Type, Ethylene Carbonate, Organic Molecule Catalyst, without Organic Solvent - - - 1>

TABLE 4-7

| | Ex. 1-4-28 | Ex. 1-4-29 | Ex. 1-4-30 |
|---|---|---|---|
| Kind of monomer | Ethylene | Ethylene | Ethylene |
| | carbonate | carbonate | carbonate |
| Catalyst | DBU | DBU | DBU |
| Kind of initiator | Lauryl | Lauryl | Lauryl |
| | alcohol | alcohol | alcohol |
| Amount of initiator | 0.5 | 0.5 | 0.5 |
| (mol %) | | | |
| Pressure (MPa) | 35 | 65 | 65 |
| Temperature (° C.) | 80 | 50 | 50 |
| Polymerization density | 788.97 | 1007.59 | 1007.59 |
| (kg/m³) | | | |
| Reaction time (min) | 15 | 15 | 30 |
| R/(C + R) | 0.99 | 0.98 | 0.26 |
| Weight average | 35,000 | 210,000 | 260,000 |
| molecular weight Mw | | | |
| Molecular weight | 1.2 | 1.6 | 1.5 |
| distribution Mw/Mn | | | |
| Residual monomer | 16,000 | 8,400 | 5,000 |
| (ppm by mass) | | | |
| YI value | 6 | 1 | 3 |
| Impact strength | C | C | C |
| Addition of catalyst | Before | After | After |

### Example 1-5-1

The polymer product of Example 1-5-1 was produced in the same manner as Example 1-1-1, except that a polymerization reaction apparatus 500 shown in FIG. 8 was used, and the monomer used in Example 1-1-1 was changed to a first monomer and a second monomer. The polymerization reaction apparatus 500 shown in FIG. 8 is the same as the polymerization reaction apparatus 400 shown in FIG. 7, except that it includes a tube 230 provided with an adding pot 225, valves (223, 224, 226, 229), and joints (230a, 230b).

As for how to add the catalyst, when adding the catalyst beforehand, the ring-opening-polymerizable monomer, the initiator, and the catalyst were put in the reaction vessel 127 from the start and reacted therein. When adding the catalyst afterwards, the ring-opening-polymerizable monomer and the initiator were put in the reaction vessel 127 and mixed therein, and after this, the catalyst was put therein and reacted. The pressure was controlled by changing the flow rate of the pump.

The characteristics of the polymer product of Example 1-5-1 thus obtained were evaluated in the same manner as Example 1-1-1. The results are shown in Table 5-1.

### Examples 1-5-2 to 1-5-15

The polymer products of Examples 1-5-2 to 1-5-15 were produced in the same manner as Example 1-5-1, except that at least any of the kind of the monomer, polymerization pressure, polymerization reaction temperature, density, reaction time, and mixing ratio [raw materials/(compressive fluid+raw materials)] used in Example 1-5-1 was changed as shown in Tables 5-1 to 5-4 below. As for how to add the catalyst, when adding the catalyst beforehand, the ring-opening-polymerizable monomer, the initiator, and the catalyst were put in the reaction vessel 127 from the start and reacted therein. When adding the catalyst afterwards, the ring-opening-polymerizable monomer and the initiator were put in the reaction vessel 127 and mixed therein, and after this, the catalyst was put therein and reacted. The pressure was controlled by changing the flow rate of the pump.

The characteristics of each of the polymer products thus obtained were evaluated in the same manner as Example 1-1-1. The results are shown in Tables 5-1 to 5-4.

<Batch Type, Copolymer of L-Lactide and D-Lactide, Metal Catalyst, with Organic Solvent>

TABLE 5-1

| | Ex. 1-5-1 | Ex. 1-5-2 | Ex. 1-5-3 | Ex. 1-5-4 |
|---|---|---|---|---|
| First monomer | L-lactide | L-lactide | L-lactide | L-lactide |
| Second monomer | D-lactide | D-lactide | D-lactide | D-lactide |
| Catalyst | Tin octylate | Tin octylate | Tin octylate | Tin octylate |
| Kind of initiator | Lauryl | Lauryl | Lauryl | Lauryl |
| | alcohol | alcohol | alcohol | alcohol |
| Amount of initiator | 0.5 | 0.5 | 0.2 | 0.2 |
| (mol %) | | | | |
| Organic solvent | Toluene | Toluene | Toluene | Toluene |
| | (1 mol %) | (1 mol %) | (1 mol %) | (1 mol %) |
| First polymerization | 65 | 65 | 65 | 65 |
| pressure (MPa) | | | | |
| First polymerization | 50 | 50 | 50 | 50 |
| temperature (° C.) | | | | |
| First polymerization | 1007.59 | 1007.59 | 1007.59 | 1007.59 |
| density (kg/m³) | | | | |
| First polymerization | 15 | 30 | 60 | 90 |
| reaction time (min) | | | | |
| R/(C + R) | 0.88 | 0.88 | 0.88 | 0.88 |
| in first polymerization | | | | |
| Second polymerization | 65 | 65 | 65 | 65 |
| pressure (MPa) | | | | |
| Second polymerization | 50 | 50 | 50 | 50 |
| temperature (° C.) | | | | |
| Second polymerization | 1007.59 | 1007.59 | 1007.59 | 1007.59 |
| density (kg/m³) | | | | |
| Second polymerization | 15 | 30 | 60 | 90 |
| reaction time (min) | | | | |
| R/(C + R) | 0.88 | 0.88 | 0.88 | 0.88 |
| in second polymerization | | | | |
| Weight average | 130,000 | 270,000 | 510,000 | 560,000 |
| molecular weight Mw | | | | |
| Molecular weight | 1.5 | 1.6 | 1.5 | 1.4 |
| distribution Mw/Mn | | | | |
| Residual monomer | 8,000 | 8,700 | 10,000 | 1,500 |
| (ppm by mass) | | | | |
| YI value | 2 | 2 | 13 | 10 |
| Impact strength | C | C | A | A |
| Addition of catalyst | Before | After | Before | Before |

<Batch Type, Copolymer of ε-Caprolactone and L-lactide, Metal Catalyst, with Organic Solvent>

TABLE 5-2

| | Ex. 1-5-5 | Ex. 1-5-6 | Ex. 1-5-7 | Ex. 1-5-8 |
|---|---|---|---|---|
| First monomer | ε- | ε- | ε- | ε- |
| | caprolactone | caprolactone | caprolactone | caprolactone |
| Second monomer | L-lactide | L-lactide | L-lactide | L-lactide |
| Catalyst | Tin octylate | Tin octylate | Tin octylate | Tin octylate |
| Kind of initiator | Lauryl | Lauryl | Lauryl | Lauryl |
| | alcohol | alcohol | alcohol | alcohol |
| Amount of initiator | 0.5 | 0.5 | 0.2 | 0.2 |
| (mol %) | | | | |
| Organic solvent | Toluene | Toluene | Toluene | Toluene |
| | (1 mol %) | (1 mol %) | (1 mol %) | (1 mol %) |
| First polymerization | 65 | 65 | 65 | 65 |
| pressure (MPa) | | | | |
| First polymerization | 50 | 50 | 50 | 50 |
| temperature (° C.) | | | | |
| First polymerization | 1007.59 | 1007.59 | 1007.59 | 1007.59 |
| density (kg/m³) | | | | |
| First polymerization | 15 | 30 | 60 | 90 |
| reaction time (min) | | | | |
| R/(C + R) | 0.95 | 0.95 | 0.95 | 0.95 |
| in first polymerization | | | | |
| Second polymerization | 65 | 65 | 65 | 65 |
| pressure (MPa) | | | | |
| Second polymerization | 50 | 50 | 50 | 50 |
| temperature (° C.) | | | | |
| Second polymerization | 1007.59 | 1007.59 | 1007.59 | 1007.59 |
| density (kg/m³) | | | | |
| Second polymerization | 15 | 30 | 60 | 90 |
| reaction time (min) | | | | |
| R/(C + R) | 0.88 | 0.88 | 0.88 | 0.88 |
| in second polymerization | | | | |
| Weight average | 200,000 | 280,000 | 340,000 | 580,000 |
| molecular weight Mw | | | | |
| Molecular weight | 1.8 | 1.6 | 1.4 | 1.5 |
| distribution Mw/Mn | | | | |
| Residual monomer | 8,600 | 2,500 | 7,700 | 2,000 |
| (ppm by mass) | | | | |
| YI value | 3 | 2 | 12 | 13 |
| Impact strength | C | C | B | A |
| Addition of catalyst | Before | After | Before | After |

<Batch Type, Copolymer of L-lactide and Another Monomer, Metal Catalyst, with Organic Solvent - - - 1>

TABLE 5-3

| | Ex. 1-5-9 | Ex. 1-5-10 | Ex. 1-5-11 | Ex. 1-5-12 |
|---|---|---|---|---|
| First monomer | L-lactide | p- | L-lactide | L-lactide |
| | | dioxanone | | |
| Second monomer | Glycolide | L-lactide | Ethylene | Propylene |
| | | | carbonate | carbonate |
| Catalyst | Tin octylate | Tin octylate | Tin octylate | Tin octylate |
| Kind of initiator | Lauryl | Lauryl | Lauryl | Lauryl |
| | alcohol | alcohol | alcohol | alcohol |
| Amount of initiator | 0.2 | 0.2 | 0.2 | 0.2 |
| (mol %) | | | | |
| Organic solvent | Toluene | Toluene | Toluene | Toluene |
| | (1 mol %) | (1 mol %) | (1 mol %) | (1 mol %) |
| First polymerization | 65 | 35 | 65 | 65 |
| pressure (MPa) | | | | |
| First polymerization | 50 | 120 | 50 | 50 |
| temperature (° C.) | | | | |
| First polymerization | 1007.59 | 837.31 | 1007.59 | 1007.59 |
| density (kg/m³) | | | | |
| First polymerization | 90 | 60 | 90 | 90 |
| reaction time (min) | | | | |
| R/(C + R) | 0.88 | 0.95 | 0.88 | 0.88 |
| in first polymerization | | | | |
| Second polymerization | 65 | 65 | 65 | 65 |
| pressure (MPa) | | | | |
| Second polymerization | 50 | 50 | 50 | 50 |
| temperature (° C.) | | | | |
| Second polymerization | 1007.59 | 1007.59 | 1007.59 | 1007.59 |
| density (kg/m³) | | | | |
| Second polymerization | 90 | 90 | 90 | 90 |
| reaction time (min) | | | | |
| R/(C + R) | 0.79 | 0.88 | 0.98 | 0.98 |
| in second polymerization | | | | |
| Weight average | 550,000 | 530,000 | 560,000 | 550,000 |
| molecular weight Mw | | | | |
| Molecular weight | 1.5 | 1.4 | 1.3 | 1.7 |
| distribution Mw/Mn | | | | |
| Residual monomer | 1,500 | 900 | 1,000 | 1,500 |
| (ppm by mass) | | | | |
| YI value | 12 | 11 | 11 | 10 |
| Impact strength | A | A | A | A |
| Addition of catalyst | Before | Before | After | After |

<Batch Type, Copolymer of L-lactide and Another Monomer, Metal Catalyst, with Organic Solvent - - - 2>

TABLE 5-4

| | Ex. 1-5-13 | Ex. 1-5-14 | Ex. 1-5-15 |
|---|---|---|---|
| First monomer | L-lactide | ε- | ε- |
| | | caprolactone | caprolactone |
| Second monomer | Trimethylene | Ethylene | Propylene |
| | carbonate | carbonate | carbonate |
| Catalyst | Tin octylate | Tin octylate | Tin octylate |
| Kind of initiator | Lauryl | Lauryl | Lauryl |
| | alcohol | alcohol | alcohol |
| Amount of initiator | 0.2 | 0.2 | 0.2 |
| (mol %) | | | |
| Organic solvent | Toluene | Toluene | Toluene |
| | (1 mol %) | (1 mol %) | (1 mol %) |
| First polymerization | 65 | 65 | 65 |
| pressure (MPa) | | | |
| First polymerization | 50 | 50 | 50 |
| temperature (° C.) | | | |
| First polymerization | 1007.59 | 1007.59 | 1007.59 |
| density (kg/m³) | | | |
| First polymerization | 90 | 90 | 90 |
| reaction time (min) | | | |
| R/(C + R) | 0.88 | 0.95 | 0.95 |
| in first polymerization | | | |
| Second polymerization | 65 | 65 | 65 |
| pressure (MPa) | | | |
| Second polymerization | 50 | 50 | 50 |
| temperature (° C.) | | | |
| Second polymerization | 1007.59 | 1007.59 | 1007.59 |
| density (kg/m³) | | | |
| Second polymerization | 90 | 90 | 90 |
| reaction time (min) | | | |
| R/(C + R) | 0.98 | 0.98 | 0.98 |
| in second polymerization | | | |
| Weight average | 540,000 | 570,000 | 550,000 |
| molecular weight Mw | | | |
| Molecular weight | 1.5 | 1.4 | 1.5 |
| distribution Mw/Mn | | | |
| Residual monomer | 900 | 1,200 | 2,000 |
| (ppm by mass) | | | |
| YI value | 9 | 13 | 10 |
| Impact strength | A | A | A |
| Addition of catalyst | After | Before | After |

### Examples 1-6-1 to 1-6-13

The polymer products of Examples 1-6-1 to 1-6-13 were produced in the same manner as Example 1-5-1, except that at least any of the kind of the monomer, polymerization pressure, polymerization reaction temperature, density, reaction time, and mixing ratio [raw materials/(compressive fluid+raw materials)] used in Example 1-5-1 was changed as shown in Tables 6-1 to 6-3 below. As for how to add the catalyst, when adding the catalyst beforehand, the ring-opening-polymerizable monomer, the initiator, and the catalyst were put in the reaction vessel 127 from the start and reacted therein. When adding the catalyst afterwards, the ring-opening-polymerizable monomer and the initiator were put in the reaction vessel 127 and mixed therein, and after this, the catalyst was put therein and reacted. The pressure was controlled by changing the flow rate of the pump.

The characteristics of each of the polymer products thus obtained were evaluated in the same manner as Example 1-1-1. The results are shown in Tables 6-1 to 6-3.

<Bath Type, Copolymer of L-Lactide and D-Lactide, Metal Catalyst, without Organic Solvent>

TABLE 6-1

| | Ex. 1-6-1 | Ex. 1-6-2 | Ex. 1-6-3 | Ex. 1-6-4 |
|---|---|---|---|---|
| First monomer | L-lactide | L-lactide | L-lactide | L-lactide |
| Second monomer | D-lactide | D-lactide | D-lactide | D-lactide |
| Catalyst | Tin octylate | Tin octylate | Tin octylate | Tin octylate |
| Kind of initiator | Lauryl | Lauryl | Lauryl | Lauryl |
| | alcohol | alcohol | alcohol | alcohol |
| Amount of initiator | 0.5 | 0.5 | 0.2 | 0.2 |
| (mol %) | | | | |
| First polymerization | 65 | 65 | 65 | 65 |
| pressure (MPa) | | | | |
| First polymerization | 50 | 50 | 50 | 50 |
| temperature (° C.) | | | | |
| First polymerization | 1007.59 | 1007.59 | 1007.59 | 1007.59 |
| density (kg/m³) | | | | |
| First polymerization | 15 | 30 | 60 | 90 |
| reaction time (min) | | | | |
| R/(C + R) | 0.88 | 0.88 | 0.88 | 0.88 |
| in first polymerization | | | | |
| Second polymerization | 65 | 65 | 65 | 65 |
| pressure (MPa) | | | | |
| Second polymerization | 50 | 50 | 50 | 50 |
| temperature (° C.) | | | | |
| Second polymerization | 1007.59 | 1007.59 | 1007.59 | 1007.59 |
| density (kg/m³) | | | | |
| Second polymerization | 15 | 30 | 60 | 90 |
| reaction time (min) | | | | |
| R/(C + R) | 0.88 | 0.88 | 0.88 | 0.88 |
| in second polymerization | | | | |
| Weight average | 170,000 | 255,000 | 510,000 | 530,000 |
| molecular weight Mw | | | | |
| Molecular weight | 1.6 | 1.6 | 1.5 | 1.4 |
| distribution Mw/Mn | | | | |
| Residual monomer | 8,000 | 8,700 | 10,000 | 1,500 |
| (ppm by mass) | | | | |
| YI value | 3 | 2 | 10 | 12 |
| Impact strength | C | C | A | A |
| Addition of catalyst | Before | After | Before | Before |

<Batch Type, Copolymer of ε-Caprolactone and L-lactide, Metal Catalyst, without Organic Solvent>

TABLE 6-2

| | Ex. 1-6-5 | Ex. 1-6-6 | Ex. 1-6-7 | Ex. 1-6-8 |
|---|---|---|---|---|
| First monomer | ε- | ε- | ε- | ε- |
| | caprolactone | caprolactone | caprolactone | caprolactone |
| Second monomer | L-lactide | L-lactide | L-lactide | L-lactide |
| Catalyst | Tin octylate | Tin octylate | Tin octylate | Tin octylate |
| Kind of initiator | Lauryl | Lauryl | Lauryl | Lauryl |
| | alcohol | alcohol | alcohol | alcohol |
| Amount of initiator | 0.5 | 0.5 | 0.2 | 0.2 |
| (mol %) | | | | |
| First polymerization | 65 | 65 | 65 | 65 |
| pressure (MPa) | | | | |
| First polymerization | 50 | 50 | 50 | 50 |
| temperature (° C.) | | | | |
| First polymerization | 1007.59 | 1007.59 | 1007.59 | 1007.59 |
| density (kg/m³) | | | | |
| First polymerization | 15 | 30 | 120 | 120 |
| reaction time (min) | | | | |
| R/(C + R) | 0.95 | 0.95 | 0.95 | 0.95 |
| in first polymerization | | | | |
| Second polymerization | 65 | 65 | 65 | 65 |
| pressure (MPa) | | | | |
| Second polymerization | 50 | 50 | 50 | 50 |
| temperature (° C.) | | | | |
| Second polymerization | 1007.59 | 1007.59 | 1007.59 | 1007.59 |
| density (kg/m³) | | | | |
| Second polymerization | 15 | 30 | 120 | 120 |
| reaction time (min) | | | | |
| R/(C + R) | 0.88 | 0.88 | 0.88 | 0.88 |
| in second polymerization | | | | |
| Weight average | 200,000 | 290,000 | 440,000 | 580,000 |
| molecular weight Mw | | | | |
| Molecular weight | 1.6 | 1.6 | 1.5 | 1.5 |
| distribution Mw/Mn | | | | |
| Residual monomer | 16,000 | 2,100 | 9,900 | 1,700 |
| (ppm by mass) | | | | |
| YI value | 1 | 2 | 11 | 10 |
| Impact strength | C | C | A | A |
| Addition of catalyst | Before | After | Before | After |

<Batch Type, Copolymer of L-Lactide and Another Monomer, Metal Catalyst, without Organic Solvent>

TABLE 6-3

| | Ex. 1-6-9 | Ex. 1-6-10 | Ex. 1-6-11 | Ex. 1-6-12 | Ex. 1-6-13 |
|---|---|---|---|---|---|
| First monomer | L-lactide | p- | L-lactide | L-lactide | ε- |
| | | dioxanone | | | caprolactone |
| Second monomer | Glycolide | L-lactide | Ethylene | Propylene | Propylene |
| | | | carbonate | carbonate | carbonate |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| First polymerization | 65 | 65 | 65 | 65 | 65 |
| pressure (MPa) | | | | | |
| First polymerization | 50 | 120 | 50 | 50 | 50 |
| temperature (° C.) | | | | | |
| First polymerization | 1007.59 | 837.31 | 1007.59 | 1007.59 | 1007.59 |
| density (kg/m³) | | | | | |
| First polymerization | 30 | 30 | 30 | 30 | 30 |
| reaction time (min) | | | | | |
| R/(C + R) | 0.88 | 0.95 | 0.88 | 0.88 | 0.95 |
| in first polymerization | | | | | |
| Second polymerization | 65 | 65 | 65 | 65 | 65 |
| pressure (MPa) | | | | | |
| Second polymerization | 50 | 50 | 50 | 50 | 50 |
| temperature (° C.) | | | | | |
| Second polymerization | 1007.59 | 1007.59 | 1007.59 | 1007.59 | 1007.59 |
| density (kg/m³) | | | | | |
| Second polymerization | 30 | 30 | 30 | 30 | 30 |
| reaction time (min) | | | | | |
| R/(C + R) | 0.79 | 0.88 | 0.98 | 0.98 | 0.98 |
| in second polymerization | | | | | |
| Weight average | 260,000 | 260,000 | 250,000 | 280,000 | 250,000 |
| molecular weight Mw | | | | | |
| Molecular weight | 1.6 | 1.4 | 1.6 | 1.5 | 1.6 |
| distribution Mw/Mn | | | | | |
| Residual monomer | 4700 | 1800 | 1400 | 2000 | 3500 |
| (ppm by mass) | | | | | |
| YI value | 3 | 2 | 2 | 4 | 3 |
| Impact strength | C | C | C | C | C |
| Addition of catalyst | After | After | After | After | After |

### Examples 1-7-1 to 1-7-7

The polymer products of Examples 1-7-1 to 1-7-7 were produced in the same manner as Example 1-5-1, except that at least any of the kind of the monomer, polymerization pressure, polymerization reaction temperature, density, reaction time, and mixing ratio [raw materials/(compressive fluid+raw materials)] used in Example 1-5-1 was changed as shown in Tables 7-1 and 7-2 below. As for how to add the catalyst, when adding the catalyst beforehand, the ring-opening-polymerizable monomer, the initiator, and the catalyst were put in the reaction vessel 127 from the start and reacted therein. When adding the catalyst afterwards, the ring-opening-polymerizable monomer and the initiator were put in the reaction vessel 127 and mixed therein, and after this, the catalyst was put therein and reacted. The pressure was controlled by changing the flow rate of the pump.

The characteristics of each of the polymer products thus obtained were evaluated in the same manner as Example 1-1-1. The results are shown in Tables 7-1 and 7-2.

<Batch Type, Copolymer of L-Lactide and D-Lactide, Organic Molecule Catalyst, with Organic Solvent>

TABLE 7-1

| | Ex. 1-7-1 | Ex. 1-7-2 | Ex. 1-7-3 | Ex. 1-7-4 |
|---|---|---|---|---|
| First monomer | L-lactide | L-lactide | L-lactide | L-lactide |
| Second monomer | D-lactide | D-lactide | D-lactide | D-lactide |
| Catalyst | DBU | DBU | DBU | DBU |
| Kind of initiator | Lauryl | Lauryl | Lauryl | Lauryl |
| | alcohol | alcohol | alcohol | alcohol |
| Amount of initiator | 0.5 | 0.5 | 0.2 | 0.2 |
| (mol %) | | | | |
| Organic solvent | Toluene | Toluene | Toluene | Toluene |
| | (1 mol %) | (1 mol %) | (1 mol %) | (1 mol %) |
| First polymerization | 65 | 65 | 65 | 65 |
| pressure (MPa) | | | | |
| First polymerization | 50 | 50 | 50 | 50 |
| temperature (° C.) | | | | |
| First polymerization | 1007.59 | 1007.59 | 1007.59 | 1007.59 |
| density (kg/m³) | | | | |
| First polymerization | 15 | 30 | 60 | 90 |
| reaction time (min) | | | | |
| R/(C + R) | 0.88 | 0.88 | 0.88 | 0.88 |
| in first polymerization | | | | |
| Second polymerization | 65 | 65 | 65 | 65 |
| pressure (MPa) | | | | |
| Second polymerization | 50 | 50 | 50 | 50 |
| temperature (° C.) | | | | |
| Second polymerization | 1007.59 | 1007.59 | 1007.59 | 1007.59 |
| density (kg/m³) | | | | |
| Second polymerization | 15 | 30 | 60 | 90 |
| reaction time (min) | | | | |
| R/(C + R) | 0.88 | 0.88 | 0.88 | 0.88 |
| in second polymerization | | | | |
| Weight average | 170,000 | 260,000 | 500,000 | 540,000 |
| molecular weight Mw | | | | |
| Molecular weight | 1.6 | 1.6 | 1.5 | 1.4 |
| distribution Mw/Mn | | | | |
| Residual monomer | 8,000 | 8,700 | 10,000 | 1,500 |
| (ppm by mass) | | | | |
| YI value | 1 | 4 | 13 | 14 |
| Impact strength | C | C | A | A |
| Addition of catalyst | Before | After | Before | Before |

<Batch Type, Copolymer of ε-Caprolactone and L-lactide, Organic Molecule Catalyst, with Organic Solvent>

TABLE 7-2

| | Ex. 1-7-5 | Ex. 1-7-6 | Ex. 1-7-7 |
|---|---|---|---|
| First monomer | ε-caprolactone | ε-caprolactone | ε-caprolactone |
| Second monomer | L-lactide | L-lactide | L-lactide |
| Catalyst | TBD | TBD | TBD |
| Kind of initiator | Lauryl | Lauryl | Lauryl |
| | alcohol | alcohol | alcohol |
| Amount of initiator | 0.5 | 0.5 | 0.2 |
| (mol %) | | | |
| Organic solvent | Toluene | Toluene | Toluene |
| | (1 mol %) | (1 mol %) | (1 mol %) |
| First polymerization | 65 | 65 | 65 |
| pressure (MPa) | | | |
| First polymerization | 50 | 50 | 50 |
| temperature (° C.) | | | |
| First polymerization | 1007.59 | 1007.59 | 1007.59 |
| density (kg/m³) | | | |
| First polymerization | 15 | 30 | 60 |
| reaction time (min) | | | |
| R/(C + R) | 0.95 | 0.95 | 0.95 |
| in first polymerization | | | |
| Second polymerization | 65 | 65 | 65 |
| pressure (MPa) | | | |
| Second polymerization | 50 | 50 | 50 |
| temperature (° C.) | | | |
| Second polymerization | 1007.59 | 1007.59 | 1007.59 |
| density (kg/m³) | | | |
| Second polymerization | 15 | 30 | 60 |
| reaction time (min) | | | |
| R/(C + R) in | 0.88 | 0.88 | 0.88 |
| second polymerization | | | |
| Weight average | 200,000 | 230,000 | 240,000 |
| molecular weight Mw | | | |
| Molecular weight | 1.6 | 1.6 | 1.5 |
| distribution Mw/Mn | | | |
| Residual monomer | 18,000 | 3,500 | 10,000 |
| (ppm by mass) | | | |
| YI value | 2 | 2 | 3 |
| Impact strength | C | C | C |
| Addition of catalyst | Before | After | Before |

### Examples 1-8-1 to 1-8-6

The polymer products of Examples 1-8-1 to 1-8-6 were produced in the same manner as Example 1-5-1, except that at least any of the kind of the monomer, polymerization pressure, polymerization reaction temperature, density, reaction time, and mixing ratio [raw materials/(compressive fluid+raw materials)] used in Example 1-5-1 was changed as shown in Tables 8-1 and 8-2 below. As for how to add the catalyst, when adding the catalyst beforehand, the ring-opening-polymerizable monomer, the initiator, and the catalyst were put in the reaction vessel 127 from the start and reacted therein. When adding the catalyst afterwards, the ring-opening-polymerizable monomer and the initiator were put in the reaction vessel 127 and mixed therein, and after this, the catalyst was put therein and reacted. The pressure was controlled by changing the flow rate of the pump.

The characteristics of each of the polymer products thus obtained were evaluated in the same manner as Example 1-1-1. The results are shown in Tables 8-1 and 8-2.

<Batch Type, Copolymer of L-Lactide and D-Lactide, Organic Molecule Catalyst, without Organic Solvent>

TABLE 8-1

| | Ex. 1-8-1 | Ex. 1-8-2 | Ex. 1-8-3 |
|---|---|---|---|
| First monomer | L-lactide | L-lactide | L-lactide |
| Second monomer | D-lactide | D-lactide | D-lactide |
| Catalyst | DBU | DBU | DBU |
| Kind of initiator | Lauryl | Lauryl | Lauryl |
| | alcohol | alcohol | alcohol |
| Amount of initiator | 0.5 | 0.5 | 0.2 |
| (mol %) | | | |
| First polymerization | 65 | 65 | 65 |
| pressure (MPa) | | | |
| First polymerization | 50 | 50 | 50 |
| temperature (° C.) | | | |
| First polymerization | 1007.59 | 1007.59 | 1007.59 |
| density (kg/m³) | | | |
| First polymerization | 15 | 30 | 60 |
| reaction time (min) | | | |
| R/(C + R) | 0.88 | 0.88 | 0.88 |
| in first polymerization | | | |
| Second polymerization | 65 | 65 | 65 |
| pressure (MPa) | | | |
| Second polymerization | 50 | 50 | 50 |
| temperature (° C.) | | | |
| Second polymerization | 1007.59 | 1007.59 | 1007.59 |
| density (kg/m³) | | | |
| Second polymerization | 15 | 30 | 60 |
| reaction time (min) | | | |
| R/(C + R) | 0.88 | 0.88 | 0.88 |
| in second polymerization | | | |
| Weight average | 185,000 | 250,000 | 270,000 |
| molecular weight Mw | | | |
| Molecular weight | 1.6 | 1.6 | 1.5 |
| distribution Mw/Mn | | | |
| Residual monomer | 15,000 | 1,200 | 9,000 |
| (ppm by mass) | | | |
| YI value | 2 | 1 | 2 |
| Impact strength | C | C | C |
| Addition of catalyst | Before | After | Before |

<Batch Type, Copolymer of ε-Caprolactone and L-Lactide, Organic Molecule Catalyst, without Organic Solvent>

TABLE 8-2

| | Ex. 1-8-4 | Ex. 1-8-5 | Ex. 1-8-6 |
|---|---|---|---|
| First monomer | ε-caprolactone | ε-caprolactone | ε-caprolactone |
| Second monomer | L-lactide | L-lactide | L-lactide |
| Catalyst | TBD | TBD | TBD |
| Kind of initiator | Lauryl | Lauryl | Lauryl |
| | alcohol | alcohol | alcohol |
| Amount of initiator | 0.5 | 0.5 | 0.2 |
| (mol %) | | | |
| First polymerization | 65 | 65 | 65 |
| pressure (MPa) | | | |
| First polymerization | 50 | 50 | 50 |
| temperature (° C.) | | | |
| First polymerization | 1007.59 | 1007.59 | 1007.59 |
| density (kg/m³) | | | |
| First polymerization | 15 | 30 | 60 |
| reaction time (min) | | | |
| R/(C + R) | 0.95 | 0.95 | 0.95 |
| in first polymerization | | | |
| Second polymerization | 65 | 65 | 65 |
| pressure (MPa) | | | |
| Second polymerization | 50 | 50 | 50 |
| temperature (° C.) | | | |
| Second polymerization | 1007.59 | 1007.59 | 1007.59 |
| density (kg/m³) | | | |
| Second polymerization | 15 | 30 | 60 |
| reaction time (min) | | | |
| R/(C + R) in | 0.88 | 0.88 | 0.88 |
| second polymerization | | | |
| Weight average | 200,000 | 230,000 | 240,000 |
| molecular weight Mw | | | |
| Molecular weight | 1.6 | 1.6 | 1.5 |
| distribution Mw/Mn | | | |
| Residual monomer | 15,000 | 3,500 | 10,000 |
| (ppm by mass) | | | |
| YI value | 3 | 2 | 2 |
| Impact strength | C | C | C |
| Addition of catalyst | Before | After | Before |

### Example 2-1-1

Ring-opening polymerization of a mixture of L-lactide and D-lactide (with a mass ratio of 90/10) was performed under the conditions shown in Table 9-1, with the polymerization reaction apparatus 100 shown in FIG. 3. The configuration of the polymerization reaction apparatus 100 is described below.

### —Tank 1, Gauge Feeder 2:

Plunger pump NP-S462 manufactured by Nihon Seimitsu Co., Ltd. The tank 1 was filled with molten lactide (a mixture of L-lactide and D-lactide (with a mass ratio of 90/10, manufactured by Pulac Inc., having a melting point of 100° C.) as the ring-opening-polymerizable monomer.

### —Tank 3, Gauge Feeder 4:

Intelligent HPLC pump (PU-2080) manufactured by Jasco Corporation. The tank 3 was filled with lauryl alcohol as the initiator.

### —Tank 5, Gauge Pump 6:

Not used in the present Example.

### —Tank 7:

Carbonic acid gas cylinder

### —Tank 11, Gauge Pump 12:

Intelligent HPLC pump (PU-2080) manufactured by Jasco Corporation. The tank 11 was filled with tin octylate as the catalyst.

### —Contact Region 9:

Biaxial stirrer equipped with screws meshing with each other

Cylinder inner diameter of 30 mm

Cylinder set temperature of 100° C.

The same direction of rotation for both of the two axes

Rotation speed of 30 rpm

### —Reacting Region 13:

Biaxial kneader

Cylinder inner diameter of 40 mm

Cylinder set temperature of 100° C. at the raw materials supply portion and 80° C. at the leading end portion

The same direction of rotation for both of the two axes

Rotation speed of 60 rpm

The biaxial stirrer of the contact region 9 and the biaxial kneader of the reacting region 13 were actuated under the setting conditions described above. The gauge feeder 2 volumetrically fed the molten lactide in the tank 1 into the container of the biaxial stirrer. The gauge feeder 4 volumetrically fed the lauryl alcohol in the tank 3 into the container of the biaxial stirrer in an amount of 0.5 mol (0.5 mol %) relative to the feeding amount of the lactide of 99.5 mol. The gauge pump 8 fed the carbonic acid gas (carbon dioxide) as the compressive fluid in the tank 7 such that the pressure inside the container of the biaxial stirrer would be 15 MPa. As a result, the biaxial stirrer brought the raw materials, namely lactide and lauryl alcohol and the compressive fluid supplied from the tanks (1, 3, 7) into contact with one another serially and mixed them with the screws to thereby melt the raw materials.

The raw materials melted in the contact region 9 were conveyed by the liquid conveying pump 10 to the reacting region 13. The gauge pump 12 fed tin octylate as the catalyst in the tank 11 to the raw material feeding port of the biaxial kneader as the reacting region 13 in an amount of 1 mol (1 mol %) relative to 99 mol of lactide. The biaxial kneader mixed the raw materials conveyed by the liquid conveying pump 10 with the tin octylate fed by the gauge pump 12 to thereby ring-opening polymerize the lactide. In this case, the average retention time of the raw materials in the biaxial kneader was about 1,200 seconds. The leading end of the biaxial kneader was fitted with the gauge pump 14 and the extruding cap 15. The conveying rate at which the gauge pump 14 conveyed the polymer (polylactic acid) as the resulting product was 200 g/min.

The characteristics of the polymer product of Example 2-1-1 thus obtained were evaluated in the same manner as Example 1-1-1. The results are shown in Table 9-1.

### Examples 2-1-2 to 2-1-22

The polymer products of Examples 2-1-2 to 2-1-22 were produced in the same manner as Example 2-1-1, except that at least any of the kind of the monomer, polymerization pressure, polymerization reaction temperature, density, reaction time, and mixing ratio [raw materials/(compressive fluid+raw materials)] used in Example 2-1-1 was changed as shown in Tables 9-1 to 9-5 below. As for how to add the catalyst, when adding the catalyst beforehand, the ring-opening-polymerizable monomer, the initiator, and the catalyst were put in the reacting region 13 from the start and reacted therein. When adding the catalyst afterwards, the ring-opening-polymerizable monomer and the initiator were put in the reacting region 13 and mixed therein, and after this, the catalyst was put therein and reacted. The pressure was controlled by changing the flow rate of the pump.

The characteristics of each of the polymer products thus obtained were evaluated in the same manner as Example 1-1-1. The results are shown in Tables 9-1 to 9-5.

<Serial Type, Monomer Kind Homo, Metal Catalyst, with Organic Solvent - - - 1>

TABLE 9-1

| | Ex. 2-1-1 | Ex. 2-1-2 | Ex. 2-1-3 | Ex. 2-1-4 |
|---|---|---|---|---|
| Kind of monomer | Lactide | Lactide | ε-caprolactone | Ethylene |
| | | | | carbonate |
| Catalyst | Tin octylate | Tin octylate | Tin octylate | Tin octylate |
| Kind of initiator | Lauryl | Lauryl | Lauryl | Lauryl |
| | alcohol | alcohol | alcohol | alcohol |
| Amount of initiator | 0.5 | 0.2 | 0.2 | 0.2 |
| (mol %) | | | | |
| Organic solvent | Toluene | Toluene | Toluene | Toluene |
| | (1 mol %) | (1 mol %) | (1 mol %) | (1 mol %) |
| Pressure (MPa) | 35 | 50 | 35 | 35 |
| Temperature (° C.) | 180 | 180 | 120 | 180 |
| Polymerization density | 484.29 | 619.61 | 645.54 | 484.29 |
| (kg/m³) | | | | |
| Reaction time (min) | 15 | 20 | 20 | 20 |
| R/(C + R) | 0.94 | 0.94 | 0.96 | 0.99 |
| Weight average | 120,000 | 370,000 | 410,000 | 390,000 |
| molecular weight Mw | | | | |
| Molecular weight | 1.3 | 1.8 | 1.8 | 1.5 |
| distribution Mw/Mn | | | | |
| Residual monomer | 8,500 | 9,500 | 5,500 | 4,500 |
| (ppm by mass) | | | | |
| YI value | 6 | 13 | 4 | 12 |
| Impact strength | C | A | B | B |
| Addition of catalyst | After | After | Before | Before |
| Optical purity (%) | 90.2 | 95.8 | 91.4 | 90.6 |

<Serial Type, Monomer Kind Homo, Metal Catalyst, without Organic Solvent - - - 1>

TABLE 9-2

| | Ex. 2-1-5 | Ex. 2-1-6 | Ex. 2-1-7 | Ex. 2-1-8 | Ex. 2-1-9 |
|---|---|---|---|---|---|
| Kind of monomer | Lactide | ε- | Ethylene | Glycolide | p- |
| | | caprolactone | carbonate | | dioxanone |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.2 | 0.2 | 0.2 | 0.2 | 0.2 |
| (mol %) | | | | | |
| Pressure (MPa) | 50 | 35 | 35 | 65 | 65 |
| Temperature (° C.) | 180 | 120 | 180 | 50 | 120 |
| Polymerization density | 619.61 | 645.54 | 484.29 | 1007.59 | 837.31 |
| (kg/m3) | | | | | |
| Reaction time (min) | 30 | 30 | 30 | 30 | 30 |
| R/(C + R) | 0.92 | 0.96 | 0.99 | 0.79 | 0.95 |
| Weight average | 385,000 | 420,000 | 400,000 | 590,000 | 590,000 |
| molecular weight Mw | | | | | |
| Molecular weight | 1.4 | 1.7 | 1.5 | 1.4 | 1.5 |
| distribution Mw/Mn | | | | | |
| Residual monomer | 7,700 | 5,000 | 7,500 | 1,100 | 2,000 |
| (ppm by mass) | | | | | |
| YI value | 8 | 9 | 7 | 13 | 10 |
| Impact strength | A | A | A | A | A |
| Addition of catalyst | After | After | After | Before | After |
| Optical purity (%) | 96.2 | 90.7 | 91.3 | 99.5 | 99.6 |

<Serial Type, Monomer Kind Homo, Metal Catalyst, without Organic Solvent - - - 2>

TABLE 9-3

| | Ex. 2-1-10 | Ex. 2-1-11 | Ex. 2-1-12 | Ex. 2-1-13 | Ex. 2-1.14 |
|---|---|---|---|---|---|
| Kind of monomer | Propiolactone | σ | Propylene | Trimethylene | Glycolide |
| | | valerolactone | carbonate | carbonate | |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.2 | 0.2 | 0.2 | 0.2 | 0.5 |
| (mol %) | | | | | |
| Pressure (MPa) | 65 | 65 | 65 | 65 | 35 |
| Temperature (° C.) | 120 | 80 | 50 | 50 | 180 |
| Polymerization density | 837.31 | 932.87 | 1007.59 | 1007.59 | 484.29 |
| (kg/m³) | | | | | |
| Reaction time (min) | 30 | 30 | 30 | 30 | 15 |
| R/(C + R) | 0.95 | 0.95 | 0.98 | 0.98 | 0.89 |
| Weight average | 590,000 | 570,000 | 590,000 | 570,000 | 270,000 |
| molecular weight Mw | | | | | |
| Molecular weight | 1.3 | 1.2 | 1.6 | 1.7 | 1.5 |
| distribution Mw/Mn | | | | | |
| Residual monomer | 1,100 | 1,300 | 900 | 800 | 7,600 |
| (ppm by mass) | | | | | |
| YI value | 11 | 10 | 12 | 10 | 5 |
| Impact strength | A | A | A | A | C |
| Addition of catalyst | Before | Before | After | After | Before |

<Serial Type, Monomer Kind Homo, Metal Catalyst, without Organic Solvent - - - 3>

TABLE 9-4

| | Ex. 2-1-15 | Ex. 2-1-16 | Ex. 2-1-17 | Ex. 2-1-18 | Ex. 2-1-19 |
|---|---|---|---|---|---|
| Kind of monomer | p- | Propiolactone | σ | Propylene | Trimethylene |
| | dioxanone | | valerolactone | carbonate | carbonate |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.5 | 0.5 | 0.5 | 0.5 | 0.5 |
| (mol %) | | | | | |
| Pressure (MPa) | 65 | 65 | 65 | 65 | 65 |
| Temperature (° C.) | 120 | 120 | 80 | 50 | 50 |
| Polymerization density | 837.31 | 837.31 | 932.87 | 1007.59 | 1007.59 |
| (kg/m³) | | | | | |
| Reaction time (min) | 10 | 10 | 10 | 10 | 10 |
| R/(C + R) | 0.95 | 0.95 | 0.95 | 0.98 | 0.98 |
| Weight average | 250,000 | 240,000 | 250,000 | 250,000 | 220,000 |
| molecular weight Mw | | | | | |
| Molecular weight | 1.6 | 1.6 | 1.6 | 1.6 | 1.6 |
| distribution Mw/Mn | | | | | |
| Residual monomer | 6,500 | 8,800 | 8,800 | 8,800 | 6,000 |
| (ppm by mass) | | | | | |
| YI value | 4 | 2 | 1 | 2 | 3 |
| Impact strength | C | C | C | C | C |
| Addition of catalyst | After | Before | Before | After | After |

<Serial Type, Monomer Kind Homo, Organic Molecule Catalyst, without Organic Solvent>

TABLE 9-5

| | Ex. 2-1-20 | Ex. 2-1-21 | Ex. 2-1-22 |
|---|---|---|---|
| Kind of monomer | Lactide | ε-caprolactone | Ethylene |
| | | | carbonate |
| Catalyst | DMAP | TBD | DBU |
| Kind of initiator | Lauryl | Lauryl | Lauryl |
| | alcohol | alcohol | alcohol |
| Amount of initiator | 0.5 | 0.5 | 0.5 |
| (mol %) | | | |
| Pressure (MPa) | 55 | 65 | 65 |
| Temperature (° C.) | 150 | 50 | 50 |
| Polymerization density | 746.2 | 1007.59 | 1007.59 |
| (kg/m³) | | | |
| Reaction time (min) | 20 | 5 | 5 |
| R/(C + R) | 0.91 | 0.95 | 0.98 |
| Weight average | 180,000 | 200,000 | 210,000 |
| molecular weight Mw | | | |
| Molecular weight | 1.6 | 1.6 | 1.7 |
| distribution Mw/Mn | | | |
| Residual monomer | 7,300 | 8,600 | 7,400 |
| (ppm by mass) | | | |
| YI value | 12 | 9 | 10 |
| Impact strength | C | C | C |
| Addition of catalyst | After | After | After |

### Example 2-2-1

The polymer product of Example 2-2-1 was produced with the polymer product producing system 200 shown in FIG. 5A and FIG. 5B under the conditions shown in Table 10-1. The apparatus shown in FIG. 5A has a configuration obtained by linking two serial-type polymerization reaction apparatuses 100 shown in FIG. 3 in series as a polymerization apparatus of a system line 1 and a polymerization apparatus of a system line 2. The configuration of the producing system 200 is described below.

### —Tank 1, Gauge Feeder 2:

Plunger pump NP-S462 manufactured by Nihon Seimitsu Co., Ltd. The tank 1 was filled with a mixture of molten L-form lactide as the ring-opening-polymerizable monomer (first monomer) and lauryl alcohol as the initiator at a ratio of 99:1 (on a molar basis).

### —Tank 3, Gauge Feeder 4:

Not used in the present Example.

### —Tank 5, Gauge Pump 6:

Not used in the present Example.

### —Tank 7:

Carbonic acid gas cylinder

### —Tank 27:

Carbonic acid gas cylinder

### —Tank 21, Gauge Feeder 22:

Plunger pump NP-S462 manufactured by Nihon Seimitsu Co., Ltd. The tank 21 was filled with molten D-form lactide as the ring-opening-polymerizable monomer (second monomer).

### —Tank 11, Gauge Pump 12:

Intelligent HPLC pump (PU-2080) manufactured by Jasco Corporation. The tank 11 was filled with tin octylate.

### Contact Region 9:

Biaxial stirrer equipped with screws meshing with each other

Cylinder inner diameter of 30 mm

The same direction of rotation for both of the two axes

Rotation speed of 30 rpm

### Contact Region 29:

Biaxial stirrer equipped with screws meshing with each other

Cylinder inner diameter of 30 mm

The same direction of rotation for both of the two axes

Rotation speed of 30 rpm

### —Reacting Region 13:

Biaxial kneader

Cylinder inner diameter of 40 mm

The same direction of rotation for both of the two axes

Rotation speed of 60 rpm

### —Reacting Region 33:

Biaxial kneader

Cylinder inner diameter of 40 mm

The same direction of rotation for both of the two axes

Rotation speed of 60 rpm

The gauge feeder 2 was actuated to volumetrically feed the mixture of L-form lactide and lauryl alcohol in the tank 1 into the container of the biaxial stirrer of the contact region 9 at a flow rate of 4 g/minute (feeding rate of the raw materials). The gauge pump 8 was actuated to feed the carbonic acid gas in the tank 7 serially into the container of the biaxial stirrer in an amount of 5 parts by mass relative to the feeding amount of the raw materials (L-form lactide and lauryl alcohol) of 100 parts by mass. In this way, the biaxial stirrer brought the raw materials, namely L-form lactide and lauryl alcohol, into contact with the compressive fluid serially and melted the raw materials.

The raw materials melted by the biaxial stirrer were conveyed to the biaxial kneader of the reacting region 13 by the liquid conveying pump 10. Meanwhile, the gauge pump 12 was actuated to feed tin octylate as the catalyst stored in the tank 11 into the biaxial kneader at a ratio relative to the feeding amount of L-form lactide of 99:1 (on the molar basis). In this way, the biaxial kneader ring-opening polymerized the L-form lactide in the presence of tin octylate.

Further, the gauge feeder 22 was actuated to volumetrically feed the D-form lactide as the second ring-opening-polymerizable monomer in the tank 21 into the container of the biaxial stirrer of the contact region 29 at 4 g/minute (feeding rate of the raw materials). The gauge pump 28 was actuated to feed the carbonic acid gas in the tank 27 serially into the container of the biaxial stirrer of the contact region 29 in an amount of 5 parts by mass relative to the feeding amount of the D-form lactide of 100 parts by mass (feeding ratio=20). In this way, the biaxial stirrer brought the D-form lactide and the compressive fluid into contact with each other serially and melted the D-form lactide.

The polymer product (L-polylactic acid) as a molten intermediate body obtained from the polymerization in the reacting region 13 and the D-form lactide melted in the contact region 29 were introduced into the biaxial kneader of the reacting region 33. Then, the biaxial kneader polymerized the polymer product (L-polylactic acid) as the intermediate body with the second ring-opening-polymerizable monomer (D-form lactide).

The leading end of the biaxial kneader of the reacting region 33 was equipped with the pressure adjusting valve 34. The polymer product (polylactic acid forming a stereo complex) was serially discharged from this pressure adjusting valve 34.

The characteristics of the polymer product of Example 2-2-1 thus obtained were evaluated in the same manner as Example 1-1-1. The results are shown in Table 10-1.

### Examples 2-2-2 to 2-2-10

The polymer products of Examples 2-2-2 to 2-2-10 were produced in the same manner as Example 2-2-1, except that at least any of the kind of the monomer, polymerization pressure, polymerization reaction temperature, density, reaction time, and mixing ratio [raw materials/(compressive fluid+raw materials)] used in Example 2-2-1 was changed as shown in Tables 10-1 to 10-3 below. As for how to add the catalyst, when adding the catalyst beforehand, the ring-opening-polymerizable monomer, the initiator, and the catalyst were put in the reacting region from the start and reacted therein. When adding the catalyst afterwards, the ring-opening-polymerizable monomer and the initiator were put in the reacting region and mixed therein, and after this, the catalyst was put therein and reacted. The pressure was controlled by changing the flow rate of the pump.

The characteristics of each of the polymer products thus obtained were evaluated in the same manner as Example 1-1-1. The results are shown in Tables 10-1 to 10-3.

<Serial Type, Copolymer of L-Lactide and Another Monomer, Metal Catalyst, with Organic Solvent>

TABLE 10-1

| | Ex. 2-2-1 | Ex. 2-2-2 |
|---|---|---|
| First monomer | L-lactide | ε-caprolactone |
| Second monomer | D-lactide | L-lactide |
| Catalyst | Tin octylate | Tin octylate |
| Kind of initiator | Lauryl | Lauryl |
| | alcohol | alcohol |
| Amount of initiator | 0.2 | 0.2 |
| (mol %) | | |
| Organic solvent | Toluene | Toluene |
| | (1 mol %) | (1 mol %) |
| First polymerization | 65 | 65 |
| pressure (MPa) | | |
| First polymerization | 50 | 50 |
| temperature (° C.) | | |
| First polymerization | 1007.59 | 1007.59 |
| density (kg/m³) | | |
| First polymerization | 20 | 20 |
| reaction time (min) | | |
| R/(C + R) | 0.88 | 0.95 |
| in first polymerization | | |
| Second polymerization | 65 | 65 |
| pressure (MPa) | | |
| Second polymerization | 50 | 50 |
| temperature (° C.) | | |
| Second polymerization | 1007.59 | 1007.59 |
| density (kg/m³) | | |
| Second polymerization | 20 | 20 |
| reaction time (min) | | |
| R/(C + R) | 0.88 | 0.88 |
| in second polymerization | | |
| Weight average | 410,000 | 380,000 |
| molecular weight Mw | | |
| Molecular weight | 1.8 | 1.5 |
| distribution Mw/Mn | | |
| Residual monomer | 11,000 | 6,700 |
| (ppm by mass) | | |
| YI value | 13 | 11 |
| Impact strength | A | B |
| Addition of catalyst | Before | Before |

<Serial Type, Copolymer of L-Lactide and Another Monomer, Metal Catalyst, without Organic Solvent - - - 1>

TABLE 10-2

| | Ex. 2-2-3 | Ex. 2-2-4 | Ex. 2-2-5 | Ex. 2-2-6 | Ex. 2-2-7 |
|---|---|---|---|---|---|
| First monomer | L-lactide | ε-caprolactone | L-lactide | L-lactide | Propylene |
| | | | | | carbonate |
| Second monomer | D-lactide | L-lactide | D-lactide | Ethylene | Trimethylene |
| | | | | carbonate | carbonate |
| Catalyst | Tin octylate | Tin octylate | Tin octylate | Tin octylate | Tin octylate |
| Kind of initiator | Lauryl | Lauryl | Lauryl | Lauryl | Lauryl |
| | alcohol | alcohol | alcohol | alcohol | alcohol |
| Amount of initiator | 0.2 | 0.2 | 0.5 | 0.5 | 0.5 |
| (mol %) | | | | | |
| First polymerization | 65 | 65 | 65 | 65 | 65 |
| pressure (MPa) | | | | | |
| First polymerization | 50 | 50 | 50 | 50 | 50 |
| temperature (° C.) | | | | | |
| First polymerization | 1007.59 | 1007.59 | 1007.59 | 1007.59 | 1007.59 |
| density (kg/m³) | | | | | |
| First polymerization | 20 | 30 | 5 | 5 | 5 |
| reaction time (min) | | | | | |
| R/(C + R) | 0.88 | 0.95 | 0.88 | 0.88 | 0.98 |
| in first polymerization | | | | | |
| Second polymerization | 65 | 65 | 65 | 65 | 65 |
| pressure (MPa) | | | | | |
| Second polymerization | 50 | 50 | 50 | 50 | 50 |
| temperature (° C.) | | | | | |
| Second polymerization | 1007.59 | 1007.59 | 1007.59 | 1007.59 | 1007.59 |
| density (kg/m³) | | | | | |
| Second polymerization | 20 | 30 | 5 | 5 | 5 |
| reaction time (min) | | | | | |
| R/(C + R) | 0.88 | 0.88 | 0.88 | 0.98 | 0.98 |
| in second polymerization | | | | | |
| Weight average | 420,000 | 430,000 | 140,000 | 210,000 | 120,000 |
| molecular weight Mw | | | | | |
| Molecular weight | 1.9 | 1.6 | 1.6 | 1.3 | 1.6 |
| distribution Mw/Mn | | | | | |
| Residual monomer | 10,000 | 8,900 | 15,500 | 19,000 | 18,900 |
| (ppm by mass) | | | | | |
| YI value | 2 | 3 | 3 | 4 | 2 |
| Impact strength | A | A | C | C | C |
| Addition of catalyst | Before | Before | Before | After | Before |

<Serial Type, Copolymer of L-Lactide and Another Monomer, Metal Catalyst, without Organic Solvent - - - 2>

TABLE 10-3

| | Ex. 2-2-8 | Ex. 2-2-9 | Ex. 2-2-10 |
|---|---|---|---|
| First monomer | ε-caprolactone | L-lactide | ε-caprolactone |
| Second monomer | L-lactide | D-lactide | L-lactide |
| Catalyst | Tin octylate | Tin octylate | Tin octylate |
| Kind of initiator | Lauryl | Lauryl | Lauryl |
| | alcohol | alcohol | alcohol |
| Amount of initiator | 0.5 | 0.2 | 0.2 |
| (mol %) | | | |
| First polymerization | 65 | 65 | 65 |
| pressure (MPa) | | | |
| First polymerization | 50 | 50 | 50 |
| temperature (° C.) | | | |
| First polymerization | 1007.59 | 1007.59 | 1007.59 |
| density (kg/m³) | | | |
| First polymerization | 10 | 30 | 30 |
| reaction time (min) | | | |
| R/(C + R) | 0.95 | 0.88 | 0.95 |
| in first polymerization | | | |
| Second polymerization | 65 | 65 | 65 |
| pressure (MPa) | | | |
| Second polymerization | 50 | 50 | 50 |
| temperature (° C.) | | | |
| Second polymerization | 1007.59 | 1007.59 | 1007.59 |
| density (kg/m³) | | | |
| Second polymerization | 10 | 30 | 30 |
| reaction time (min) | | | |
| R/(C + R) | 0.88 | 0.88 | 0.88 |
| in second polymerization | | | |
| Weight average | 290,000 | 440,000 | 520,000 |
| molecular weight Mw | | | |
| Molecular weight | 1.5 | 1.3 | 1.5 |
| distribution Mw/Mn | | | |
| Residual monomer | 2500 | 9900 | 12000 |
| (ppm by mass) | | | |
| YI value | 2 | 12 | 13 |
| Impact strength | C | A | A |
| Addition of catalyst | After | Before | Before |

### Examples 2-3-1 and 2-3-2

The polymer products of Examples 2-3-1 and 2-3-2 were produced in the same manner as Example 2-2-1, except that the monomer used in Example 2-2-1 was changed to a first monomer and a second monomer, the metal catalyst used in Example 2-2-1 was changed to an organic molecule catalyst, and the conditions indicated in Table 11-1 were used. As for how to add the catalyst, when adding the catalyst beforehand, the ring-opening-polymerizable monomer, the initiator, and the catalyst were put in the reacting region from the start and reacted therein. When adding the catalyst afterwards, the ring-opening-polymerizable monomer and the initiator were put in the reacting region and mixed therein, and after this, the catalyst was put therein and reacted. The pressure was controlled by changing the flow rate of the pump.

The characteristics of the polymer products of Examples 2-3-1 and 2-3-2 thus obtained were evaluated in the same manner as Example 1-1-1. The results are shown in Table 11-1.

<Serial Type, Copolymer of L-Lactide and Another Monomer, Organic Molecule Catalyst, without Organic Solvent>

TABLE 11-1

| | Ex. 2-3-1 | Ex. 2-3-2 |
|---|---|---|
| First monomer | L-lactide | ε-caprolactone |
| Second monomer | D-lactide | L-lactide |
| Catalyst | DBU | TBD |
| Kind of initiator | Lauryl | Lauryl |
| | alcohol | alcohol |
| Amount of initiator | 0.2 | 0.2 |
| (mol %) | | |
| First polymerization | 65 | 65 |
| pressure (MPa) | | |
| First polymerization | 50 | 50 |
| temperature (° C.) | | |
| First polymerization | 1007.59 | 1007.59 |
| density (kg/m³) | | |
| First polymerization | 20 | 20 |
| reaction time (min) | | |
| R/(C + R) | 0.88 | 0.95 |
| in first polymerization | | |
| Second polymerization | 65 | 65 |
| pressure (MPa) | | |
| Second polymerization | 50 | 50 |
| temperature (° C.) | | |
| Second polymerization | 1007.59 | 1007.59 |
| density (kg/m³) | | |
| Second polymerization | 20 | 20 |
| reaction time (min) | | |
| R/(C + R) | 0.88 | 0.88 |
| in second polymerization | | |
| Weight average | 220,000 | 210,000 |
| molecular weight Mw | | |
| Molecular weight | 1.5 | 1.4 |
| distribution Mw/Mn | | |
| Residual monomer | 9,000 | 10,000 |
| (ppm by mass) | | |
| YI value | 8 | 9 |
| Impact strength | C | C |
| Addition of catalyst | Before | Before |

Aspects of the present invention are as follows, for example.

<1> A polymer product,

wherein the weight average molecular weight of the polymer product measured by gel permeation chromatography is 250,000 or greater, and the content of residual ring-opening-polymerizable monomer in the polymer product is 100 ppm by mass or greater but less than 1,000 ppm by mass.

<2> The polymer product according to <2>,

wherein the weight average molecular weight of the polymer product measured by gel permeation chromatography is 300,000 or greater.

<3> The polymer product according to <1> or <2>,

wherein the yellow index (YI) value of the polymer product is 15 or less.

<4> The polymer product according to any one of <1> to <3>,

wherein the polymer product is polyester.

<5> A polymer product,

wherein the content of residual ring-opening-polymerizable monomer in the polymer product is from 1,000 ppm by mass to 20,000 ppm by mass, and the yellow index (YI) value of the polymer product is 15 or less.

<6> The polymer product according to <5>,

wherein the content of residual ring-opening-polymerizable monomer in the polymer product is from 1,000 ppm by mass to 10,000 ppm by mass.

<7> The polymer product according to <5> or <6>,

wherein the yellow index (YI) value of the polymer product is 10 or less.

<8> The polymer product according to any one of <5> to <7>,

wherein the weight average molecular weight of the polymer product measured by gel permeation chromatography is 10,000 or greater.

<9> The polymer product according to any one of <5> to <8>,

wherein the polymer product is polyester.

<10> A method for producing a polymer product, including

a polymerizing step of bringing a ring-opening-polymerizable monomer and a compressive fluid into contact with each other at a pressure of 35 MPa or higher and ring-opening polymerizing the ring-opening-polymerizable monomer.

<11> The method for producing the polymer product according to <10>,

wherein in the polymerizing step, the ring-opening-polymerizable monomer and the compressive fluid are brought into contact with each other at a pressure of from 35 MPa to 65 MPa.

<12> The method for producing the polymer product according to <10> or <11>,

wherein a polymerization reaction temperature in the polymerizing step is 200° or lower.

<13> The method for producing the polymer product according to any one of <10> to <12>,

wherein a polymerization reaction temperature in the polymerizing step is from 40° C. to 180° C.

<14> The method for producing the polymer product according to any one of <10> to <13>,

wherein the compressive fluid includes carbon dioxide.

<15> The method for producing the polymer product according to any one of <10> to <14>,

wherein the ring-opening-polymerizable monomer is a monomer that includes a carbonyl group in the ring thereof.

<16> The method for producing the polymer product according to any one of <10> to <15>,

wherein the polymer product is polyester.

<17> A polymer product producing apparatus, including:

a polymerizing unit configured to bring a ring-opening-polymerizable monomer and a compressive fluid into contact with each other at a pressure of 35 MPa or greater at a temperature of 200° C. or lower and ring-opening polymerize the ring-opening-polymerizable monomer; and

an extruding unit configured to extrude a polymerization product obtained by the polymerizing unit to an outside.

### REFERENCE SIGNS LIST

1 tank
9 contact region
13 reacting region
21 tank
100 polymerization reaction apparatus
125 adding pot
127 reaction vessel
200 polymerization reaction apparatus
300 polymerization reaction apparatus
400 polymerization reaction apparatus
P polymer product

1. A polymer product, wherein a weight average molecular weight of the polymer product measured by gel permeation chromatography is 250,000 or greater, and a content of residual ring-opening-polymerizable monomer in the polymer product is 100 ppm by mass or greater but less than 1,000 ppm by mass.

2. The polymer product according to claim 1, wherein the weight average molecular weight of the polymer product measured by gel permeation chromatography is 300,000 or greater.

3. The polymer product according to claim 1, wherein a yellow index (YI) value of the polymer product is 15 or less.

4. The polymer product according to claim 1, wherein the polymer product is polyester.

5. A polymer product,
wherein a content of residual ring-opening-polymerizable monomer in the polymer product is from 1,000 ppm by mass to 20,000 ppm by mass, and a yellow index (YI) value of the polymer product is 15 or less.

6. The polymer product according to claim 5, wherein the content of residual ring-opening-polymerizable monomer in the polymer product is from 1,000 ppm by mass to 10,000 ppm by mass.

7. The polymer product according to claim 5, wherein the yellow index (YI) value of the polymer product is 10 or less.

8. The polymer product according to claim 5, wherein a weight average molecular weight of the polymer product measured by gel permeation chromatography is 10,000 or greater.

9. The polymer product according to claim 5, wherein the polymer product is polyester.

10. A method for producing the polymer product according to claim 1, comprising:
bringing a ring-opening-polymerizable monomer and a compressive fluid into contact with each other at a pressure of 35 MPa or higher and ring-opening polymerizing the ring-opening-polymerizable monomer.

11. The method for producing the polymer product according to claim 10, wherein in the ring-opening polymerization, the ring-opening-polymerizable monomer and the compressive fluid are brought into contact with each other at a pressure of from 35 MPa to 65 MPa.

12. The method for producing the polymer product according to claim 10, wherein a polymerization reaction temperature in the ring-opening polymerization is 200° C. or lower.

13. The method for producing the polymer product according to claim 10, wherein a polymerization reaction temperature in the ring-opening polymerization is from 40° C. to 180° C.

14. The method for producing the polymer product according to claim 10, wherein the compressive fluid comprises carbon dioxide.

15. The method for producing the polymer product according to claim 10, wherein the ring-opening-polymerizable monomer is a monomer that comprises a carbonyl group in a ring thereof.

16. The method for producing the polymer product according to claim 10, wherein the polymer product is polyester.

17. A method for producing the polymer product according to claim 5, comprising:
bringing a ring-opening-polymerizable monomer and a compressive fluid into contact with each other at a pressure of 35 MPa or higher and ring-opening polymerizing the ring-opening-polymerizable monomer.

18. The method for producing the polymer product according to claim 17, wherein in the ring-opening polymerization, the ring-opening-polymerizable monomer and the compressive fluid are brought into contact with each other at a pressure of from 35 MPa to 65 MPa.

19. A polymer product producing apparatus for producing the polymer product according to claim 1, comprising:
a polymerizing unit configured to bring a ring-opening-polymerizable monomer and a compressive fluid into contact with each other at a pressure of 35 MPa or higher at a temperature of 200° C. or lower and ring-opening polymerize the ring-opening-polymerizable monomer; and
an extruding unit configured to extrude a polymerization product obtained by the polymerizing unit to an outside.

20. A polymer product producing apparatus for producing the polymer product according to claim 5, comprising:
a polymerizing unit configured to bring a ring-opening-polymerizable monomer and a compressive fluid into contact with each other at a pressure of 35 MPa or higher at a temperature of 200° C. or lower and ring-opening polymerize the ring-opening-polymerizable monomer; and
an extruding unit configured to extrude a polymerization product obtained by the polymerizing unit to an outside.
